(19) United States
(12) Patent Application Publication
(10) Pub. No.: US 2025/0347667 A1
(43) Pub. Date: Nov. 13, 2025

(54) METHOD FOR SETTING UP A WORKFLOW FOR A CHROMATOGRAPHY SYSTEM

(71) Applicant: Dionex Softron GmbH, Germering (DE)

(72) Inventors: Martin Rendl, Munich (DE); Anne Morgenstern, Gilching (DE)

(73) Assignee: Dionex Softron GmbH, Germering (DE)

(21) Appl. No.: 19/196,065

(22) Filed: May 1, 2025

(30) Foreign Application Priority Data
May 8, 2024 (DE) 102024113025.3

(51) Int. Cl. G01N 30/86

(52) U.S. Cl. CPC G01N 30/8696; G01N 30/8651; G01N 30/8662

(57) ABSTRACT

The present invention relates to a method for setting up a workflow for a chromatography system, wherein the workflow comprises a plurality of workflow parameters, the method comprising providing subroutines of the workflow; providing at least one boundary condition for at least one workflow parameter; assigning a duration and a start time to each of the subroutines; and generating the workflow by combining the subroutines. Furthermore, the present invention relates to a chromatography system and a computer program product.

### CROSS REFERENCE TO RELATED APPLICATION

This application claims priority from German Application No. DE 102024113025.3, filed May 8, 2024. The entire disclosure of Application No. DE 102024113025.3 is incorporated herein by reference.

### FIELD

The present invention generally relates to methods for setting up a workflow for a chromatography system.

### BACKGROUND

Generally, an ongoing democratization of chromatography results in a decreasing level of user experience, while at the same time the complexity of the chromatographic separation, instrumentation and downstream data analysis is increasing. Therefore, there may generally be a demand to reduce complexity to lower the entry barrier for new users to liquid chromatography. This may particularly be realized by means of more intuitive user guidance, e.g., when setting up a workflow.

Typically, chromatography workflows may be set up utilizing method editors. Current state of the art method editors may require a significant level of user experience for correctly setting up a desired workflow. This may be the result of several problems of known method editors.

Firstly, the chromatography device settings may typically be displayed in a modular representation instead of an integrated system representation. For instance, settings specific for a chromatography pump may be displayed on a dedicated method editor page for the pump. Thus, parameters which influence the entire chromatography system across individual modules may frequently not be synchronized between individual method editor pages of given modules and/or be redundant. This may disadvantageously result in numerous and frequently ambiguous parameters that a user needs to set, which may in turn result in rather difficult usability and a complex (overwhelming) user experience.

Secondly, workflow operations may typically be displayed in a tabular representation. In that regard, chromatography workflows are essentially schedules of control commands for the chromatography device units (or modules). These schedules may typically be represented as individual tables, i.e., one for each module/unit. However, this representation may render display of inter-module scheduling dependencies rather difficult. For instance, in a typical chromatography workflow, certain operations can run in parallel but need to complete at a given time to allow for synchronous subsequent operation of multiple modules. For example, the analytical column may be equilibrated while simultaneously the autosampler may perform a pickup of a sample. Prior to injecting the sample into the flow path, both parallel processes may need to be completed and ideally both processes should complete simultaneously or in short succession. Hence, particularly in the case of a more complex chromatography workflow such as for tandem or “heart-cut” applications, a significant user experience may be required for correctly setting up the workflow, e.g., instrument methods. Moreover, frequently long and tedious experiments for workflow (and/or method) setup and development may be needed.

Additionally, there may currently be no satisfactory means for simple optimization of the chromatography workflow. Method editors in state-of-the-art chromatography data systems (CDSs) may not provide means to display and optimize the efficiency and throughput of a chromatography workflow, e.g., by displaying and optimizing a detector uptime, i.e., periods during the chromatography workflow when the detector is actually recording usable data. Thus, there may be no means for leveraging usability and throughput. However, while there are for example options which allow a user to execute certain parts of the injection process already during the previous injection (e.g., the “PrepareNextInjection” command within Chromeleon CDS by Thermo Fisher Scientific), the correct timing of the command—without knowing its actual duration—may be entirely up to the customer and therefore very error-prone.

Thus, there may be a need for improved methods of setting up a workflow for a chromatography system, e.g., by providing a more intuitive and more user guided method.

In fact, this may particularly be relevant for more sophisticated chromatographic applications, such as tandem, 2D or heart-cut applications, where elaborate synchronization of instruments is advantageous. Currently, tandem workflows may frequently be programmed by experts by essentially manually composing the task execution scripts.

In that regard, for example the Thermo Fisher Scientific Chromeleon instrument method editor for LC Tandem Support is known, which is targeted to alleviate the operation of tandem liquid chromatography (LC) applications. It allows to define a tandem instrument method if a suitable instrument configuration is detected. However, this implementation may have several drawbacks, particularly compared to the present invention. It essentially is targeted at parallel execution of tasks of gradient pump and equilibration pump. That is, parallel execution may be limited to tasks of gradient pump and equilibration pump only. Thus, sample handling may occur prior to those tasks, such that it is neither synchronized nor running simultaneously to the afore mentioned processes. For low flow LC and particularly for trap applications, where a lot of time may typically be spent for loading and conditioning of the trap column, this may significantly limit the cycle time and thus throughput. Furthermore, there may also be no support for accelerated loading and equilibration pump operation modes. Again, leading to a limited cycle time and throughput.

Thus, designing workflows, particularly workflows that require synchronization of several (at least partially) in parallel occurring tasks, may be challenging since a multitude of interdependent parameters may have to be specified while boundary conditions for synchronization of various tasks of the workflow may have to be considered.

Therefore, there may be a demand to reduce the complexity by means of automated synchronization of instrument tasks, which may aid with setting up a workflow, particularly an optimized workflow.

### SUMMARY

In light of the above, it is an object to overcome or at least alleviate the shortcomings and disadvantages of the prior art. More particularly, it may be an object of the present invention to provide a smart method editing approach that facilitates setting up of chromatography workflows.

These objects are met by the present invention.

In a first aspect, the present invention relates to a method for setting up a workflow for a chromatography system, wherein the workflow comprises a plurality of workflow parameters, the method comprising providing subroutines of the workflow; providing at least one boundary condition for at least one workflow parameter; assigning a duration and a start time to each of the subroutines; and generating the workflow by combining the subroutines.

It will be understood that a start time may generally be defined with respect to a start of the workflow, e.g., a subroutine may be assigned a start time of 5 seconds after the start of the workflow. In other words, the start of the workflow may define a reference point which may for example correspond to a start time of 0 s.

The method may comprise displaying at least a part of the workflow, wherein displaying at least a part of the workflow comprises displaying at least a selection of the subroutines; wherein each displayed subroutine may be represented as an item, respectively; wherein a position in a first direction of each item may be indicative of the start time of the respective subroutine relative to the other subroutines; and wherein an expansion in the first direction of each item may be indicative of the duration of the respective subroutine.

In other words, the method may comprise displaying at least part of the workflow, preferably to a user, wherein subroutines are displayed as an item whose position and expansion in a first direction, e.g., x-direction, may be indicative of the start time and the duration of the respective subroutine. This may advantageously allow to facilitate with understanding the timing and dependencies between different subroutines. The visualization may thus for example aid with planning of workflows. It will be understood that the displaying at least a part of the workflow may relate to displaying the respective at least a part of the workflow on a screen, e.g., a computer screen.

Further, displaying at least a part of the workflow may comprise displaying each subroutine. Alternatively, the selection of subroutines may comprise all subroutines concerning handling of fluids. Additionally or alternatively, the selection of subroutines may not comprise subroutines solely concerning changing of a fluidic configuration of the chromatography system. Thus, advantageously all subroutines relating to the handling of fluids may be displayed while for example valve switches that merely change the fluidic configuration assumed by the system may not be displayed. This may advantageously help to keep the visualization clear and avoid displaying unnecessary subroutines that are for example intrinsically linked to other subroutines. For example, it may always be necessary to switch a valve after precompressing a sample in a trap column to inject it into the separation column and a respective analysis.

Displaying at least a part of the workflow may comprise displaying at least one of the last least one boundary condition. Such a boundary condition may for example relate to one subroutine being required to finish prior to starting another subroutine. For example, sample precompression may need to be finished in an autosampler prior to loading the sample onto the separation column. Similarly, a maximum applicable parameter such as duration or volume may be indicated or displayed.

Displaying at least a part of the workflow may comprise displaying at least one interdependence of subroutines. Such an interdependence may for example relate to a required order of subroutines, particularly between different modules. Thus, some of these interdependencies may relate to boundary conditions as in the example given above. Further, multiple subroutines may depend on the same parameter. For example, sample pickup and loading may both depend on a desired injection volume.

The method may comprise displaying workflow parameters related to a subroutine upon request of a user. For example, a user may select an item of a displayed workflow, e.g., by clicking on the respective item, and related workflow parameters may be displayed to the user, e.g., in a popup window.

The system may comprise a plurality of system modules operated in parallel. Further, each subroutine may be associated to at least one system module. Furthermore, a position of each item in a second direction perpendicular to the first direction may be indicative of the association to a system module of the respective item. Thus, in addition to the position and extension in a first direction, which indicate start time and duration, a position in a second direction may indicate the association of a subroutine to a system module. Thus, position and size of an item may visualise not only timing parameters of a subroutine but also by which system module the subroutine is performed. This may advantageously also improve a user's understanding of which subroutines are performed when at which system module and particularly allow to identify subroutines that are performed in parallel. Furthermore, it may facilitate with planning the correct timing of subroutines performed by different system modules.

The method may further comprise saving the generated workflow as a data file and/or in a database.

The method may further comprise operating the chromatography system according to the generated workflow. That is, the method may comprise a chromatography system actually performing the generated workflow. Further, operating the chromatography system according to the generated workflow may comprise controlling the chromatography system in accordance with the generated workflow. Additionally or alternatively, operating the chromatography system according to the generated workflow may comprise controlling the system modules of the chromatography system in accordance with the generated workflow.

The method may be a computer-implemented method.

The method may further comprise receiving at least one input parameter. It will be understood that receiving for example an input parameter or any other information may comprise the user providing such information, e.g., by means of a user input through a user interface, as well as for example receiving such information from an ID tag. Receiving at least one input parameter may comprise updating at least one input parameter. Further, the at least one input parameter may comprise at least one workflow parameter. Receiving at least one workflow parameter may comprise enforcing any associated boundary condition. Additionally or alternatively, the at least one input parameter comprises at least one boundary condition for at least one workflow parameter. Such a boundary condition may for example be a minimum or maximum value of a parameter.

Providing the at least one boundary condition for at least one workflow parameter may be based on at least one of the at least one input parameter.

In some embodiments, providing at least one boundary condition may comprise automatically determining at least one boundary condition based on at least one workflow parameter, at least one boundary condition and/or at least one provided subroutine. Generally, a boundary condition may for example be a maximum value for a parameter. Since there may be interdependencies between different parameters, it will be understood that a boundary condition may be determined based on, inter alia, another boundary condition. For example, a maximum applicable injection volume may depend on a maximum applicable flow rate at which gradient, column wash and or column equilibration can be performed. It will be understood that in the provided example, a boundary condition (i.e., the maximum applicable injection volume) is automatically determined based on another boundary condition (i.e., the maximum applicable flow rate).

The method may comprise suggesting a change of workflow parameters to optimize the workflow. For example, a workflow may be optimized with respect to gradient delay volume, detector uptime and/or cycle time.

In embodiments wherein the system comprises the plurality of system modules, the plurality of system modules may comprise at least one autosampler module. The autosampler module may comprise at least one autosampler comprising a sampling device, a sample pick-up means, a seat for receiving the sample pick-up means, and a distribution valve. Further, autosampler module may comprise a sample storage, preferably a sample loop.

In embodiments wherein the system comprises the plurality of system modules, the plurality of system modules may comprise at least one pump module. The at least one pump module may comprise a gradient pump module. Additionally or alternatively, the at least one pump module comprises an equilibration pump module.

In embodiments wherein the system comprises the plurality of system modules, the plurality of system modules may comprise a column compartment module. The column compartment module may comprise at least one separation column. Additionally or alternatively, the column compartment module may comprise at least one trap column. The column compartment module may comprise at least one distribution valve.

In embodiments wherein the system comprises the plurality of system modules, the plurality of system modules may comprise at least one detector module.

The provided subroutines may be selected from a plurality of predefined subroutines.

The plurality of predefined subroutines may comprise a loop wash subroutine, wherein the loop wash subroutine may comprise washing of a sample storage, preferably a sample loop. Further, the loop wash subroutine may be associated with the autosampler module. Alternatively, the loop wash subroutine may be associated with one of the at least one pump module, preferably the equilibration pump module. The sample storage may be the sample storage that is comprised by the autosampler module.

The duration of the loop wash subroutine may depend on a number of loop-wash iterations #_{lwash}, a volume per loop-wash iteration V_{lwash} as well as a loop-wash rate f_{lwash}. Particularly, the duration of the loop wash subroutine may be t_{lwash}=#_{lwash}*V_{lwash}/f_{lwash}.

In some embodiments, the plurality of workflow parameters may comprise the number of loop-wash iterations #_{lwash} for washing a sample storage, preferably a sample loop, the volume per loop-wash iteration V_{lwash}, and the loop-wash rate f_{lwash}. Additionally or alternatively, the plurality of workflow parameters may comprise the duration of the loop wash subroutine t_{lwash} and/or a start time of the loop wash subroutine t_{start,lwash}.

In some embodiments, the plurality of predefined subroutines may comprise a trap wash subroutine, wherein the trap wash subroutine may comprise washing a respective trap column. The trap wash subroutine may be associated with the autosampler module. Alternatively, the trap wash subroutine may be associated with one of the at least one pump module, preferably the equilibration pump module.

The duration of the trap wash subroutine may depend on a volume for trap washing V_{trapwash}. The volume for trap washing may be given as V_{trapwash}=X_{trapwash}*V_{trapcol}, wherein V_{trapcol} denotes a void volume of the respective trap column and X_{trapwash} denotes a trap-wash factor.

In some embodiments, the trap wash subroutine may comprise a flow-controlled wash and the duration of the trap wash subroutine may further depend on a trap-wash rate f_{trapwash}, wherein the duration of the trap wash is preferably t_{trapwash}=V_{trapwash}/f_{trapwash}.

Alternatively, the trap wash subroutine may comprise a pressure-controlled wash and wherein the duration of the trap wash subroutine may depend on a trap-related backpressure Rₜᵣₐₚ and a trap-wash pressure P_{trapwash}. The duration of the trap wash subroutine may be approximated as t_{trapwash}≈V_{trapwash}*Rₜᵣₐₚ/P_{trapwash}. A trap-wash safety margin t_{add,trapwash} may be added to account for variations in the actual duration, such that the duration of trap wash subroutine may be given as t_{trapwash}=V_{trapwash}*Rₜᵣₐₚ/P_{trapwash}+t_{add,trapwash}.

The plurality of workflow parameters may comprise one or more of the volume for trap washing V_{trapwash}, the trap-wash rate f_{trapwash}, the trap-wash pressure P_{trapwash}, the trap-wash safety margin t_{add,trapwash}, a trap column temperature the duration of the trap wash subroutine t_{trapwash} and/or a start time of the trap wash subroutine t_{start,trapwash}.

In some embodiments, the plurality of predefined subroutines may comprise a trap equilibration subroutine for equilibrating a respective trap column. The trap equilibration subroutine may be associated with the autosampler module. Alternatively, the trap equilibration subroutine may be associated with one of the at least one pump module, preferably the equilibration pump module.

The duration of the trap equilibration subroutine may depend on a volume for trap equilibration V_{trapeq}. The volume for trap equilibration may be given as V_{trapeq}=X_{trapeq}*V_{trapcol}, wherein V_{trapcol} denotes a void volume of the respective trap column and X_{trapeq} denotes a trap-equilibration factor.

The trap equilibration subroutine may comprise a flow-controlled equilibration and wherein the duration of the trap equilibration subroutine further depends on a trap-equilibration rate f_{trapeq}. The duration of the trap equilibration may be given as t_{trapeq}=V_{trapeq}/f_{trapeq}.

Alternatively, the trap equilibration subroutine may comprise a pressure-controlled equilibration and wherein the duration of the trap equilibration subroutine may depend on the trap-related backpressure Rₜᵣₐₚ and a trap-equilibration pressure P_{trapeq}. The duration of the trap equilibration subroutine may be approximated as t_{rapeq}≈V_{trapeq}*Rₜᵣₐₚ/P_{trapeq}. A trap-equilibration safety margin t_{add,trapeq} may be added to account for variations in the actual duration, such that the duration of the trap equilibration subroutine may be given as t_{rapeq}=V_{trapeq}*Rₜᵣₐₚ/P_{trapeq}+t_{add,trapeq}.

The plurality of workflow parameters may comprise one or more of the volume for trap equilibration V_{trapeq}, the trap-equilibration rate f_{trapeq}, the trap-equilibration pressure P_{trapeq}, the trap-equilibration safety margin t_{add,trapeq}, the duration of the trap equilibration subroutine t_{rapeq}, and/or a start time of the trap equilibration subroutine t_{start,rapeq}.

In some embodiments, the plurality of predefined subroutines may comprise an init subroutine comprising an initialization of an autosampler comprised by the chromatography system. The init subroutine may be associated with the autosampler module. The autosampler may be the autosampler comprised by the autosampler module. The init subroutine may comprise setting the sampling device to a desired position for subsequent sample pickup.

The duration of the init subroutine may depend on a momentary position of the sampling device, an idle volume of the sampling device and a moving speed of the sampling device, particularly a drive thereof. The idle volume and/or the moving speed may be determined based on an injection Volume Vᵢₙⱼ of a subsequent sample pick-up. Additionally or alternatively, the duration of the init subroutine may depend on the injection Volume Vᵢₙⱼ of a subsequent sample pick-up.

The plurality of workflow parameters may comprise the momentary position of the sampling device, the idle volume of the sampling device, and the moving speed of the sampling device. Additionally or alternatively, the plurality of workflow parameters may comprise one or more of the injection Volume Vᵢₙⱼ, the duration of the init subroutine tᵢₙᵢₜ, and/or a start time of the init subroutine t_{start,init}.

In some embodiments, the plurality of predefined subroutines may comprise a sample pickup subroutine comprising picking up at least a portion of a sample. The sample pickup subroutine may be associated with the autosampler module.

The duration of the sample pickup subroutine may depend on the injection Volume Vᵢₙⱼ, a draw rate f_{draw}, and a draw delay t_{delay}. Particularly, the duration of the sample pickup routine may be given as t_{pickup}=Vᵢₙⱼ/f_{draw}+t_{delay}. In some embodiments, the sample pick up routine may comprise at least one additional washing step with a duration t_{pwash} and wherein the duration of the sample pickup routine may thus be given as t_{pickup}=Vᵢₙⱼ/f_{draw}+t_{delay}+t_{pwash}.

The plurality of workflow parameters may comprise on or more of the draw rate f_{draw}, the draw delay t_{delay}, the duration of the at least one additional washing step during sample pickup subroutine t_{pwash}, the duration of the sample pickup subroutine t_{pickup} and/or a start time of the sample pickup subroutine t_{start,pickup}.

In some embodiments, the plurality of predefined subroutines may comprise a trap loading subroutine for providing a sample to a respective trap column. The trap loading subroutine may be associated with the autosampler module. Alternatively, the trap loading subroutine may be associated with one of the at least one pump module, preferably the equilibration pump module. Loading the trap column utilizing one of the at least one pump could for example comprise using a trap column upstream of a separation column for protecting the separation column from particles.

The duration of the trap loading subroutine may depend on a volume for trap loading V_{trapload}. The volume for trap loading may be given as V_{trapload}=Vᵢₙⱼ+V_{traploadex}, wherein V_{traploadex} denotes a trap loading excess volume configured to ensure that the sample is entirely loaded onto the trap column. Particularly, the volume for trap loading may be given as V_{trapload}=X_{trapload}*Vₜᵣₐₚ+Vᵢₙⱼ, wherein Vₜᵣₐₚ denotes a void volume of the separation column and X_{trapload} denotes a trap-loading factor. The trap-loading factor may generally be greater than 0 and may preferably be chosen such that the trap loading excess volume is about the same as the injection volume, resulting in a total trap loading volume which may be about twice the injection volume.

The trap loading subroutine may comprise a flow-controlled loading and wherein the duration of the trap loading subroutine further may depend on a trap-loading rate f_{trapload}. The duration of the trap loading may be given as t_{trapload}=V_{trapload}/f_{trapload}.

Alternatively, the trap loading subroutine may comprise a pressure-controlled loading and wherein the duration of the trap loading subroutine may depend on the trap-related backpressure Rₜᵣₐₚ and a trap-loading pressure P_{trapload}. The duration of the trap loading subroutine may be approximated as t_{trapload}≈V_{trapload}*Rₜᵣₐₚ/P_{trapload}. In some embodiments, a trap-loading safety margin t_{add,trapload} may be added to account for variations in the actual duration, such that the duration of the trap loading subroutine may be given as t_{trapload}=V_{trapload}*Rₜᵣₐₚ/P_{trapload}+t_{add,trapload}.

The plurality of workflow parameters may comprise one or more of the volume for trap loading V_{trapload}, the trap-loading rate f_{trapload}, the trap-loading pressure P_{trapload}, the trap-loading safety margin t_{add,trapload}, the duration of the trap loading subroutine t_{trapload}, and/or a start time of the trap loading subroutine t_{start,trapload}.

The trap-related backpressure Rₜᵣₐₚ may relate to the backpressure in a flow path comprising the trap column during the trap wash, trap equilibration and/or trap loading subroutine. It will be understood that the trap-related backpressure Rₜᵣₐₚ may particularly originate from the trap column, but may further depend on geometries of fluid conduits, viscosity of the solvent and/or sample as well as trap column temperature. In particular, it may be solvent-dependent.

The trap-related backpressure Rₜᵣₐₚ may be derived from a lookup table, from historical (measured) values or by means of measuring.

Statistical methods and/or statistical learning such as machine learning techniques may be employed for deriving Rₜᵣₐₚ.

The method may comprise measuring the trap-related backpressure Rₜᵣₐₚ.

The plurality of workflow parameters may comprise the trap-related backpressure Rₜᵣₐₚ.

In some embodiments, the plurality of predefined subroutines may comprise a precompression subroutine comprising pressurizing the sample prior to injection into a separation column. The trap loading subroutine may be associated with the autosampler module.

The precompression subroutine may comprise pressurizing an injection flow path. It will be understood that the injection flow path may denote the fluidic path that is fluidly connected to the separation column for injection of the sample into the separation column, which may typically comprise a trap column and/or sample storage, e.g., sample loop.

The precompression subroutine may comprise pressurizing the sample storage, preferably sample loop. Additionally or alternatively, the precompression subroutine may comprise pressurizing a respective trap column.

Pressurizing may comprise elevating the pressure from an initial pressure Pᵢₙᵢₜ to a precompression pressure P_{compress}. The initial pressure may correspond to ambient pressure. The precompression pressure may approximate analytical pressure at the respective separation column during separation. The precompression pressure may be at least 50 bar, preferably at least 100 bar, more preferably at least 500 bar.

The duration of the precompression subroutine may depend on a pressure difference between the initial pressure and the precompression pressure. Additionally or alternatively, the duration of the precompression subroutine may depend on a speed employed for compression. Additionally or alternatively, the duration of the precompression subroutine may depend on a volume to be pressurized. Additionally or alternatively, the duration of the precompression subroutine may depend on viscosity and/or compressibility of solvent(s) and/or sample to be pressurized. The duration of the precompression subroutine t_{precomp} may for example be assigned a fixed duration in the range of 1 to 60 s.

The plurality of workflow parameters may comprise one or more of the initial pressure Pᵢₙᵢₜ, the precompression pressure P_{compress}, the speed employed for compression within the precompression subroutine, the volume to be pressurized within the precompression subroutine, the viscosity and/or compressibility of the solvent(s), the viscosity and/or compressibility of the sample, the duration of the precompression subroutine t_{precomp}, and/or a start time of the precompression subroutine t_{start,precomp}.

In some embodiments, the plurality of predefined subroutines may comprise an inject subroutine comprising switching a flow path comprising the sample into a respective flow path to the separation column. The inject subroutine may be assigned a fixed duration in the range of 0 to 10 s, preferably 0 to 5 s, more preferably 0 to 1 s. In particular, the duration time of the injection subroutine may be on the order of a valve switching time.

The plurality of workflow parameters may comprise the duration of the inject subroutine tᵢₙⱼ and/or a start time of the inject subroutine t_{start,inj}.

In some embodiments, the plurality of predefined subroutines may comprise a column wash subroutine comprising washing of a respective separation column. The column wash subroutine may be associated with one of the at least one pump module. Alternatively, the column wash subroutine may be associated with the equilibration pump module.

The duration of the column wash subroutine may depend on a volume for column washing V_{colwash}. The volume for column washing may be given as V_{colwash} X_{colwash}*V_{col}, wherein V_{col} denotes the void volume of the respective separation column and X_{colwash} denotes a column-wash factor.

The column wash subroutine may comprise a flow-controlled wash and wherein the duration of the column wash subroutine further depends on a column-wash rate f_{colwash}. The duration of the column wash may be given as t_{colwash}=V_{colwash}/f_{colwash}.

Alternatively, the column wash subroutine may comprise a pressure-controlled wash and wherein the duration of the column wash subroutine may further depend on a column-related backpressure R_{col} and a column-wash pressure P_{colwash}. The duration of the column wash subroutine may be approximated as t_{colwash}≈V_{colwash}*R_{col}/P_{colwash}. In some embodiments, a column-wash safety margin t_{add,colwash} may be added to account for variations in the actual duration, such that the duration of column wash subroutine is given as t_{colwash}=V_{colwash}*R_{col}/P_{colwash}+t_{add,colwash}.

The plurality of workflow parameters may comprise one or more of the volume for column washing V_{colwash}, the column-wash rate f_{colwash}, the column-wash pressure P_{colwash}, the column-wash safety margin t_{add,colwash}, a separation column temperature, the duration of the column wash subroutine t_{colwash}, and/or a start time of the trap wash subroutine t_{start,colwash}.

In some embodiments, the plurality of predefined subroutines may comprise a column equilibration subroutine comprising equilibrating of a separation column. The column equilibration subroutine may be associated with one of the at least one pump module. Particularly, the column equilibration subroutine may be associated with the equilibration pump module.

The duration of the column equilibration subroutine may depend on a volume for equilibrating the separation column V_{coleq}. The volume for equilibrating the separation column may be given as V_{coleq}=X_{coleq}*V_{col} wherein V_{col}, denotes the void volume of the respective separation column and X_{coleq} denotes a column-equilibration factor.

The column equilibration subroutine may comprise a flow-controlled equilibration and wherein the duration of the column equilibration subroutine may further depend on a column-equilibration rate f_{coleq}. The duration of the column equilibration may be given as t_{coleq}=V_{coleq}/f_{coleq}.

Alternatively, the column equilibration subroutine may comprise a pressure-controlled equilibration and wherein the duration of the column equilibration subroutine may depend on the column-related backpressure R_{col} and a column-equilibration pressure P_{coleq}. The duration of the column equilibration subroutine may be approximated as t_{coleq}≈V_{coleq}*R_{col}/P_{coleq}. In some embodiments, a column-equilibration safety margin t_{add,coleq} may be added to account for variations in the actual duration, such that the duration of column equilibration subroutine is given as t_{coleq}=V_{coleq}*R_{col}/P_{coleq}+t_{add,coleq}.

The plurality of workflow parameters may comprise one or more of the volume for column equilibration V_{coleq}, the column-equilibration rate f_{coleq}, the column-equilibration pressure P_{coleq}, the column-equilibration safety margin t_{add,coleq}, the duration of the column equilibration subroutine t coleq, and/or a start time of the column equilibration subroutine t_{start,coleq}.

In some embodiments, the plurality of predefined subroutines may comprise a column loading subroutine comprising providing a sample to a respective separation column. The column loading subroutine may be associated with one of the at least one pump module. Particularly, the column loading subroutine may be associated with the equilibration pump module.

The duration of the column loading subroutine may depend on a volume for column loading V_{colload}. The volume for column loading may be given as V_{colload}=Vᵢₙⱼ+V_{colloadex}, wherein V_{colloadex} denotes a column loading excess volume configured to ensure that the sample is entirely loaded onto the respective separation column. For example, the volume for column loading may be given as V_{colload}=X_{colload}*V_{col}+Vᵢₙⱼ, wherein V_{col} denotes a void volume of the respective separation column and X_{colload} denotes a column-loading factor. The column-loading factor may generally be greater than 0 and may preferably be chosen such that the column loading excess volume is about the same as the injection volume, resulting in a total column loading volume which may be about twice the injection volume.

The column loading subroutine may comprise a flow-controlled loading and wherein the duration of the column loading subroutine further depends on a column-loading rate f_{colload}. The duration of the column loading subroutine may be given as t_{colload}=V_{colload}/f_{colload}.

Alternatively, the column loading subroutine comprises a pressure-controlled loading and wherein the duration of the column loading subroutine further depends on the column-related backpressure R_{col} and a column-loading pressure P_{colload}. The duration of the column loading subroutine may be approximated as t_{colload}≈V_{colload}*R_{col}/P_{colload}. In some embodiments, a column-loading safety margin t_{add,colload} may be added to account for variations in the actual duration, such that the duration of the column loading subroutine is determined as t_{colload}=V_{colload}*R_{col}/P_{colload}+t_{add,colload}.

The plurality of workflow parameters may comprise one or more of the volume for column loading V_{colload}, the volume of the separation column V_{col}, the column-loading factor X_{colload}, the column-loading rate f_{colload}, the column-loading pressure P_{colload}, the column-loading safety margin t_{add,colload}, the duration of the column loading subroutine t_{colload}, and/or a start time of the column loading subroutine t_{start,colload}.

The column-related backpressure R_{col} may relate to the backpressure in a flow path comprising the separation column during the column wash, column equilibration and/or column loading subroutine. It will be understood that the column-related backpressure R_{col} may be dependent on the type of the column(s), geometries of the fluidic conduits, viscosity and compressibility of the solvent as well as column temperature. In particular, the column-related backpressure may be solvent dependent and may thus be different for washing, equilibrating and loading of the separation column.

The column-related backpressure R_{col} may be derived from a lookup table, from historical (measured) values or by means of measuring.

Statistical methods and/or statistical learning such as machine learning techniques may be employed for deriving R_{col}.

The method may comprise measuring the column-related backpressure R_{col}.

The plurality of workflow parameters may comprise the column-related backpressure R_{col}.

In some embodiments, the plurality of predefined subroutines may comprise a gradient subroutine comprising providing a solvent gradient to a respective separation column. The gradient subroutine may be associated with one of the at least one pump module. Particularly, the gradient subroutine may be associated with the gradient pump module.

The plurality of workflow parameters may comprise the duration of the gradient subroutine t_{grad} and/or a start time of the gradient subroutine t_{start,grad}.

In some embodiments, the plurality of predefined subroutines may comprise an align subroutine configured for temporally aligning subroutines.

The plurality of workflow parameters may comprise the duration of the align subroutine t_{align} and/or a start time of the align subroutine t_{start.align}.

In some embodiments, the plurality of predefined subroutines may comprise an acquisition subroutine comprising recording data on an effluent. The duration of the acquisition subroutine may be the same as the duration of the gradient subroutine.

The plurality of workflow parameters may comprise the duration of the acquisition subroutine t_{acq} and/or a start time of the acquisition subroutine t_{start,acq}.

The plurality of predefined subroutines may comprise a wait subroutine. The plurality of workflow parameters may comprise the duration of the wait subroutine t_{wait} and/or a start time of the trap equilibration subroutine t_{start,wait}.

Column conditioning subroutines may comprise a combination of column wash and column equilibration subroutines. Column conditioning subroutines may further comprise at least one align subroutine.

Sample handling subroutines may comprise a combination of sample pickup, precompression and init subroutines. Sample handling subroutines may further comprise at least one loop wash subroutine. Additionally or alternatively, sample handling subroutines may further comprise at least one trap loading subroutine and/or at least one trap washing subroutine.

A boundary condition for duration and start time of subroutines may be that there cannot be an overlap in time for subroutines associated with the same module.

Providing at least one boundary condition may comprise providing at least one boundary condition directed at a logical order of the provided subroutines. Additionally or alternatively, providing at least one boundary condition may comprise providing at least one boundary condition directed at subroutines associated to different system modules comprising the same start time. Additionally or alternatively, providing at least one boundary condition may comprise providing at least one boundary condition directed at subroutines associated to different system modules ending at the same time.

For example: The at least one provided boundary condition may comprise the start time of the trap equilibration subroutine being later than the start time of an associated trap wash subroutine. The at least one provided boundary condition may comprise the start time of the sample pickup subroutine being greater than the start time of an associated init subroutine. The at least one provided boundary condition may comprise the start time of the precompression subroutine being greater than the start time of an associated sample pickup subroutine. The at least one provided boundary condition may comprise the start time of the trap loading subroutine being greater than the start time of an associated sample pickup subroutine. The at least one provided boundary condition may comprise the start time of the precompression subroutine being greater than the start time of an associated trap loading subroutine. The at least one provided boundary condition may comprise the start time of the column equilibration subroutine being greater than the start time of an associated column wash subroutine. The at least one provided boundary condition may comprise the start time of the column loading subroutine being greater than the start time of an associated column equilibration subroutine. The at least one provided boundary condition may comprise the start time of the gradient subroutine being greater than the start time of an associated precompression subroutine.

In some embodiments, the method may comprise determining a cycle time t_{cycle} corresponding to the total duration of analysing one sample. Further, the method may comprise displaying the cycle time t_{cycle}. Particularly, displaying at least a part of the workflow may comprise displaying the cycle time t_{cycle}.

The method may comprise determining a detector uptime tᵤₚₜᵢₘₑ corresponding to the duration of the acquisition subroutine relative to the cycle time t_{cycle}. Further, the method may comprise displaying the detector uptime tᵤₚₜᵢₘₑ. Particularly, displaying at least a part of the workflow may comprise displaying the detector uptime tᵤₚₜᵢₘₑ.

Displaying the cycle time and/or detector uptime may advantageously allow a user to directly see an impact of any changes made to a workflow.

The method may comprise determining where detector uptime is lost. Further, method may comprise indicating where detector uptime is lost. Additionally or alternatively, the workflow may be optimized with regard to detector uptime.

The workflow may be optimized with regard to detector cycle time.

The plurality of workflow parameters may comprise the cycle time t_{cycle} and/or the detector uptime tᵤₚₜᵢₘₑ.

The method may comprise receiving information on the chromatography system. It will be understood that the information may be received from a user, i.e. the user may provide the information and/or that information may be received from other sources such as databases or ID tags. The information on the chromatography system may include at least one of comprised hardware components and/or fluidic configuration of the system.

The method may comprise receiving additional information on the chromatographic application for which the workflow is set up. The additional information may comprise the type of chromatography, preferably selected from size-exclusion, normal-phase, and reversed-phase chromatography. Additionally or alternatively, the additional information may comprise information about the sample. The information about the sample may comprise the affinity of the sample to water, such as hydrophobic or hydrophilic. Additionally or alternatively, the information about the sample may comprise the viscosity of the sample. Additionally or alternatively, the information about the sample may comprise the polarity of the sample. Additionally or alternatively, the information about the sample may comprise the pH of the sample.

The method may further comprise receiving a default workflow. For example, a user may specify a default workflow through selection from a list of default workflows. Such a list may include default workflows such as direct injection, trap and elute (preconcentration), tandem—direct injection, tandem—trap and elute (preconcentration, online 2D. Further, in the step of providing subroutines of the workflow the subroutines may be provided based on the received default workflow.

Receiving a default workflow may comprise providing a plurality of default workflows and a user selecting a desired default workflow. Further, providing a plurality of default workflows may comprise filtering available default workflows based on information on the chromatographic system, and providing only default workflows that are supported by the chromatography system. Available default workflows may be filtered based on comprised hardware components and/or fluidic configuration of the chromatography system.

Assigning a duration and a start time to each of the subroutines may comprise automatically assigning a duration and a start time to each of the subroutines. While the duration and the start time may be automatically assigned to each of the subroutines, it should be understood that these automatically assigned durations and start times may subsequently also be changed, e.g., by a user input.

Assigning the duration and/or the start time to each of the subroutines may be based on the selected default workflow. Additionally or alternatively, assigning the duration and/or the start time to each of the subroutines may be based on at least one of the at least one received input parameter. Additionally or alternatively, the duration and/or the start time to each of the subroutines may be based on at least one workflow parameter.

In some embodiments, assigning the duration and/or the start time to each of the subroutines may be based on at least one boundary condition. Additionally or alternatively, assigning the duration and/or the start time to each of the subroutines is based on the information on the chromatography system. Additionally or alternatively, assigning the duration and/or the start time to each of the subroutines may be based on the additional information on the chromatographic application.

Generally, assigning a duration and a start time to each of the subroutines may comprise assigning a minimum duration required based on the selected default workflow and/or workflow parameters.

The method may further comprise customizing the workflow through adjustment of workflow parameters. Further, the method may comprise displaying dependencies of workflow parameters during customization. Additionally or alternatively, customizing the workflow may comprise adjusting the start time of at least one subroutine. Thus, relative timing between subroutines may be changed and subroutines may even be rearranged, i.e. the sequence of subroutines may be changed. Adjusting the start time of a subroutine may comprise receiving a user input. Receiving a user input may comprise the user moving at least one item in the displayed workflow in the first direction to adjust the start time of the associated subroutine. Additionally or alternatively, receiving a user input may comprise receiving a start time for at least one subroutine.

Customizing the workflow may comprise adjusting the duration of at least one subroutine. Adjusting the duration of a subroutine may comprise receiving a user input. Receiving a user input may comprise the user resizing at least one item in the displayed workflow in the first direction to adjusting the duration of the associated subroutine. Additionally or alternatively, receiving a user input may comprise receiving a duration for at least one subroutine. Receiving a duration for at least one subroutine may comprise the user selecting a displayed item and providing a duration for said item.

The method may further comprise the user selecting an item representing a subroutine; and displaying workflow parameters associated with the selected item. Further, the method may comprise the user adjusting at least one of the displayed workflow parameters. Yet further, the method may comprise displaying updated workflow parameters based on the at least one adjusted workflow parameter.

The method may comprise enforcing the at least one boundary condition. That is, the method may not allow certain amendments of the workflow which would violate a boundary condition, for example switching certain subroutines. For example, when adjusting a workflow parameter, associated boundary conditions may be indicated (e.g., displayed).

Customizing the workflow may comprise updating the cycle time t_{cycle}.

Additionally or alternatively, customizing the workflow may updating the detector uptime tᵤₚₜᵢₘₑ. Updating the cycle time and/or detector uptime may advantageously allow to directly visualise an impact of any customization made. This may advantageously allow a user to better understand consequences of amendments performed during customization.

At least one boundary condition may relate to a gradient delay volume V_{GDV}. It will be understood that the gradient delay volume (GDV) V_{GDV} denotes the volume the fluidic path between a point where the gradient is formed and the separation column. The method may further comprise optimizing timing and/or duration of subroutines based on the gradient delay volume and/or at least one boundary condition associated with the gradient delay volume. The optimizing timing and/or duration of subroutines based on the gradient delay volume and/or at least one boundary condition associated with the gradient delay volume may be performed automatically.

The method may comprise determining the gradient delay volume. Determining the gradient delay volume may be based on the fluidic configuration of the chromatography system. Additionally or alternatively, determining the gradient delay volume may be based on the information on the chromatography system.

In some embodiments, determining the gradient delay volume may comprise measuring the gradient delay volume. Alternatively, the method may comprise receiving the gradient delay volume.

The optimizing timing and/or duration of subroutines based on the gradient delay volume and/or at least one boundary condition associated with the gradient delay volume may comprise shifting the start time of the acquisition subroutine t_{start,acq} by a gradient delay time t_{GDV} with respect to the start time of the gradient subroutine t_{start,grad}. Shifting the start time of the acquisition subroutine t_{start,acq} may comprise adding a wait subroutine with a duration t_{wait} corresponding to the gradient delay time t_{GDV}.

The duration of the gradient delay time t_{GDV} may be configured to account for the gradient delay volume V_{GDV}. That is, it may be chosen such that it may denote the duration that is required for fluid composing the gradient start condition to actually reach the detector.

The plurality of workflow parameters may comprise the gradient delay time t_{GDV} and/or the gradient delay volume V_{GDV}.

Therein the method may comprise identifying an unnecessarily large gradient delay volume in the fluidic setup of the chromatography system. The method may further comprise indicating an identified, unnecessarily large gradient delay volume to the user.

The method may comprise suggesting a different fluidic configuration of the chromatography setup to optimize the gradient delay volume. That is, the method may comprise identifying an origin of an unnecessary large delay volume, indicating it to the user and/or suggesting a potential change to the fluidic configuration of the setup that may allow for a lower gradient delay volume.

The method may comprise displaying an impact of a different fluidic configuration on the gradient delay volume. Again, displaying the impact of a different fluidic configuration may advantageously facilitate the user with understanding the consequences of such a change in fluidic configuration.

The method may comprise displaying an impact of the gradient delay volume on the workflow execution.

The method may further comprise optimizing workflow parameters based on the additional information on the chromatographic application. The optimizing based on additional workflow parameters may comprise the sample pickup subroutine comprising applying air gaps during sample pickup for hydrophobic samples in aqueous solution. Alternatively, the optimizing based on additional workflow parameters may comprise reducing volume(s) employed during trap and/or column loading subroutine(s) to a minimum for hydrophilic samples. The optimizing based on additional workflow parameters may comprise adjusting draw rate f_{draw}, and/or draw delay t_{delay} for the sample pickup routine based on the viscosity of the sample. Generally, the optimizing workflow parameters based on the additional information on the chromatographic application may be performed automatically.

Receiving at least one input parameter may comprise receiving a flow regime. The flow regime may generally relate to any flow rate relevant to the field of UHPLC and particularly be one of nano or capillary flow (NAN/CAP), or micro flow (MIC). Additionally or alternatively, receiving at least one input parameter may comprise receiving a fluidic configuration for the workflow. The fluidic configuration may comprise geometric properties of conduits, such as volume, inner diameter etc.

Receiving at least one input parameter may comprise receiving at least one input parameter for separation column(s) and/or trap column(s) comprised by the chromatography system. The at least one input parameter may comprise one or more of a void volume, a maximum allowed pressure, a maximum allowed flow, a maximum allowed temperature and/or a maximum allowed pressure increase/decrease of a respective column. It will be understood that the void volume is a workflow parameter and that the other values are boundary conditions. Additionally or alternatively, the at least one input parameter may comprise a backpressure of a respective column. This backpressure may be solvent-dependent. Thus, it may for example be specified for different solvents, or alternatively a “worst case” backpressure, i.e., the highest backpressure for the solvents used may be given to provide an upper boundary.

The method may comprise automatically determining the backpressure of at least one trap and/or separation column through measurement and storing the determined backpressure in the chromatography system.

In some embodiments, receiving at least input parameter may comprise receiving at least one input parameter associated with the gradient subroutine. The at least one input parameter may comprise the duration of the gradient subroutine t_{grad}.

Receiving at least one input parameter may comprise receiving at least one input parameter related to sample handling. Additionally or alternatively, receiving at least one input parameter may comprise receiving at least one input parameter related to sample pickup subroutine. The at least one input parameter may comprise a lower limit for the injection volume V_{inj,min} and/or the draw rate f_{draw}

In some embodiments, receiving at least one input parameter may comprise receiving at least one input parameter related to column conditioning, and/or trap loading and/or column loading subroutines.

The at least one input parameter may comprise one or more of the volume for column loading V_{colload}, the volume for column washing V_{colwash}, the volume for column equilibration V_{coleq}, the volume for trap loading V_{trapoad}, the volume for column washing V_{trapwash} and/or the volume for column equilibration V_{trapeq}.

In some embodiments, providing at least one boundary condition may comprise providing a minimum flow rate and/or a maximum flow rate based on the received flow regime. Additionally or alternatively, providing at least one boundary condition may comprise providing a maximum injection volume V_{inj,max} based on the received flow regime particularly providing at least one boundary condition may comprise determining a maximum injection volume V_{inj,max}.

Providing at least one boundary condition may comprise determining a minimum gradient time t_{grad,min}. Determining the minimum gradient time t grad,min may comprise determining whether a minimum total duration of column conditioning subroutines t_{colconditioning,min} is shorter or longer than a minimum total duration of sampling handling subroutines t_{sampler,min}, and wherein t_{grad,min} may be determined to correspond to the larger of the two and where applicable additionally a minimum column loading time t_{colload,min}.

Further, automatically assigning a duration and a start time to each of the subroutines may comprise adjusting the duration of the shorter one of t_{colconditioning,min} and t_{sampler,min} to match the duration of the longer one. The adjusting the duration may comprise prolonging the initially assigned duration of subroutines and/or adding a wait subroutine.

Providing at least one boundary condition may comprise one or more of determining a minimum sample pick up speed f_{draw}, min, determining a maximum column-loading excess volume V_{colloadex}, max, determining a maximum trap-loading excess volume V_{traploadex,max}, determining a maximum column wash volume V_{colwash,max}, determining a maximum trap wash volume V_{trapwash,max}.

An extra time tₑₓₜᵣₐ may be given as a difference between the duration of the gradient subroutine and the minimum gradient time tₑₓₜᵣₐ=t_{grad}−t_{grad,min}. The duration of subroutines may be constrained to their respective minimum values if tₑₓₜᵣₐ=0. Additionally or alternatively, the method may comprise allocating available extra time to present subroutines and/or adding a wait subroutine for each system module, respectively. Allocating the available extra time may comprise redistributing the extra time between present subroutines and/or an added wait subroutine by means of respective weighting factors that add up to 1. The respective weighting factors may be proportional to the respective duration previously assigned to the subroutines, preferably the respective minimum duration assigned previously assigned to the subroutines. Alternatively, wherein the method may comprise receiving the respective weighting factors.

Allocating the available extra time to the autosampler module may comprise adding a wait subroutine with a length at most corresponding to the extra time. Additionally or alternatively, allocating the available extra time to the autosampler module may comprise adjusting the duration of trap wash subroutine and/or trap equilibration subroutine. Additionally or alternatively, allocating the available extra time to the autosampler module may comprise adjusting the duration of column wash subroutine and/or column equilibration subroutine. Additionally or alternatively, allocating the available extra time to the autosampler module further comprises adjusting the column loading subroutine.

The system may be a system as described in the following.

In a further aspect, the present invention relates to a chromatography system comprising a controller, wherein the controller is configured to execute a workflow on the chromatography system. The workflow may be set up using the above-described method.

Particularly, the controller may be configured to perform the method for setting up a workflow according to the above-described method.

The system may comprise at least one pump, an autosampler, at least one separation column and at least one detector. The system may further comprise at least one distribution valve.

The autosampler may comprise at least one distribution valve, a sampling device, a sample pick-up means and a seat for receiving the sample pick-up means.

The detector may comprise a mass spectrometer.

The system may comprise an electrospray ionization source. The electrospray ionization source may be a double-barrel electrospray ionization source.

The system may comprise two separation columns. Additionally or alternatively, the system may comprise at least one trap column. In some embodiments, the system may comprise two trap columns.

The system may comprise two pumps.

The system may comprise a sample storage, preferable a sample loop. The sample storage may be directly fluidly connected to the sample pick-up means.

The system may comprise a waste.

The controller may comprise a data processing unit. Particularly, the controller may comprise a microprocessor.

In another aspect, the present invention relates to a computer program product comprising instructions which, when the program is executed by a processor, cause the processor to carry out the method as described above.

In a further aspect, the present invention relates to a data carried signal carrying the computer program product.

In yet another aspect, the present invention relates to a non-transitory computer-readable medium comprising instructions which, when executed by a processor, cause the processor to carry out the method as described above embodiments.

In a further aspect, the present invention relates to a data carried signal carrying the computer program product.

The present invention is also defined by the following numbered embodiments.

Below, reference will be made to method embodiments. These embodiments are abbreviated by the letter “M” followed by a number. Whenever reference is herein made to “method embodiments”, these embodiments are meant.

M1. Method for setting up a workflow for a chromatography system, wherein the workflow comprises a plurality of workflow parameters, the method comprising
providing subroutines of the workflow;
providing at least one boundary condition for at least one workflow parameter;
assigning a duration and a start time to each of the subroutines; and
generating the workflow by combining the subroutines.

It will be understood that a start time may generally be defined with respect to a start of the workflow, e.g., a subroutine may be assigned a start time of 5 seconds after the start of the workflow. In other words, the start of the workflow may define a reference point which may for example correspond to a start time of 0 s.

M2. The method according to the preceding method embodiment, wherein the method comprises displaying at least a part of the workflow, wherein displaying at least a part of the workflow comprises displaying at least a selection of the subroutines;
wherein each displayed subroutine is represented as an item, respectively;
wherein a position in a first direction of each item is indicative of the start time of the respective subroutine relative to the other subroutines; and
wherein an expansion in the first direction of each item is indicative of the duration of the respective subroutine.

M3. The method according to the preceding method embodiment, wherein displaying at least a part of the workflow comprises displaying each subroutine.

M4. The method according to the penultimate method embodiments, wherein the selection of subroutines comprises all subroutines concerning handling of fluids.

M5. The method according to any of the 3 preceding method embodiments, wherein the selection of subroutines does not comprise subroutines solely concerning changing of a fluidic configuration of the chromatography system.

M6. The method according to any of the 4 preceding method embodiments, wherein displaying at least a part of the workflow comprises displaying at least one of the last least one boundary condition.

M7. The method according to any of the 5 preceding method embodiments, wherein displaying at least a part of the workflow comprises displaying at least one interdependence of subroutines.

M8. The method according to any of the 6 preceding method embodiments, wherein the method comprises displaying workflow parameters related to a subroutine upon request of a user.

M9. The method according to any of the preceding method embodiments, wherein the system comprises a plurality of system modules operated in parallel.

M10. The method according to the preceding method embodiment, wherein each subroutine is associated to at least one system module.

M11. The method according to the preceding method embodiment and with the features of M2, wherein a position of each item in a second direction perpendicular to the first direction is indicative of the association to a system module of the respective item.

M12. The method according to any of the preceding method embodiments, wherein the method further comprises saving the generated workflow as a data file and/or in a database.

M13. The method according to any of the preceding method embodiments, wherein the method further comprises operating the chromatography system according to the generated workflow.

M14. The method according to the preceding method embodiment, wherein operating the chromatography system according to the generated workflow comprises controlling the chromatography system in accordance with the generated workflow.

M15. The method according to any of the 2 preceding method embodiments and with the features of M9, wherein operating the chromatography system according to the generated workflow comprises controlling the system modules of the chromatography system in accordance with the generated workflow.

M16. The method according to any of the preceding method embodiments, wherein the method is a computer-implemented method.

M17. The method according to any of the preceding method embodiments, wherein the method further comprises receiving at least one input parameter.

It will be understood that receiving for example an input parameter or any other information may comprise the user providing such information, e.g., by means of a user input through a user interface, as well as for example receiving such information from an ID tag.

M17a. The method according to the preceding method embodiment, wherein receiving at least one input parameter comprises updating at least one input parameter.

M18. The method according to any of the 2 preceding method embodiments, wherein the at least one input parameter comprises at least one workflow parameter.

M18a. The method according to the preceding method embodiment, wherein receiving at least one workflow parameter comprises enforcing any associated boundary condition.

M19. The method according to any of the 4 preceding method embodiments, wherein the at least one input parameter comprises at least one boundary condition for at least one workflow parameter.

M20. The method according to any of the 5 preceding method embodiments, wherein providing the at least one boundary condition for at least one workflow parameter is based on at least one of the at least one input parameter.

M21. The method according to any of the preceding method embodiments, wherein providing at least one boundary condition comprises automatically determining at least one boundary condition based on at least one workflow parameter, at least one boundary condition and/or at least one provided subroutine.

M22. The method according to any of the preceding method embodiments, wherein the method comprises suggesting a change of workflow parameters to optimize the workflow.

M23. The method according to any of the preceding method embodiments and with the features of M9, wherein the plurality of system modules comprises at least one autosampler module.

M24. The method according to the preceding method embodiment, wherein the autosampler module comprises at least one autosampler comprising a sampling device, a sample pick-up means, a seat for receiving the sample pick-up means, and a distribution valve.

M25. The method according to any of the 2 preceding method embodiments, wherein the autosampler module further comprises a sample storage, preferably a sample loop.

M26. The method according to any of the preceding method embodiments and with the features of M9, wherein the plurality of system modules comprises at least one pump module.

M27. The method according to the preceding method embodiment, wherein the at least one pump module comprises a gradient pump module.

M28. The method according to any of the 3 preceding method embodiments, wherein the at least one pump module comprises an equilibration pump module.

M29. The method according to any of the preceding method embodiments and with the features of M9, wherein the plurality of system modules comprises a column compartment module.

M30. The method according to the preceding method embodiment, wherein the column compartment module comprises at least one separation column.

M31. The method according to any of the 2 preceding method embodiments, wherein the column compartment module comprises at least one trap column.

M32. The method according to any of the 3 preceding method embodiments, wherein the column compartment module comprises at least one distribution valve.

M33. The method according to any of the preceding method embodiments and with the features of M9, wherein the plurality of system modules comprises at least one detector module.

M34. The method according to any of the preceding method embodiments, wherein the provided subroutines are selected from a plurality of predefined subroutines.

M35. The method according to the preceding method embodiment, wherein the plurality of predefined subroutines comprises a loop wash subroutine, wherein the loop wash subroutine comprises washing of a sample storage, preferably a sample loop.

M36. The method according to the preceding method embodiment and with the features of M23, wherein the loop wash subroutine is associated with the autosampler module.

M37. The method according to the penultimate method embodiment and with the features of M26, wherein the loop wash subroutine is associated with one of the at least one pump module, preferably the equilibration pump module.

M38. The method according to any of the 3 preceding method embodiments and with the features of M25, wherein the sample storage is the sample storage that is comprised by the autosampler module.

M39. The method according to any of the 4 preceding method embodiments, wherein the duration of the loop wash subroutine depends on a number of loop-wash iterations #_{lwash}, a volume per loop-wash iteration V_{lwash} as well as a loop-wash rate f_{lwash}.

M40. The method according to the preceding method embodiment, wherein the duration of the loop wash subroutine is t_{lwash}=#_{lwash}*V_{lwash}/f_{lwash}.

M41. The method according to any of the preceding method, wherein the plurality of workflow parameters comprises:
the number of loop-wash iterations #_{lwash} for washing a sample storage, preferably a sample loop, the volume per loop-wash iteration V_{lwash}, and the loop-wash rate f_{lwash}.

M42. The method according to any of the preceding method embodiments, wherein the plurality of workflow parameters comprises the duration of the loop wash subroutine t_{lwash}.

M43. The method according to any of the preceding method embodiments, wherein the plurality of workflow parameters comprises a start time of the loop wash subroutine t_{start,lwash}.

M44. The method according to any of the preceding method embodiments and with the features of M34, wherein the plurality of predefined subroutines comprises a trap wash subroutine, wherein the trap wash subroutine comprises washing a respective trap column.

M45. The method according to the preceding method embodiment and with the features of M23, wherein the trap wash subroutine is associated with the autosampler module.

M46. The method according to the penultimate method embodiment and with the features of M26, wherein the trap wash subroutine is associated with one of the at least one pump module, preferably the equilibration pump module.

M47. The method according to any of the 3 preceding method embodiments, wherein the duration of the trap wash subroutine depends on a volume for trap washing V_{trapwash}.

M48. The method according to the preceding method embodiment, wherein the volume for trap washing is given as V_{trapwash}=X_{trapwash}*V_{trapcol}, wherein V_{trapcol} denotes a void volume of the respective trap column and X_{trapwash} denotes a trap-wash factor.

M49. The method according to any of the 2 preceding method embodiments, wherein the trap wash subroutine comprises a flow-controlled wash and wherein the duration of the trap wash subroutine further depends on a trap-wash rate f_{trapwash}, wherein the duration of the trap wash is preferably t_{trapwash}=V_{trapwash}/f_{trapwash}.

M50. The method according to any of method embodiments M44 to M48, wherein the trap wash subroutine comprises a pressure-controlled wash and wherein the duration of the trap wash subroutine depends on a trap-related backpressure Rₜᵣₐₚ and a trap-wash pressure P_{trapwash}.

M51. The method according to the preceding method embodiment and with the features of M47, wherein the duration of the trap wash subroutine is approximated as t_{trapwash}≈V_{trapwash}*Rₜᵣₐₚ/P_{trapwash}.

M52. The method according to the preceding method embodiment, wherein a trap-wash safety margin t_{add,trapwash} is added to account for variations in the actual duration, such that the duration of trap wash subroutine is given as t_{trapwash}=V_{trapwash}*Rₜᵣₐₚ/P_{trapwash}+t_{add,trapwash}.

M53. The method according to any of the preceding method embodiments, wherein the plurality of workflow parameters comprises the volume for trap washing V_{trapwash}.

M54. The method according to any of the preceding method embodiments, wherein the plurality of workflow parameters comprises the trap-wash rate f_{trapwash}.

M55. The method according to any of the preceding method embodiments, wherein the plurality of workflow parameters comprises the trap-wash pressure P_{trapwash}.

M56. The method according to any of the preceding method embodiments, wherein the plurality of workflow parameters comprises the trap-wash safety margin t_{add,trapwash}.

M57. The method according to any of the preceding method embodiments, wherein the plurality of workflow parameters comprises a trap column temperature.

M58. The method according to any of the preceding method, wherein the plurality of workflow parameters comprises the duration of the trap wash subroutine t_{trapwash}.

M59. The method according to any of the preceding method embodiments, wherein the plurality of workflow parameters comprises a start time of the trap wash subroutine t_{start,trapwash}.

M60. The method according to any of the preceding method embodiments and with the features of M34, wherein the plurality of predefined subroutines comprises a trap equilibration subroutine for equilibrating a respective trap column.

M61. The method according to the preceding method embodiment and with the features of M23, wherein the trap equilibration subroutine is associated with the autosampler module.

M62. The method according to the penultimate method embodiment and with the features of M26, wherein the trap equilibration subroutine is associated with one of the at least one pump module, preferably the equilibration pump module.

M63. The method according to any of the 2 preceding method embodiments, wherein the duration of the trap equilibration subroutine depends on a volume for trap equilibration V_{trapeq}.

M64. The method according to the preceding method embodiment, wherein the volume for trap equilibration is given as V_{trapeq}=X_{trapeq}*V_{trapcol}, wherein V_{trapcol} denotes a void volume of the respective trap column and X_{trapeq} denotes a trap-equilibration factor.

M65. The method according to any of the 2 preceding method embodiments, wherein the trap equilibration subroutine comprises a flow-controlled equilibration and wherein the duration of the trap equilibration subroutine further depends on a trap-equilibration rate f_{trapeq}.

M66. The method according to the preceding method embodiment, wherein the duration of the trap equilibration is given as t_{trapeq}=V_{trapeq}/f_{trapeq}.

M67. The method according to any of method embodiments M60 to M64, wherein the trap equilibration subroutine comprises a pressure-controlled equilibration and wherein the duration of the trap equilibration subroutine depends on the trap-related backpressure Rₜᵣₐₚ and a trap-equilibration pressure P_{trapeq}.

M68. The method according to the preceding method embodiment and with the features of M63, wherein the duration of the trap equilibration subroutine is approximated as t_{rapeq}≈V_{trapeq}*Rₜᵣₐₚ/P_{trapeq}.

M69. The method according to the preceding method embodiment, wherein a trap-equilibration safety margin t_{add,trapeq} is added to account for variations in the actual duration, such that the duration of the trap equilibration subroutine is given as t_{rapeq}=V_{trapeq}*Rₜᵣₐₚ/P_{trapeq}+t_{add,trapeq}.

M70. The method according to any of the preceding method embodiments, wherein the plurality of workflow parameters comprises the volume for trap equilibration V_{trapeq}.

M71. The method according to any of the preceding method embodiments, wherein the plurality of workflow parameters comprises the trap-equilibration rate f_{trapeq}.

M72. The method according to any of the preceding method embodiments, wherein the plurality of workflow parameters comprises the trap-equilibration pressure P_{trapeq}.

M73. The method according to any of the preceding method embodiments, wherein the plurality of workflow parameters comprises the trap-equilibration safety margin t_{add,trapeq}.

M74. The method according to any of the preceding method embodiments, wherein the plurality of workflow parameters comprises the duration of the trap equilibration subroutine t_{rapeq}.

M75. The method according to any of the preceding method embodiments, wherein the plurality of workflow parameters comprises a start time of the trap equilibration subroutine t_{start,rapeq}.

M76. The method according to any of the preceding method embodiments and with the features of M34, wherein the plurality of predefined subroutines comprises an init subroutine comprising an initialization of an autosampler comprised by the chromatography system.

M77. The method according to the preceding method embodiment and with the features of M23, wherein the init subroutine is associated with the autosampler module.

M78. The method according to any of the 2 preceding method embodiments and with the features of 24, wherein the autosampler is the autosampler comprised by the autosampler module.

M79. The method according to any of the 3 preceding method embodiments and with the features of M24, wherein the init subroutine comprises setting the sampling device to a desired position for subsequent sample pickup.

M80. The method according to the preceding method embodiment, wherein the duration of the init subroutine depends on a momentary position of the sampling device, an idle volume of the sampling device and a moving speed of the sampling device, particularly a drive thereof.

M81. The method according to the preceding method embodiment, wherein the idle volume and/or the moving speed are determined based on an injection Volume Vᵢₙⱼ of a subsequent sample pick-up.

M82. The method according to any of the 6 preceding method embodiments, wherein the duration of the init subroutine depends on the injection Volume Vᵢₙⱼ of a subsequent sample pick-up.

M83. The method according to any of the preceding method embodiments, wherein the plurality of workflow parameters comprises.
the momentary position of the sampling device,
the idle volume of the sampling device, and
the moving speed of the sampling device.

M84. The method according to any of the preceding method embodiments, wherein the plurality of workflow parameters comprises the injection Volume Vᵢₙⱼ. M85. The method according to any of the preceding method embodiments, wherein the plurality of workflow parameters comprises the duration of the init subroutine tᵢₙᵢₜ.

M86. The method according to any of the preceding method embodiments, wherein the plurality of workflow parameters comprises a start time of the init subroutine t_{start,init}.

M87. The method according to any of the preceding method embodiments and with the features of M34, wherein the plurality of predefined subroutines comprises a sample pickup subroutine comprising picking up at least a portion of a sample.

M88. The method according to the preceding method embodiment, wherein the sample pickup subroutine is associated with the autosampler module.

M89. The method according to any of the 2 preceding method embodiments, wherein the duration of the sample pickup subroutine depends on the injection Volume Vᵢₙⱼ, a draw rate f_{draw}, and a draw delay t_{delay}.

M90. The method according to the preceding method embodiment, wherein the duration of the sample pickup routine is given as t_{pickup}=Vᵢₙⱼ/f_{draw}+t_{delay}.

M91. The method according to the preceding method embodiment, wherein the sample pick up routine comprises at least one additional washing step with a duration t_{pwash} and wherein the duration of the sample pickup routine is thus given as t_{pickup}=Vᵢₙⱼ/f_{draw}+t_{delay}+t_{pwash}.

M92. The method according to any of the preceding method embodiments, wherein the plurality of workflow parameters comprises the draw rate f_{draw}.

M93. The method according to any of the preceding method embodiment, wherein the plurality of workflow parameters comprises the draw delay t_{delay}.

M94. The method according to any of the preceding method embodiments, wherein the plurality of workflow parameters comprises the duration of the at least one additional washing step during sample pickup subroutine t_{pwash}.

M95. The method according to any of the preceding method embodiments, wherein the plurality of workflow parameters comprises the duration of the sample pickup subroutine t_{pickup}.

M96. The method according to any of the preceding method embodiments, wherein the plurality of workflow parameters comprises a start time of the sample pickup subroutine t_{start,pickup}.

M97. The method according to any of the preceding method embodiments and with the features of M34, wherein the plurality of predefined subroutines comprises a trap loading subroutine for providing a sample to a respective trap column.

M98. The method according to the preceding method embodiment and with the features of M23, wherein the trap loading subroutine is associated with the autosampler module.

M99. The method according to the penultimate method embodiment and with the features of M26, wherein the trap loading subroutine is associated with one of the at least one pump module, preferably the equilibration pump module.

M100. The method according to any of the 2 preceding method embodiments, wherein the duration of the trap loading subroutine depends on a volume for trap loading V_{trapload}.

M101. The method according to the preceding method embodiment, wherein the volume for trap loading is given as V_{trapload}=Vᵢₙⱼ+V_{traploadex}, wherein V_{traploadex} denotes a trap loading excess volume configured to ensure that the sample is entirely loaded onto the trap column.

M102. The method according to any of the 2 preceding method embodiments and with the features of M84 or M89, wherein the volume for trap loading is given as V_{trapload}=X_{trapload}*Vₜᵣₐₚ+Vᵢₙⱼ, wherein Vₜᵣₐₚ denotes a void volume of the separation column and X_{trapload} denotes a trap-loading factor.

M103. The method according to any of the 3 preceding method embodiments, wherein the trap loading subroutine comprises a flow-controlled loading and wherein the duration of the trap loading subroutine further depends on a trap-loading rate f_{trapload}.

M104. The method according to the preceding method embodiment, wherein the duration of the trap loading is given as t_{trapload}=V_{trapload}/f_{trapload}.

M105. The method according to any of method embodiments M97 to M102, wherein the trap loading subroutine comprises a pressure-controlled loading and wherein the duration of the trap loading subroutine depends on the trap-related backpressure Rₜᵣₐₚ and a trap-loading pressure P_{trapload}.

M106. The method according to the preceding method embodiment and with the features of M100, wherein the duration of the trap loading subroutine is approximated as t_{trapload}≈V_{trapload}*Rₜᵣₐₚ/P_{trapload}.

M107. The method according to the preceding method embodiment, wherein a trap-loading safety margin t_{add,trapload} is added to account for variations in the actual duration, such that the duration of the trap loading subroutine is given as t_{trapload}=V_{trapload}*Rₜᵣₐₚ/P_{trapload}+t_{add,trapload}.

M108. The method according to any of the preceding method embodiments, wherein the plurality of workflow parameters comprises the volume for trap loading V_{trapload}.

M109. The method according to any of the preceding method embodiments, wherein the plurality of workflow parameters comprises the trap-loading rate f_{trapload}.

M110. The method according to any of the preceding method embodiments, wherein the plurality of workflow parameters comprises the trap-loading pressure P_{trapload}.

M111. The method according to any of the preceding method embodiments, wherein the plurality of workflow parameters comprises the trap-loading safety margin t_{add,trapload}.

M112. The method according to any of the preceding method embodiments, wherein the plurality of workflow parameters comprises the duration of the trap loading subroutine t_{trapload}.

M113. The method according to any of the preceding method embodiments, wherein the plurality of workflow parameters comprises a start time of the trap loading subroutine t_{start,trapload}.

M114. The method according to any of the preceding method embodiments and with the features of M50, M67 or M105, wherein the trap-related backpressure Rₜᵣₐₚ relates to the backpressure in a flow path comprising the trap column during the trap wash, trap equilibration and/or trap loading subroutine.

M115. The method according to any of the preceding method embodiments and with the features of M50, M67 or M105, wherein the trap-related backpressure Rₜᵣₐₚ is derived from a lookup table, from historical (measured) values or by means of measuring.

M116. The method according to any of the preceding method embodiments and with the features of M50, M67 or M105, wherein statistical methods and/or statistical learning such as machine learning techniques are employed for deriving Rₜᵣₐₚ.

M117. The method according to any of the preceding method embodiments, wherein the method comprises measuring the trap-related backpressure Rₜᵣₐₚ.

M118. The method according to any of the preceding method embodiments, wherein the plurality of workflow parameters comprises the trap-related backpressure Rₜᵣₐₚ.

M119. The method according to any of the preceding method embodiments and with the features of M34, wherein the plurality of predefined subroutines comprises a precompression subroutine comprising pressurizing the sample prior to injection into a separation column.

M120. The method according to the preceding method embodiment and with the features of M23, wherein the trap loading subroutine is associated with the autosampler module.

M121. The method according to any of the 2 preceding method embodiments, wherein the precompression subroutine comprises pressurizing an injection flow path.

It will be understood that the injection flow path may denote the fluidic path that is fluidly connected to the separation column for injection of the sample into the separation column, which may typically comprise a trap column and/or sample storage, e.g., sample loop.

M122. The method according to any of the 3 preceding method embodiments, wherein the precompression subroutine comprises pressurizing the sample storage, preferably sample loop.

M123. The method according to any of the 4 preceding method embodiments, wherein the precompression subroutine comprises pressurizing a respective trap column.

M124. The method according to any of the 5 preceding method embodiments, wherein pressurizing comprises elevating the pressure from an initial pressure Pᵢₙᵢₜ to a precompression pressure P_{compress}.

M125. The method according to the preceding method embodiment, wherein the initial pressure corresponds to ambient pressure.

M126. The method according to any of the 2 preceding method embodiments, wherein the precompression pressure approximates analytical pressure at the respective separation column during separation.

M127. The method according to any of the 3 preceding method embodiments, wherein the precompression pressure is at least 50 bar, preferably at least 100 bar, more preferably at least 500 bar.

M128. The method according to any of the 4 preceding method embodiments, wherein the duration of the precompression subroutine depends on a pressure difference between the initial pressure and the precompression pressure.

M129. The method according to any of the 9 preceding method embodiments, wherein the duration of the precompression subroutine depends on a speed employed for compression.

M130. The method according to any of the 10 preceding method embodiments, wherein the duration of the precompression subroutine depends on a volume to be pressurized.

M131. The method according to any of the 11 preceding method embodiments, wherein the duration of the precompression subroutine depends on viscosity and/or compressibility of solvent(s) and/or sample to be pressurized.

M132. The method according to any of the 12 preceding method embodiments, wherein the duration of the precompression subroutine t_{precomp} is assigned a fixed duration in the range of 1 to 60 s, preferably 1 to 20 s, more preferably 1 to 5 s.

M133. The method according to any of the preceding method embodiments, wherein the plurality of workflow parameters comprises the initial pressure Pᵢₙᵢₜ.

M134. The method according to any of the preceding method embodiments, wherein the plurality of workflow parameters comprises the precompression pressure P_{compress}.

M135. The method according to any of the preceding method embodiments, wherein the plurality of workflow parameters comprises the speed employed for compression within the precompression subroutine.

M136. The method according to any of the preceding method embodiments, wherein the plurality of workflow parameters comprises the volume to be pressurized within the precompression subroutine.

M137. The method according to any of the preceding method embodiments, wherein the plurality of workflow parameters comprises the viscosity and/or compressibility of the solvent(s).

M138. The method according to any of the preceding method embodiments, wherein the plurality of workflow parameters comprises the viscosity and/or compressibility of the sample.

M139. The method according to any of the preceding method embodiments, wherein the plurality of workflow parameters comprises the duration of the precompression subroutine t_{precomp}.

M140. The method according to any of the preceding method embodiments, wherein the plurality of workflow parameters comprises a start time of the precompression subroutine t_{start,precomp}.

M141. The method according to any of the preceding method embodiments and with the features of M34, wherein the plurality of predefined subroutines comprises an inject subroutine comprising switching a flow path comprising the sample into a respective flow path to the separation column.

M142. The method according to the preceding method embodiment, wherein the inject subroutine is assigned a fixed duration in the range of 0 to 10 s, preferably 0 to 5 s, more preferably 0 min to 1 s.

M143. The method according to any of the preceding method embodiments, wherein the plurality of workflow parameters comprises the duration of the inject subroutine tᵢₙⱼ.

M144. The method according to any of the preceding method embodiments, wherein the plurality of workflow parameters comprises a start time of the inject subroutine t_{start,inj}.

M145. The method according to any of the preceding method embodiments and with the features of M34, wherein the plurality of predefined subroutines comprises a column wash subroutine comprising washing of a respective separation column.

M146. The method according to the preceding method embodiment and with the features of M26, wherein the column wash subroutine is associated with one of the at least one pump module.

M147. The method according to any of the 2 preceding method embodiments and with the features of M28, wherein the column wash subroutine is associated with the equilibration pump module.

M148. The method according to any of the 3 preceding method embodiments, wherein the duration of the column wash subroutine depends on a volume for column washing V_{colwash}.

M149. The method according to the preceding method embodiment, wherein the volume for column washing is given as V_{colwash}=X_{colwash}*V_{col}, wherein V_{col} denotes the void volume of the respective separation column and X_{colwash} denotes a column-wash factor.

M150. The method according to any of the 2 preceding method embodiments, wherein the column wash subroutine comprises a flow-controlled wash and wherein the duration of the column wash subroutine further depends on a column-wash rate f_{colwash}.

M151. The method according to the preceding method embodiment, wherein the duration of the column wash is given as t_{colwash}=V_{colwash}/f_{colwash}.

M152. The method according to any of method embodiments M145 to M149, wherein the column wash subroutine comprises a pressure-controlled wash and wherein the duration of the column wash subroutine further depends on a column-related backpressure R_{col} and a column-wash pressure P_{colwash}.

M153. The method according to the preceding method embodiment and with the features of M148, wherein the duration of the column wash subroutine is approximated as t_{colwash}≈V_{colwash}*R_{col}/P_{colwash}.

M154. The method according to the preceding method embodiment, wherein a column-wash safety margin t_{add,colwash} is added to account for variations in the actual duration, such that the duration of column wash subroutine is given as t_{colwash}=V_{colwash}*R_{col}/P_{colwash}+t_{add,colwash}.

M155. The method according to any of the preceding method embodiments, wherein the plurality of workflow parameters comprises the volume for column washing V_{colwash}.

M156. The method according to any of the preceding method embodiments, wherein the plurality of workflow parameters comprises the column-wash rate f_{colwash}.

M157. The method according to any of the preceding method embodiments, wherein the plurality of workflow parameters comprises the column-wash pressure P_{colwash}.

M158. The method according to any of the preceding method embodiments, wherein the plurality of workflow parameters comprises the column-wash safety margin t_{add,colwash}.

M159. The method according to any of the preceding method embodiments, wherein the plurality of workflow parameters comprises a separation column temperature.

M160. The method according to any of the preceding method embodiments, wherein the plurality of workflow parameters comprises the duration of the column wash subroutine t colwash.

M161. The method according to any of the preceding method embodiments, wherein the plurality of workflow parameters comprises a start time of the trap wash subroutine t_{start,colwash}.

M162. The method according to any of the preceding method embodiments and with the features of M34, wherein the plurality of predefined subroutines comprises a column equilibration subroutine comprising equilibrating of a separation column.

M163. The method according to the preceding method embodiment and with the features of M26, wherein the column equilibration subroutine is associated with one of the at least one pump module.

M164. The method according to any of the 2 preceding method embodiments and with the features of M28, wherein the column equilibration subroutine is associated with the equilibration pump module.

M165. The method according to any of the 3 preceding method embodiments, wherein the duration of the column equilibration subroutine depends on a volume for equilibrating the separation column V_{coleq}.

M166. The method according to the preceding method embodiment, wherein the volume for equilibrating the separation column is given as V_{coleq}=X_{coleq}*V_{col} wherein V_{col}, denotes the void volume of the respective separation column and X_{coleq} denotes a column-equilibration factor.

M167. The method according to any of the 2 preceding method embodiments, wherein the column equilibration subroutine comprises a flow-controlled equilibration and wherein the duration of the column equilibration subroutine further depends on a column-equilibration rate f_{coleq}.

M168. The method according to the preceding method embodiment, wherein the duration of the column equilibration is given as t_{coleq}=V_{coleq}/f_{coleq}.

M169. The method according to any of method embodiments M162 to M166, wherein the column equilibration subroutine comprises a pressure-controlled equilibration and wherein the duration of the column equilibration subroutine depends on the column-related backpressure R_{col} and a column-equilibration pressure P_{coleq}.

M170. The method according to the preceding method embodiment and with the features of M165, wherein the duration of the column equilibration subroutine is approximated as t_{coleq}≈V_{coleq}*R_{col}/P_{coleq}.

M171. The method according to the preceding method embodiment, wherein a column-equilibration safety margin t_{add,coleq} is added to account for variations in the actual duration, such that the duration of column equilibration subroutine is given as t_{coleq}=V_{coleq}*R_{col}/P_{coleq}+t_{add,coleq}.

M172. The method according to any of the preceding method embodiments, wherein the plurality of workflow parameters comprises the volume for column equilibration V_{coleq}.

M173. The method according to any of the preceding method embodiments, wherein the plurality of workflow parameters comprises the column-equilibration rate f_{coleq}.

M174. The method according to any of the preceding method embodiments, wherein the plurality of workflow parameters comprises the column-equilibration pressure P_{coleq}.

M175. The method according to any of the preceding method embodiments, wherein the plurality of workflow parameters comprises the column-equilibration safety margin t_{add,coleq}.

M176. The method according to any of the preceding method embodiments, wherein the plurality of workflow parameters comprises the duration of the column equilibration subroutine t_{coleq}.

M177. The method according to any of the preceding method embodiments, wherein the plurality of workflow parameters comprises a start time of the column equilibration subroutine t_{start,coleq}.

M178. The method according to any of the preceding method embodiments and with the features of M34, wherein the plurality of predefined subroutines comprises a column loading subroutine comprising providing a sample to a respective separation column.

M179. The method according to the preceding method embodiment and with the features of M26, wherein the column loading subroutine is associated with one of the at least one pump module.

M180. The method according to any of the 2 preceding method embodiments and with the features of M28, wherein the column loading subroutine is associated with the equilibration pump module.

M181. The method according to any of the 3 preceding method embodiments, wherein the duration of the column loading subroutine depends on a volume for column loading V_{colload}.

M182. The method according to the preceding method embodiment, wherein the volume for column loading is given as V_{colload}=Vᵢₙⱼ+V_{colloadex}_{^{x}}, wherein V_{colloadex} denotes a column loading excess volume configured to ensure that the sample is entirely loaded onto the respective separation column.

M183. The method according to any of the 2 preceding method embodiments and with the features of M84 or M89, wherein the volume for column loading is given as V_{colload}=X_{colload}*V_{col}+Vᵢₙⱼ, wherein V_{col} denotes a void volume of the respective separation column and X_{colload} denotes a column-loading factor.

M184. The method according to any of the 3 preceding method embodiments, wherein the column loading subroutine comprises a flow-controlled loading and wherein the duration of the column loading subroutine further depends on a column-loading rate f_{colload}.

M185. The method according to the preceding method embodiment, wherein the duration of the column loading subroutine is given as t_{colload}=V_{colload}/f_{colload}.

M186. The method according to any of method embodiments M178 to M181, wherein the column loading subroutine comprises a pressure-controlled loading and wherein the duration of the column loading subroutine further depends on the column-related backpressure R_{col} and a column-loading pressure P_{colload}.

M187. The method according to the preceding method embodiment, wherein the duration of the column loading subroutine is approximated as t_{colload}≈V_{colload}*R_{col}/P_{colload}.

M188. The method according to the preceding method embodiment, wherein a column-loading safety margin t_{add,colload} is added to account for variations in the actual duration, such that the duration of the column loading subroutine is determined as t_{colload}=V_{colload}*R_{col}/P_{colload}+t_{add,colload}.

M189. The method according to any of the preceding method embodiments, wherein the plurality of workflow parameters comprises the volume for column loading V_{colload}.

M190. The method according to any of the preceding method embodiments, wherein the plurality of workflow parameters comprises the volume of the separation column V_{col}.

M191. The method according to any of the preceding method embodiments, wherein the plurality of workflow parameters comprises the column-loading factor X_{colload}.

M192. The method according to any of the preceding method embodiments, wherein the plurality of workflow parameters comprises the column-loading rate f_{colload}.

M193. The method according to any of the preceding method embodiments, wherein the plurality of workflow parameters comprises the column-loading pressure P_{colload}.

M194. The method according to any of the preceding method embodiments, wherein the plurality of workflow parameters comprises the column-loading safety margin t_{add,colload}.

M195. The method according to any of the preceding method embodiments, wherein the plurality of workflow parameters comprises the duration of the column loading subroutine t_{colload}.

M196. The method according to any of the preceding method embodiments, wherein the plurality of workflow parameters comprises a start time of the column loading subroutine t_{start,colload}.

M197. The method according to any of the preceding method embodiments and with the features of M152, M169 or M186, wherein the column-related backpressure R_{col} relates to the backpressure in a flow path comprising the separation column during the column wash, column equilibration and/or column loading subroutine.

M198. The method according to any of the preceding method embodiments and with the features of M152, M169, or M186, wherein the column-related backpressure R_{col} is derived from a lookup table, from historical (measured) values or by means of measuring.

M199. The method according to any of the preceding method embodiments and with the features of M152, M169, or M186, wherein statistical methods and/or statistical learning such as machine learning techniques are employed for deriving R_{col}.

M200. The method according to any of the preceding method embodiments, wherein the method comprises measuring the column-related backpressure R_{col}.

M201. The method according to any of the preceding method embodiments, wherein the plurality of workflow parameters comprises the column-related backpressure R_{col}.

M202. The method according to any of the preceding method embodiments and with the features of M34, wherein the plurality of predefined subroutines comprises a gradient subroutine comprising providing a solvent gradient to a respective separation column.

M203. The method according to the preceding method embodiment and with the features of M26, wherein the gradient subroutine is associated with one of the at least one pump module.

M204. The method according to any of the 2 preceding method embodiments and with the features of M27, wherein the gradient subroutine is associated with the gradient pump module.

M205. The method according to any of the 2 preceding method embodiments, wherein the plurality of workflow parameters comprises the duration of the gradient subroutine t_{grad}.

M206. The method according to any of the 3 preceding method embodiments, wherein the plurality of workflow parameters comprises a start time of the gradient subroutine t_{start,grad}.

M207. The method according to any of the preceding method embodiments and with the features of M34, wherein the plurality of predefined subroutines comprises an align subroutine configured for temporally aligning subroutines.

M208. The method according to any of the preceding method embodiments, wherein the plurality of workflow parameters comprises the duration of the align subroutine t_{align}.

M209. The method according to any of the preceding method embodiments, wherein the plurality of workflow parameters comprises a start time of the align subroutine t_{start.align}.

M210. The method according to any of the preceding method embodiments and with the features of M34, wherein the plurality of predefined subroutines comprises an acquisition subroutine comprising recording data on an effluent.

M211. The method according to the preceding method embodiment and with the features of M202, wherein the duration of the acquisition subroutine is the same as the duration of the gradient subroutine.

M212. The method according to any of the preceding method embodiments, wherein the plurality of workflow parameters comprises the duration of the acquisition subroutine t_{acq}.

M213. The method according to any of the preceding method embodiments, wherein the plurality of workflow parameters comprises a start time of the acquisition subroutine t_{start,acq}.

M214. The method according to any of the preceding method embodiments and with the features of M34, wherein the plurality of predefined subroutines comprises a wait subroutine.

M215. The method according to any of the preceding method embodiments, wherein the plurality of workflow parameters comprises the duration of the wait subroutine t_{wait}.

M216. The method according to any of the preceding method embodiments, wherein the plurality of workflow parameters comprises a start time of the trap equilibration subroutine t_{start,wait}.

M217. The method according to any of the preceding method embodiments and with the features of M145 and M162, wherein column conditioning subroutines comprise a combination of column wash and column equilibration subroutines.

M218. The method according to the preceding method and with the features of M210, wherein column conditioning subroutines further comprise at least one align subroutine.

M219. The method according to any of the preceding method embodiments and with the features of M87, M119 and M76, wherein sample handling subroutines comprise a combination of sample pickup, precompression and init subroutines.

M220. The method according to the preceding method and with the features of M35, wherein sample handling subroutines further comprise at least one loop wash subroutine.

M221. The method according to the preceding method and with the features of M97, wherein sample handling subroutines further comprise at least one trap loading subroutine.

M222. The method according to the preceding method and with the features of M44, wherein sample handling subroutines further comprise at least one trap washing subroutine.

M223. The method according to any of the preceding method embodiments and with the features M10, wherein a boundary condition for duration and start time of subroutines is that there cannot be an overlap in time for subroutines associated with the same module.

M224. The method according to any of the preceding method embodiments, wherein providing at least one boundary condition comprises providing at least one boundary condition directed at a logical order of the provided subroutines.

M225. The method according to any of the preceding method embodiments and with the features M10, wherein providing at least one boundary condition comprises providing at least one boundary condition directed at subroutines associated to different system modules comprising the same start time.

M226. The method according to any of the preceding method embodiments and with the features M10, wherein providing at least one boundary condition comprises providing at least one boundary condition directed at subroutines associated to different system modules ending at the same time.

M227. The method according to any of the preceding method embodiments and with the features of M44 and M60, wherein the at least one provided boundary condition comprises the start time of the trap equilibration subroutine being later than the start time of an associated trap wash subroutine.

M228. The method according to any of the preceding method embodiments and with the features of M87 and M76, wherein the at least one provided boundary condition comprises the start time of the sample pickup subroutine being greater than the start time of an associated init subroutine.

M229. The method according to any of the preceding method embodiments and with the features of M87 and M119, wherein the at least one provided boundary condition comprises the start time of the precompression subroutine being greater than the start time of an associated sample pickup subroutine.

M230. The method according to any of the preceding method embodiments and with the features of M87 and M97, wherein the at least one provided boundary condition comprises the start time of the trap loading subroutine being greater than the start time of an associated sample pickup subroutine.

M231. The method according to any of the preceding method embodiments and with the features of M119 and M97, wherein the at least one provided boundary condition comprises the start time of the precompression subroutine being greater than the start time of an associated trap loading subroutine.

M232. The method according to any of the preceding method embodiments and with the features of M145 and M162, wherein the at least one provided boundary condition comprises the start time of the column equilibration subroutine being greater than the start time of an associated column wash subroutine.

M234. The method according to any of the preceding method embodiments and with the features of M162 and M187, wherein the at least one provided boundary condition comprises the start time of the column loading subroutine being greater than the start time of an associated column equilibration subroutine.

M235. The method according to any of the preceding method embodiments and with the features of M119 und M202, wherein the at least one provided boundary condition comprises the start time of the gradient subroutine being greater than the start time of an associated precompression subroutine.

M236. The method according to any of the preceding method embodiments, wherein the method comprises determining a cycle time t_{cycle} corresponding to the total duration of analysing one sample.

M237. The method according to the preceding method embodiment, wherein the method comprises displaying the cycle time t_{cycle}.

M238. The method according to any of the 2 preceding method embodiments and with the features of M2, wherein displaying at least a part of the workflow comprises displaying the cycle time t_{cycle}.

M239. The method according to any of the 3 preceding method embodiments and with the features of M210, wherein the method comprises determining a detector uptime tᵤₚₜᵢₘₑ corresponding to the duration of the acquisition subroutine relative to the cycle time t_{cycle}.

M240. The method according to the preceding method embodiment, wherein the method comprises displaying the detector uptime tᵤₚₜᵢₘₑ.

M241. The method according to any of the 2 preceding method embodiments and with the features of M2, wherein displaying at least a part of the workflow comprises displaying the detector uptime tᵤₚₜᵢₘₑ.

M242. The method according to any of the 3 preceding method embodiments, wherein the method comprises determining where detector uptime is lost.

M243. The method according to any of the 4 preceding method embodiments, wherein the method comprises indicating where detector uptime is lost.

M244. The method according to any of the 5 preceding method embodiments and with M22, wherein the workflow is optimized with regard to detector uptime.

M245. The method according to any of the 9 preceding method embodiments and with M22, wherein the workflow is optimized with regard to detector cycle time.

M246. The method according to any of the preceding method embodiments, wherein the plurality of workflow parameters comprises the cycle time t_{cycle}.

M247. The method according to any of the preceding method embodiments, wherein the plurality of workflow parameters comprises the detector uptime tᵤₚₜᵢₘₑ.

M248. The method according to any of the preceding method embodiments, wherein the method comprises receiving information on the chromatography system.

It will be understood that the information may be received from a user, i.e. the user may provide the information and/or that information may be received from other sources such as databases or ID tags.

M249. The method according to the preceding method embodiment, wherein the information on the chromatography system includes at least one of comprised hardware components and/or fluidic configuration of the system.

M250. The method according to any of the preceding method embodiments, wherein the method comprises receiving additional information on the chromatographic application for which the workflow is set up.

M251. The method according to the preceding method embodiment, wherein the additional information comprises the type of chromatography, preferably selected from size-exclusion, normal-phase, and reversed-phase chromatography.

M252. The method according to any of the 2 preceding method embodiments, wherein the additional information comprises information about the sample.

M253. The method according to the preceding method embodiment, wherein the information about the sample comprises the affinity of the sample to water, such as hydrophobic or hydrophilic.

M254. The method according to any of the 2 preceding method embodiments, wherein the information about the sample comprises the viscosity of the sample.

M255. The method according to any of the 3 preceding method embodiments, wherein the information about the sample comprises the polarity of the sample.

M256. The method according to any of the 4 preceding method embodiments, wherein the information about the sample comprises the pH of the sample.

M257. The method according to any of the preceding method embodiments, wherein the method further comprises receiving a default workflow.

For example, a user may specify a default workflow through selection from a list of default workflows. Such a list may include default workflows such as direct injection, trap and elute (preconcentration), tandem-direct injection, tandem-trap and elute (preconcentration, online 2D.

M258. The method according to the preceding method embodiment, wherein in the step of providing subroutines of the workflow the subroutines are provided based on the received default workflow.

M259. The method according to any of the 2 preceding method embodiments, wherein receiving a default workflow comprises providing a plurality of default workflows and a user selecting a desired default workflow.

M260. The method according to the preceding method embodiment, wherein providing a plurality of default workflows comprises filtering available default workflows based on information on the chromatographic system, and providing only default workflows that are supported by the chromatography system.

M261. The method according to the preceding method embodiment and with the features of M248, wherein available default workflows are filtered based on comprised hardware components and/or fluidic configuration of the chromatography system.

M262. The method according to any of the preceding method embodiments, wherein assigning a duration and a start time to each of the subroutines comprises automatically assigning a duration and a start time to each of the subroutines.

While the duration and the start time may be automatically assigned to each of the subroutines, it should be understood that these automatically assigned durations and start times may subsequently also be changed, e.g., by a user input.

M263. The method according to the preceding method embodiment and with the features of M257, wherein assigning the duration and/or the start time to each of the subroutines is based on the selected default workflow.

M264. The method according to any of the 2 preceding method embodiments and with the features M17, wherein assigning the duration and/or the start time to each of the subroutines is based on at least one of the at least one received input parameter.

M265. The method according to any of the 3 preceding method embodiments, wherein assigning the duration and/or the start time to each of the subroutines is based on at least one workflow parameter.

M266. The method according to any of the 4 preceding method embodiments, wherein assigning the duration and/or the start time to each of the subroutines is based on at least one boundary condition.

M267. The method according to any of the 5 preceding method embodiments and with the features of M248, wherein assigning the duration and/or the start time to each of the subroutines is based on the information on the chromatography system.

M268. The method according to any of the 6 preceding method embodiments and with the features of M250, wherein assigning the duration and/or the start time to each of the subroutines is based on the additional information on the chromatographic application.

M269. The method according to any of the preceding method embodiment, wherein assigning a duration and a start time to each of the subroutines comprises assigning a minimum duration required based on the selected default workflow and/or workflow parameters.

M270. The method according to any of the preceding method embodiments, wherein the method further comprises customizing the workflow through adjustment of workflow parameters.

M271. The method according to the preceding method embodiment, wherein the method further comprises displaying dependencies of workflow parameters during customization.

M272. The method according to any of the 2 preceding method embodiments, wherein customizing the workflow comprises adjusting the start time of at least one subroutine.

Thus, relative timing between subroutines may be changed and subroutines may even be rearranged, i.e. the sequence of subroutines may be changed.

M273. The method according to the preceding method embodiment, wherein adjusting the start time of a subroutine comprises receiving a user input.

M274. The method according to the preceding method embodiment and with the features of M2, wherein receiving a user input comprises the user moving at least one item in the displayed workflow in the first direction to adjust the start time of the associated subroutine.

M275. The method according to any of the 2 preceding method embodiments, wherein receiving a user input comprises receiving a start time for at least one subroutine.

M276. The method according to any of the preceding method embodiments and with the features of M270, wherein customizing the workflow comprises adjusting the duration of at least one subroutine.

M277. The method according to the preceding method embodiment, wherein adjusting the duration of a subroutine comprises receiving a user input.

M278. The method according to the preceding method embodiment and with the features of M2, wherein receiving a user input comprises the user resizing at least one item in the displayed workflow in the first direction to adjusting the duration of the associated subroutine.

M279. The method according to any of the 2 preceding method embodiments, wherein receiving a user input comprises receiving a duration for at least one subroutine.

M280. The method according to the preceding method embodiment and with the features of M2, wherein receiving a duration for at least one subroutine comprises the user selecting a displayed item and providing a duration for said item.

M281. The method according to any of the preceding method embodiments and with the features of M270 and M2, wherein the method comprises:
the user selecting an item representing a subroutine; and
displaying workflow parameters associated with the selected item.

M282. The method according to the preceding method embodiment, wherein the method further comprises the user adjusting at least one of the displayed workflow parameters.

M283. The method according to the preceding method embodiment, wherein the method further comprises displaying updated workflow parameters based on the at least one adjusted workflow parameter.

M284. The method according to any of the preceding method embodiments, wherein the method comprises enforcing the at least one boundary condition.

M285. The method according to any of the preceding method embodiments and with the features of M270 and M236, wherein customizing the workflow comprises updating the cycle time t_{cycle}.

M286. The method according to any of the preceding method embodiments and with the features of M70 and M239, wherein customizing the workflow comprises updating the detector uptime tᵤₚₜᵢₘₑ.

M287. The method according to any of the preceding method embodiments, wherein at least one boundary condition relates to a gradient delay volume V_{GDV}.

It will be understood that the gradient delay volume (GDV) V_{GDV}. denotes the volume the fluidic path between a point where the gradient is formed and the separation column.

M288. The method according to any of the preceding method embodiments, wherein the method further comprises optimizing timing and/or duration of subroutines based on the gradient delay volume and/or at least one boundary condition associated with the gradient delay volume.

M289. The method according to any of the 3 preceding method embodiments, wherein the optimizing timing and/or duration of subroutines based on the gradient delay volume and/or at least one boundary condition associated with the gradient delay volume is performed automatically.

M290. The method according to any of the preceding method embodiments, wherein the method further comprises determining the gradient delay volume.

M291. The method according to the preceding method embodiment, wherein determining the gradient delay volume is based on the fluidic configuration of the chromatography system.

M292. The method according to any of the 2 preceding method embodiments and with the features of M248, wherein determining the gradient delay volume is based on the information on the chromatography system.

M293. The method according to any of the 3 preceding method embodiments, wherein determining the gradient delay volume comprises measuring the gradient delay volume.

M294. The method according to any of the preceding method embodiments, wherein the method comprises receiving the gradient delay volume.

M295. The method according to any of the 7 preceding method embodiments and with the features of M202 and M210, wherein the optimizing timing and/or duration of subroutines based on the gradient delay volume and/or at least one boundary condition associated with the gradient delay volume comprises shifting the start time of the acquisition subroutine t_{start,acq} by a gradient delay time t_{GDV} with respect to the start time of the gradient subroutine t_{start,grad}.

M296. The method according to the preceding method embodiment and with the features of M214, wherein shifting the start time of the acquisition subroutine t_{start,acq} comprises adding a wait subroutine with a duration t_{wait} corresponding to the gradient delay time t_{GDV}.

M297. The method according to any of the 3 preceding method embodiments, wherein the duration of the gradient delay time t_{GDV} is configured to account for the gradient delay volume V_{GDV}.

M298. The method according to any of the preceding method embodiments, wherein the plurality of workflow parameters comprises the gradient delay time t_{GDV}.

M299. The method according to any of the preceding method embodiments, wherein the plurality of workflow parameters comprises the gradient delay volume V_{GDV}.

M300. The method according to any of the preceding method embodiments, wherein the method comprises identifying an unnecessarily large gradient delay volume in the fluidic setup of the chromatography system.

M301. The method according to the preceding method embodiment, wherein the method comprises indicating an identified, unnecessarily large gradient delay volume to the user.

M302. The method according to any of the preceding method embodiments, wherein the method comprises suggesting a different fluidic configuration of the chromatography setup to optimize the gradient delay volume.

M303. The method according to any of the preceding method embodiments, wherein the method comprises displaying an impact of a different fluidic configuration on the gradient delay volume.

M304. The method according to any of the preceding method embodiments, wherein the method comprises displaying an impact of the gradient delay volume on the workflow execution.

M305. The method according to any of the preceding method embodiments and with the features of M250, wherein the method further comprises optimizing workflow parameters based on the additional information on the chromatographic application.

M306. The method according to the preceding method embodiment and with the features of M87, wherein the optimizing based on additional workflow parameters comprises the sample pickup subroutine comprising applying air gaps during sample pickup for hydrophobic samples in aqueous solution.

M307. The method according to the penultimate method embodiment and with the features of M97 and/or M187, wherein the optimizing based on additional workflow parameters comprises reducing volume(s) employed during trap and/or column loading subroutine(s) to a minimum for hydrophilic samples.

M308. The method according to any of the 3 preceding method embodiments and with the features of M87, the optimizing based on additional workflow parameters comprises adjusting draw rate f_{draw}, and/or draw delay t_{delay} for the sample pickup routine based on the viscosity of the sample.

M309. The method according to any of the 4 preceding method embodiments, wherein the optimizing workflow parameters based on the additional information on the chromatographic application is performed automatically.

M310. The method according to any of the preceding method embodiments and with the features of M17, wherein receiving at least one input parameter comprises receiving a flow regime.

M311. The method according to the preceding method embodiment, wherein the flow regime is one of nano or capillary flow (NAN/CAP), or micro flow (MIC).

M312. The method according to any of the 2 preceding method embodiments, wherein receiving at least one input parameter comprises receiving a fluidic configuration for the workflow.

M313. The method according to the preceding method embodiment, wherein the fluidic configuration comprises geometric properties of conduits, such as volume, inner diameter etc.

M314. The method according to any of the preceding method embodiments and with the features of M17, wherein receiving at least one input parameter comprises receiving at least one input parameter for separation column(s) and/or trap column(s) comprised by the chromatography system.

M315. The method according to the preceding method embodiment, wherein the at least one input parameter comprises one or more of a void volume, a maximum allowed pressure, a maximum allowed flow, a maximum allowed temperature and/or a maximum allowed pressure increase/decrease of a respective column.

It will be understood that the void volume is a workflow parameter and that the other values in embodiment M315 are boundary conditions.

M316. The method according to any of the 2 preceding method embodiments, wherein the at least one input parameter comprises a backpressure of a respective column.

M317. The method according to any of the preceding method embodiments wherein the method comprises automatically determining the backpressure of at least one trap and/or separation column through measurement and storing the determined backpressure in the chromatography system.

M318. The method according to any of the preceding method embodiments and with the features of M17 and M202, wherein receiving at least input parameter comprises receiving at least one input parameter associated with the gradient subroutine.

M319. The method according to any of the preceding method embodiment and with the features of M202, wherein the at least one input parameter comprises the duration of the gradient subroutine t_{grad}.

M320. The method according to any of the preceding method embodiments and with the features of M17 and M87, wherein receiving at least one input parameter comprises receiving at least one input parameter related to sample handling.

M320a. The method according to any of the preceding method embodiments and with the features of M17 and M87, wherein receiving at least one input parameter comprises receiving at least one input parameter related to sample pickup subroutine.

M321. The method according to the preceding method embodiment, wherein the at least one input parameter comprises a lower limit for the injection volume V_{inj,min}.

M322. The method according to any of the 2 preceding method embodiments, wherein the at least one input parameter comprises the draw rate f_{draw}.

M323. The method according to any of the preceding method embodiments and with the features of M17, M217, and/or M97 and/or M178, wherein receiving at least one input parameter comprises receiving at least one input parameter related to column conditioning, and/or trap loading and/or column loading subroutines.

M334. The method according to the preceding method embodiment and with the features of M17 and M178, wherein the at least one input parameter comprises the volume for column loading V_{colload}.

M335. The method according to any of the 2 preceding method embodiments and with the features of M17 and M145, wherein the at least one input parameter comprises the volume for column washing V_{colwash}.

M336. The method according to any of the 3 preceding method embodiments and with the features of M17 and M162, wherein the at least one input parameter comprises the volume for column equilibration V_{coleq}.

M337. The method according to any of the 4 preceding method embodiment and with the features of M17 and M97, wherein the at least one input parameter comprises the volume for trap loading V_{trapoad}.

M338. The method according to any of the 5 preceding method embodiments and with the features of M17 and M44, wherein the at least one input parameter comprises the volume for column washing V_{trapwash}.

M339. The method according to any of the 6 preceding method embodiments and with the features of M17 and M60, wherein the at least one input parameter comprises the volume for column equilibration V_{trapeq}.

M340. The method according to any of the preceding method embodiments and with the features of M310, wherein providing at least one boundary condition comprises providing a minimum flow rate and/or a maximum flow rate based on the received flow regime.

M341. The method according to any of the preceding method embodiments and with the features of M310, wherein providing at least one boundary condition comprises providing a maximum injection volume Vᵢₙⱼ, max based on the received flow regime.

M342. The method according to any of the preceding method embodiments, wherein providing at least one boundary condition comprises determining a maximum injection volume Vᵢₙⱼ, max.

M343. The method according to any of the preceding method embodiments, wherein providing at least one boundary condition comprises determining a minimum gradient time t_{grad,min}.

M343a. The method according to the preceding method embodiment and with the features of M178, wherein determining the minimum gradient time t_{grad,min} comprises determining whether a minimum total duration of column conditioning subroutines t_{colconditioning,min} is shorter or longer than a minimum total duration of sampling handling subroutines t_{sampler,min}, and wherein t_{grad,min} is determined to correspond to the larger of the two and where applicable additionally a minimum column loading time t_{colload.min}.

M343b. The method according to the preceding method embodiment and with the features of M262, wherein automatically assigning a duration and a start time to each of the subroutines comprises adjusting the duration of the shorter one of t_{colconditioning,min} and t_{sampler,min} to match the duration of the longer one.

M343c. The method according to the preceding method embodiment, wherein the adjusting the duration comprises prolonging the initially assigned duration of subroutines and/or adding a wait subroutine.

M344. The method according to any of the preceding method embodiments, wherein providing at least one boundary condition comprises determining a minimum sample pick up speed f_{draw,min}.

M345. The method according to any of the preceding method embodiments, wherein providing at least one boundary condition comprises determining a maximum column-loading excess volume V_{colloadex,max}.

M346. The method according to any of the preceding method embodiments, wherein providing at least one boundary condition comprises determining a maximum trap-loading excess volume V_{traploadex,max}.

M347. The method according to any of the preceding method embodiments, wherein providing at least one boundary condition comprises determining a maximum column wash volume V_{colwash,max}.

M348. The method according to any of the preceding method embodiments, wherein providing at least one boundary condition comprises determining a maximum trap wash volume V_{trapwash,max}.

M349. The method according to any of the preceding method embodiments and with the features of M202 and M343, wherein an extra time tₑₓₜᵣₐ is given as a difference between the duration of the gradient subroutine and the minimum gradient time tₑₓₜᵣₐ=t_{grad}−t_{grad,min}

M350. The method according to the preceding method, wherein the duration of subroutines is constrained to their respective minimum values if tₑₓₜᵣₐ=0.

M351. The method according to any of the 2 preceding method embodiments, wherein the method comprises allocating available extra time to present subroutines and/or adding a wait subroutine for each system module, respectively.

M352. The method according to the preceding method embodiment, wherein allocating the available extra time comprises redistributing the extra time between present subroutines and/or an added wait subroutine by means of respective weighting factors that add up to 1.

M353. The method according to the preceding method embodiment, wherein the respective weighting factors are proportional to the respective duration previously assigned to the subroutines, preferably the respective minimum duration assigned previously assigned to the subroutines.

M354. The method according to the penultimate method embodiment, wherein the method comprises receiving the respective weighting factors.

M355. The method according to any of the 6 preceding method embodiment and with the features of M23, wherein allocating the available extra time to the autosampler module comprises adding a wait subroutine with a length at most corresponding to the extra time.

M356. The method according to any of the 7 preceding method embodiments and with the features of M23, M44, M60, wherein allocating the available extra time to the autosampler module comprises adjusting the duration of trap wash subroutine and/or trap equilibration subroutine.

M357. The method according to any of the 8 preceding method embodiments and with the features of M28, M145 and/or M162, wherein allocating the available extra time to the autosampler module comprises adjusting the duration of column wash subroutine and/or column equilibration subroutine.

M358. The method according to the preceding embodiment and with the features of embodiment M178, wherein allocating the available extra time to the autosampler module further comprises adjusting the column loading subroutine.

Below, reference will be made to system embodiments. These embodiments are abbreviated by the letter “S” followed by a number. Whenever reference is herein made to “system embodiments”, these embodiments are meant.

S1. Chromatography system comprising a controller, wherein the controller is configured to execute a workflow on the chromatography system.

S2. The chromatography system according to the preceding system embodiment, wherein the workflow is set up using the method according to any of the preceding method embodiments.

S3. The chromatography system according to any of the preceding system embodiments, wherein the controller is configured to perform the method for setting up a workflow according to any of the preceding method embodiments.

S4. The chromatography system according to any of the preceding system embodiments, wherein the system comprises at least one pump, an autosampler, at least one separation column and at least one detector.

S5. The chromatography system according to any of the preceding system embodiments, wherein the system further comprises at least one distribution valve.

S6. The chromatography system according to any of the 2 preceding system embodiments, wherein the autosampler comprises at least one distribution valve, a sampling device, a sample pick-up means and a seat for receiving the sample pick-up means.

S7. The chromatography system according to any of the 3 preceding system embodiments, wherein the detector comprises a mass spectrometer.

S8. The chromatography system according to any of the preceding system embodiments, wherein the system comprises an electrospray ionization source.

S9. The chromatography system according to the preceding system embodiment, wherein the electrospray ionization source is a double-barrel electrospray ionization source.

S10. The chromatography system according to any of the preceding system embodiments, wherein the system comprises two separation columns.

S11. The chromatography system according to any of the preceding system embodiments, wherein the system comprises at least one trap column.

S12. The chromatography system according to any of the preceding system embodiments, wherein the system comprises two trap columns.

S13. The chromatography system according to any of the preceding system embodiments, wherein the system comprises two pumps.

S14. The chromatography system according to any of the preceding system embodiments, wherein the system comprises a sample storage, preferable a sample loop.

S15. The chromatography system according to the preceding system embodiment, wherein the sample storage is directly fluidly connected to the sample pick-up means.

S16. The chromatography system according to any of the preceding system embodiments, wherein the system comprises a waste.

S17. The chromatography system according to any of the preceding system embodiments, wherein the controller comprises a data processing unit.

S18. The chromatography system according to any of the preceding system embodiments, wherein the controller comprises a microprocessor.

M359. The method according to any of the preceding method embodiments, wherein the system is a system according to any of the preceding system embodiments. Below, reference will be made to computer program product embodiments.

These embodiments are abbreviated by the letter “C” followed by a number. Whenever reference is herein made to “program embodiments”, these embodiments are meant.

C1. Computer program product comprising instructions which, when the program is executed by a processor, cause the processor to carry out the method according to any of the preceding method embodiments.

C2. Computer-readable medium comprising instructions which, when executed by a processor, cause the processor to carry out the method according to any of the preceding method embodiments.

C3. A data carried signal carrying the computer program product of embodiment C1.

Embodiments of the present invention will now be described with reference to the accompanying drawings. These embodiments should only exemplify, but not limit, the present invention.

### BRIEF DESCRIPTION OF THE DRAWINGS

FIG. 1A depicts an exemplary chromatography system suitable for tandem trap and elute workflows;

FIG. 1B depicts another exemplary chromatography system suitable for a tandem direct injection workflow;

FIG. 1C depicts a further exemplary chromatography system suitable for a tandem direct injection workflow;

FIG. 2A depicts an exemplary visualization of a direct injection workflow;

FIG. 2B depicts an exemplary visualization of a tandem trap and elute workflow;

FIG. 3 illustrates a visualization of parameters associated with a subroutine;

FIG. 4 illustrates a chronological order for providing parameters;

FIG. 5 illustrates a tandem workflow for different column types;

FIGS. 6A & 6B illustrate adjustments of column conditioning subroutines;

FIGS. 7A & 7B illustrate adjustment of sample handling subroutines;

FIG. 8A illustrates visualizations of tandem trap and elute workflows for different gradient times;

FIG. 8B illustrates visualizations of tandem direct injection workflows for different gradient times; and

FIG. 8C depicts a visualization of a direct injection workflow indicating the extra time allocated through a chosen gradient time.

### DETAILED DESCRIPTION

It is noted that not all the drawings carry all the reference signs. Instead, in some of the drawings, some of the reference signs have been omitted for the sake of brevity and simplicity of the illustration. Embodiments of the present invention will now be described with reference to the accompanying drawings.

Very generally, the present invention relates to setting up a workflow for a chromatography system 100. A chromatography system may typically comprise at least one pump, an autosampler, at least one separation column and a detector. However, with increasing demands for more elaborate analyses, also the complexity of chromatography systems 100 may increase. In the following exemplary elaborate chromatography systems 100, 100a, 100b, 100c are briefly discussed for illustrative purposes.

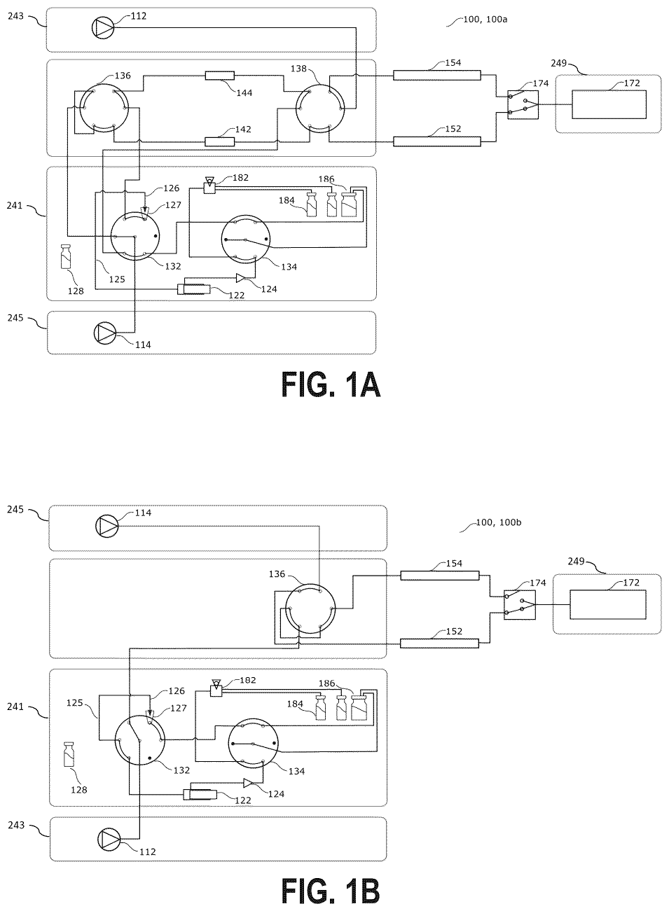

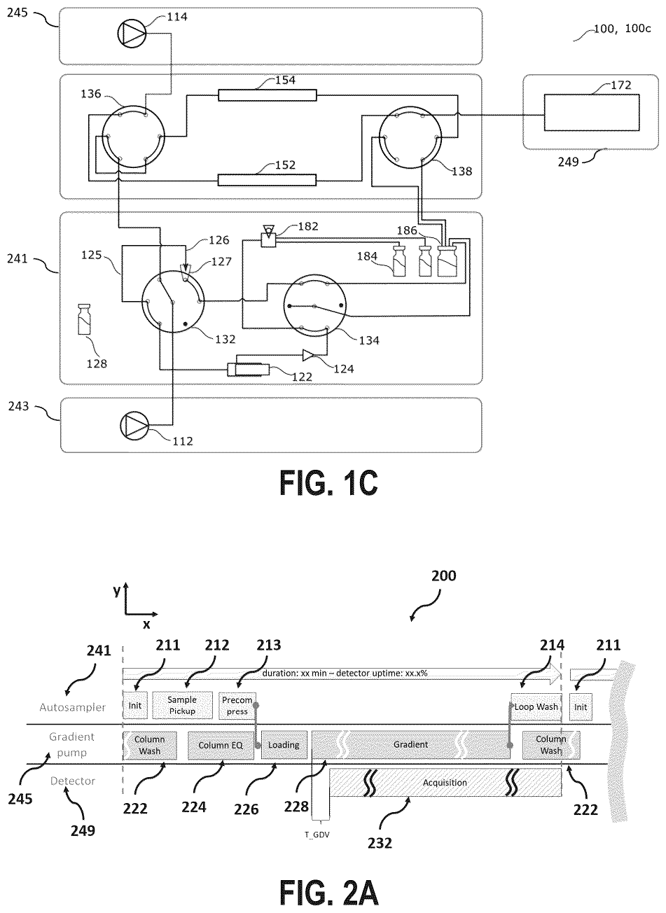

With reference to FIG. 1A an exemplary chromatography system 100, 100a (also simply referred to as system 100, 100a) is discussed. The depicted chromatography system 100a is in a tandem configuration that allows for trapping and eluting samples by means of respective trap columns 142, 144.

The system 100a comprises a sampling device 122, a sample pick-up means 126 and a seat 127 for receiving the sample pick-up means, a first trap column 142 and a second trap column 144, a first separation column 152 and a second separation column 154, a first pump 112 and a second pump 114, a plurality of distribution valves 132, 134, 136, 138 and a detector 172. Furthermore, the system 100a comprises tubing to establish fluid connections between different components of the system 100a.

It will be understood that the terms “first . . . ” and “second . . . ” are merely used to differentiate between elements of the same kind and that these to not imply any hierarchy or ordering thereof.

The distribution valves 132, 134, 136, and 138 may comprise a stator and a rotor, and a rotatable drive. The stator may comprise a plurality of ports, and the rotor may comprise connecting elements to connect the ports to one another, e.g., grooves. The rotor can be rotated with respect to the stator (by means of the rotatable drive) so that the connecting elements may establish connections between different ports. The rotatable drive can include a motor, gearbox and encoder. Thus, the configuration assumed by the distribution valves may determine the fluidic connection between different elements of the chromatography system 100a and thus the configuration assumed by the chromatography system 100a.

The sampling device 122 may also be referred to as metering device 122. The sampling device 122 may comprise a housing and a piston. Furthermore, the sampling device 122 may comprise a stepper motor or drive device for moving the piston within the housing. For example, the metering device may be a motorized syringe. Generally, the sampling device 122 may be configured to provide a pressure difference, e.g., through movement of the piston, which may allow to suck a fluid into the sampling device and consequently into tubing connected to the sampling device and/or to push a fluid out of the sampling device and tubing connected to the sampling device 122.

For example, the sampling device 122 may be configured to retrieve (a portion of) a sample from a sample reservoir 128 via the sample pick-up means 126, which may generally be moveable and particularly separable from the seat 127. Generally, the fluid connection between the sampling device 122 and the sample pick up means 126 may constitute a sample storage 125 configured for intermediate storage of a sample, which may for example comprise a sample loop. The sample pick-up means 126 may for example be a needle 126 and the seat 127 a corresponding needle seat 127. Thus, for picking up a sample, the sample pick-up means 126 may be separated from the seat 127 and moved to the sample reservoir 128, preferably the sample pick-up means 126 may be configured to be moved in an automated fashion, e.g., the sample pick-up means may be motorized. Subsequently, at least a portion of the sample may be sucked into the sample pick-up means 126 (and potentially connected tubing) by means of the sampling device 122. For example, the sample may be sucked into the sample storage 125, e.g., a sample loop. Once the sample pick-up means 126 is moved back to the respective seat 127 the sampling device 122 may deliver the sample to a downstream element, e.g., one of the trap columns 142, 144.

A pressure in the sampling device 122 may for example be measured using a pressure sensor 124 in fluid connection with the sampling device 122. It will be understood that the depicted location of the pressure sensor 124 is merely exemplary and that the pressure sensor 124 may in fact be located at any location where it allows the pressure in the sampling device 122 to be measured.

The sampling device 122 may also be configured to draw in solvents from solvent reservoirs 184, which may for example be used to wash and/or equilibrate trap columns 142, 144. A check valve 182 may prevent any fluid flow from the metering device 122 to the solvent reservoirs 184. Thus, for example in the depicted configuration an inward movement of the piston of the sampling device 122 would push fluid, e.g., comprising sample, towards the first trap column 142 as the check valve 182 prevents any flow in the direction of the solvent reservoirs 184.

The first pump 112 and the second pump 114 may typically be connected to at least one solvent reservoir (not depicted). Thus, depending on the configuration assumed by the chromatography system (i.e., valve positions), they may provide solvent for sample separation and analysis, e.g., a solvent gradient, or for washing and equilibration, e.g., of separation columns 152, 154. For example, in the configuration depicted in FIG. 1a, the first pump 112 may provide solvent for washing and equilibration of the second separation column 154, while the second pump 114 may provide a solvent gradient through the first trap column 142 and the first separation column 152. Generally, it may be preferred for each of the pumps to have a designated task. For example, with reference to system 100a, the first pump 112 may generally provide solvent for washing and equilibrating the separation columns 152, 154, while the second pump 114 may generally provide a solvent gradient through the trap columns 142, 144 and the separation columns 152, 154. In case of such dedicated tasks, the first pump 112 may be referred to as equilibration pump 112 and the second pump 114 may be referred to as gradient pump. Conditioning (e.g., washing and equilibrating) and loading of the trap columns 142, 144 may be performed by the autosampler, i.e., via the sampling device 122.

A double barrel ESI source 174 may allow to selectively introduce fluid from one of the separation columns 152, 154 into the detector 172, e.g., a mass spectrometer, while for example connecting the other separation column 152, 154 to waste (not depicted). This may advantageously allow to analyze fluid from one separation column 152, 154 while at the same time washing and equilibrating the other separation column 152, 154. It will be understood that the double barrel ESI source 174 merely serves as an example and that also other means for selectively introducing the sample into the detector may be utilized, e.g., a valve in combination with a standard ESI source.

Thus, a chromatography system 100a as depicted in FIG. 1A may allow to analyze a sample using one of the separation columns 152, 154 while at the same time preparing the other separation column 152, 154 for a consecutive measurement through washing and equilibration thereof, and, also at the same time, loading and/or washing and equilibrating the trap column 142, 144 not currently involved in the sample analysis.

Specifically, in the configuration depicted in FIG. 1A, the first pump 112 may wash and equilibrate the second separation column 154, thus in such a configuration the first pump 112 may act as an equilibration pump. At the same time, the second pump 114 may provide a solvent gradient through the first trap column 142 and to the first separation column 152, therefore allowing a sample previously trapped in the first trap column 142 to be separated and subsequently analyzed using the detector 172, e.g., a mass spectrometer. Thus, in such a configuration, the second pump 114 may act as a gradient pump. In addition, the sampling device 122 may wash and equilibrate the second trap column 144 using solvents from the solvent reservoirs 184, and/or pick up at least a portion of a sample from the sample reservoir 128 and provide it to the second trap column 144, thereby loading it for a subsequent analysis in the second separation column 154.

Once analysis of the sample initially provided in the first trap column 142 is done, the configuration of the chromatography system 100a may be changed such that now the sample trapped in the second trap column 144 may be analyzed using the second separation column 154 and a gradient supplied by the second pump 114, while the first separation column 152 may be washed and equilibrated using the first pump 112 and the first trap column 142 may be washed, equilibrated and loaded by means of the sampling device 122.

Generally, it will be understood that in simpler chromatography systems 100, e.g., systems comprising only a single pump, such a pump would perform tasks associated with both the gradient pump and the equilibration pump.

FIG. 1A further indicates functional system modules, namely the autosampler 241, the column compartment, the detector 249, the gradient pump 245 and the equilibration pump 243. The autosampler 241 may comprise the first distribution valve 132 and the second distribution valve 134, the sampling device 122, the sample pick-up means 126, the seat 127, the solvent reservoirs 184, the check valve 182, the pressure sensor 124, the sample reservoir 128 and respective tubing. The column compartment may comprise the trap columns 142, 144, the third distribution valve 136, the fourth distribution valve 138 and respective tubing. Optionally, the column compartment may also comprise the separation columns 152, 154. However, particularly when using a double barrel ESI source 174, it may be desirable to place the separation columns as close to the double barrel ESI source 174 as possible to keep the volume between separation column and double barrel ESI source small. Thus, the separation columns 152, 154 may also be located outside of the column compartment. If for example using a single ESI source, an additional valve may be used which could be placed in an additional column compartment that could also house the separation columns 152, 154. The detector module 249 may comprise the detector 172. In the depicted system configuration, the gradient pump module 245 may comprise the second pump 114 and the equilibration pump module 243 may comprise the first pump 112.

In general, efficient operation of such a chromatography system 100, 100a may therefore require scheduling of a number of different tasks and particularly coordination with respect to time a duration of tasks. This can be very complex and tedious, particularly for unexperienced users of such a system. Thus, it may be advantageous to provide methods for easing planning of respective tasks for such complex chromatography systems.

With reference to FIG. 1B another chromatography system 100, 100b is described, which is configured for direct injection without the use of trap columns. Like components are denoted with like reference numbers. In contrast to the chromatography system 100a depicted in FIG. 1A, the chromatography system 100b of FIG. 1B does not comprise any trap column 142, 144. Furthermore, it only comprises three distribution valves 132, 134, and 136. That is, the changes with respect to the system 100a depicted in FIG. 1A are mainly within the column compartment module.

Again, these changes lead to the chromatography system 100b being configured for direct injection. For example, in the depicted system configuration, the second pump 114 may provide a gradient to the first separation column 152, which may be fluidly connected to the double barrel ESI source 174 and the detector 172. At the same time, the first pump 112 may provide a solvent for washing and/or equilibrating the second separation column 154 which may be fluidly connected to waste via the double barrel ESI source 174 (not shown). Furthermore, the sampling device 122 may wash the sample pick-up means 126, the seat 127 and/or the sample storage 125, e.g., particularly the sample loop. Additionally or alternatively, the sampling device 122 may pick up at least a portion of a sample from the sample reservoir 128 and store it in the sample storage 125, e.g., in the sample loop.

In contrast to the chromatography system 100a depicted in FIG. 1A, the sample may not be injected by means of the sampling device 122 but by means of the first pump 112. That is, by changing the configuration assumed by a first distribution valve 132, the first pump 112 may be fluidly connected to the sample storage 125 and provide a flow for injecting the sample into the respective separation column 152, 154. Once injected the third distribution valve 136 may change its configuration in order to fluidly connect the second pump 114 to the separation column 152, 154 into which the sample has been injected and supply a respective gradient. Thus, in the chromatography system 100b depicted in FIG. 1B the first pump 112 may generally constitute the equilibration pump configured for washing and equilibrating separation columns 152, 154 as well as injecting a sample from the sample storage 125 into a respective separation column 152, 154. Accordingly, the second pump 114 may generally constitute the gradient pump configured to provide a solvent gradient for separating and analyzing the sample in a separation column 152, 154.

However, it will be understood that principally, also the first pump may provide a respective gradient and the second pump may provide a solvent for washing and/or equilibrating. Using the second pump 114 as gradient pump may however provide the advantage that the gradient delay volume (from pump outlet to inlet of the respective column) may be significantly reduced compared to using the first pump 112 which may advantageously allow for a higher throughput. Further, depending on the instrument setup, if both pumps switch roles (gradient/equilibrium pump) in an alternating fashion, this may result in alternating fluidic paths and thus fluidic conditions (such as backpressure, gradient delay volume) for the two columns, which may induce an unwanted alternation in the chromatographic results that can lead to decreased comparability of results. This may be particularly undesired when utilizing identical columns and identical sample runs. Moreover, it may be desirable to run sample handling and loading processes in parallel to the gradient to enhance the overall throughput. However, this may require at least one pump being fluidly connected to the autosampler and it is not desirable to route both pumps in an alternating fashion through the autosampler. Thus, using the second pump 114 as gradient pump in the setup depicted in FIG. 1B may allow for injecting a sample into the separation column 152, 154 currently not in an analysis path, i.e., a path between the pump providing the gradient and the detector which also comprises the separation column currently used for sample separation, using the first pump 112.

Again, it will be understood that the separation columns 152, 154 may in some cases not be placed inside the column compartment, particularly when using a double barrel ESI source 174.

FIG. 1C depicts a further embodiment of a chromatography system 100, 100c, which is very similar to the chromatography system 100b depicted in FIG. 1B. However, instead of using a double barrel ESI source 174 a distribution valve, namely a fourth distribution valve 138 is used. It will be understood that depending on the detector 172 there may still be an ESI source between the fourth distribution valve 138 and an input to the detector 172. Alternatively, the detector may for example comprise an ESI source or a nebulizer. Other than that, the chromatography system 100c in FIG. 1C is the same as the chromatography system 100b depicted in FIG. 1B and provides the same functionalities. In such a case, the separation columns 152, 154 may typically be placed within the column compartment as depicted in FIG. 1C.

Again, efficient operation of such chromatography systems 100b, 100c may consequently require scheduling of a number of different tasks and particularly coordination with respect to time a duration of tasks. This can be very complex and tedious, particularly for unexperienced users of such a system. Thus, it may be advantageous to provide methods for easing planning of respective tasks for such complex chromatography systems.

Furthermore, the chromatography system 100, 100a, 100b, 100c may generally also comprise a controller. The controller can be operatively connected to other components. More particularly, the controller may be operatively connected to the distribution valves 132, 134, 136, 138 (and more particularly to the rotatable drives thereof), to the sample pick-up means 126, to the first and second pump 112, 114, and to the sampling device 122 (more particularly, to the stepper motor of the sampling device 122).

The controller can include a data processing unit and may be configured to control the system 100 and carry out particular method steps. The controller can send or receive electronic signals for instructions. The controller can also be referred to as a microprocessor. Furthermore, the controller can be contained on an integrated-circuit chip. The controller can include a processor with memory and associated circuits. A microprocessor is a computer processor that incorporates the functions of a central processing unit on a single integrated circuit (IC), or sometimes up to a plurality of integrated circuits, such as 8 integrated circuits. The microprocessor may be a multipurpose, clock driven, register based, digital integrated circuit that accepts binary data as input, processes it according to instructions stored in its memory and provides results (also in binary form) as output. Microprocessors may contain both combinational logic and sequential digital logic. Microprocessors operate on numbers and symbols represented in the binary number system.

Furthermore, it should be understood that the chromatography system 100, 100a, 100b, 100c may be configured to measure pressures at different locations of the system. For example, the system may comprise a plurality of pressure sensors. For example, a first pressure sensor may be located at or in the first pump 112, and a second pressure sensor may be located at or in the sampling device 122, e.g., pressure sensor 124. Further, a third pressure sensor may also be located at or in the second pump 114. These pressure sensors may also be operatively connected to the controller, and the controller may use readings of these pressure sensors when controlling the operation of the system. The pressure sensors may be configured to measure the pressure directly. However, it should be understood that also other parameters may be measured and may be used to determine the respective pressures (and that such a procedure should also be understood as a pressure measurement and the components involved should be understood as pressure sensors). For example, it will be understood that when a pump 112, 114 supplies a solvent at a flow rate, the power consumption of the pump 112, 114 will also depend on the pressure at which it operates—the higher the operating pressure, the higher the power consumption. Thus, e.g., the power consumption of the pumps 112, 114 may also be used to derive the pressure present at the pumps 112, 114. A corresponding consideration also applies for the sampling device 122: The higher the pressure present in the sampling device 122, the higher the power consumption when the piston is moved further into the housing. Thus, the system 100 may generally be configured to measure pressures present at different locations of the system 100.

The present invention thus aims to facilitate with setting up a workflow for a chromatography system 100 and may generally comprise the steps of providing subroutines of the workflow, providing at least one boundary condition for at least one workflow parameter, assigning a duration to each of the subroutines, and generating the workflow by combining the subroutines. Furthermore, the workflow may be visualized in a comprehensive manner. Setting up a workflow may generally comprise amending and/or optimizing a workflow.

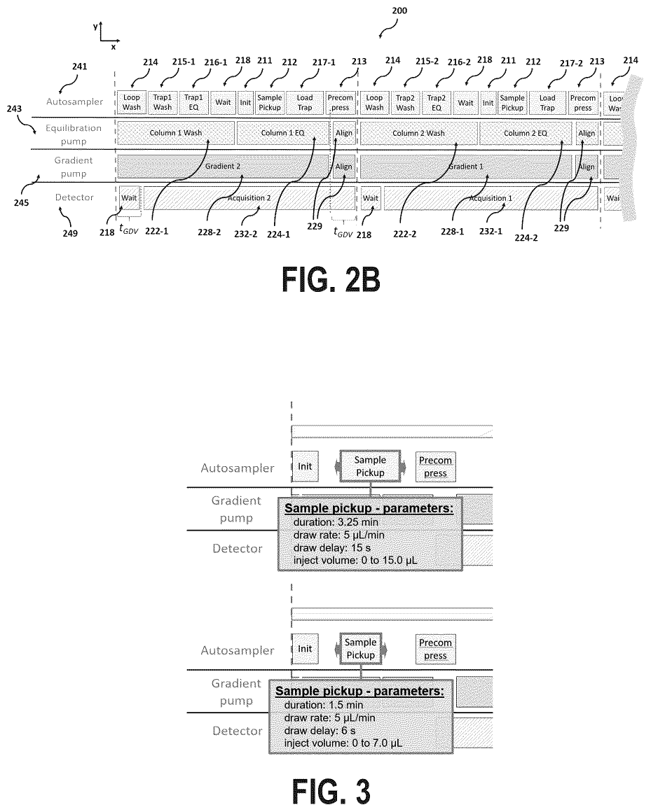

With reference to FIG. 2A a visualization of an exemplary workflow 200 is depicted. Specifically, a schematic illustration of a direct injection workflow is depicted. Generally, subroutines of the workflow may be represented as items 211 to 232 that are arranged in such a way that their position in a first direction (here in x-direction) is indicative of their start time and an expansion in said first direction is indicative of their duration. In the depicted embodiment the length (extension in x-direction) may thus be indicative of the respective duration and the overall position of the items in the x-direction may similarly denote the timing of the subroutine represented by the item. It is however noted that for sake of simplicity certain items may not be displayed to their full extend, which may be indicated by means of wavey vertical lines. That is, depicted extensions in the first direction, i.e., durations of subroutines, may not be to scale. It will be understood that the first direction may alternatively also be chosen to run in the y-direction, or theoretically any other direction.

As can be seen in FIG. 2A, the position of items 211 to 232 in a second direction (here y-direction) may indicate the association of a respective subroutine with a respective system module 241 to 249, e.g., autosampler module 241, gradient pump module 245, detector module 249. That is, the depicted workflow may for example be designated for a chromatography system comprising a single pump, an autosampler, a single separation column and a detector, as well as respective distribution valves, fluidic conduits and a waste. It will be understood that in such a chromatography system, the pump may provide both gradient delivery and column conditioning. Since only a single pump is used, the respective subroutines may be performed successively rather than in parallel.

The depicted workflow comprises an init subroutine 211, wherein the autosampler 241 may be initialized to prepare for a subsequent sample pickup by means of a respective sample pickup subroutine 212, which may be followed by a precompression of the sample through a respective precompression subroutine 213. Furthermore, the autosampler 241 may also perform a loop wash subroutine 214 wherein a respective sample loop 125 may be washed.

The pump may perform a column equilibration subroutine 224, which may be proceeded by a column wash subroutine 222. Alternatively, the column wash subroutine 222 may be comprised by the column equilibration subroutine 224. Following the column equilibration subroutine 224, the sample may be loaded onto the separation column, e.g., by switching the sample loop into the flow path to the separation column and providing a respective solvent flow with the pump—this task may be denoted as column loading subroutine 226. Generally, the loading subroutine 226 may only start once the precompression subroutine 213 is finished and the column is equilibrated, i.e., the equilibration subroutine 224 is finished. A constrain between subroutines of different modules can advantageously be visualized in the workflow, for example by a vertical line connecting the item representing the precompression subroutine 213 and the time of the loading subroutine 226 as shown in FIG. 2A. Furthermore, the pump may also provide a gradient for separation of the sample by means of the separation column, which is denoted as gradient subroutine 228. The detector may perform the acquisition subroutine 232 in order to measure respective analytes eluted from the separation column during the gradient. Preferably, the start of the acquisition subroutine 232 may be shifted with respect to the start of the gradient subroutine by a time t_{GDV} accounting for the time the gradient requires to actually arrive at the detector, which is dependent on the gradient delay volume (GDV).

It is noted that for the sake of simplicity no column compartments are shown in the workflows depicted herein as column compartments are typically operated in a constant mode. Thus, there may be no temporal changes that would need to be visualized. Moreover, again for sake of reduced complexity, depicted workflow visualizations may not show any fluidic information such as valve shifts. In general, exceptions to this may be fluidic implications that affect the temporal order of subroutines, such as a gradient delay volume (GDV).

Thus, visualization of the workflow 200 provides information on the timing, duration and association of respective subroutines of the workflow and thereby particularly facilitates with understanding interdependencies subroutines and relative timing of subroutines. More generally, the present invention may provide a holistic means for setting up and display of a chromatographic workflow thus enhancing usability and throughput particularly of more complex chromatographic applications such as tandem LC, multidimensional separations or “heart-cut”. This may be achieved by dividing each workflow into a set of generic tasks. Each of these tasks may be a subroutine which may be defined such that it can be employed as a subroutine in any (related) workflow. Thus, these tasks may also be referred to as subroutines.

Hence, each workflow can be composed by employing a multitude of these subroutines as “building blocks”. In the following some of the typical subroutines that may be comprised by chromatography workflows are discussed. Such typical subroutines may comprise a loop wash subroutine 214, a trap wash subroutine 215, a trap equilibration subroutine 216, an init subroutine 211, a sample pickup subroutine 212, a trap loading subroutine 217, a precompression subroutine 213, an inject subroutine, a column wash subroutine 222, a column equilibration subroutine 224, a column loading subroutine 215, a gradient subroutine 216, an align subroutine 229, and an acquisition subroutine 218. However, it will be understood that the above is not conclusive, and that further subroutines may be comprised by a respective workflow. Furthermore, it will be understood that a respective workflow does not necessarily comprise all of the above subroutines but only a selection thereof, which may for example be based on characteristics of the chromatographic system 100, e.g., whether a trap column is present, as well as on a default workflow which may be chosen as a starting point, e.g., the desired workflow is generally desired to be a trap and elute workflow or a direct injection workflow.

The column wash 222, column equilibration 224 and (if applicable) align 229 subroutines may be referred to as column conditioning subroutines and may generally be performed by a pump, e.g., the equilibration pump. Similarly, subroutines related to the autosampler module 241 may be referred to as sample handling subroutines, which may comprise loop wash 214, trap wash 215, trap equilibration 216, init 211, sample pickup 212, precompression 213, and trap loading 217 subroutines (if applicable). Again, it will be understood that the exact composition of sample handling and column conditioning subroutines may depend on the chromatographic system and/or the overall desired (default) workflow. For example, sample handling may only comprise trap wash 215, trap equilibration 216 and trap loading 217 subroutines if a trap column is present and used. That is, these subroutines may for example be present when performing a trap and elute workflow, e.g., a tandem trap and elute workflow, whereas they may not be present when performing a direct injection workflow.

A further (more elaborate) example of a workflow is depicted in FIG. 2B. The depicted workflow generally relates to a tandem trap and elute workflow which may for example be performed on a chromatography system 100, 100a as depicted in FIG. 1A.

Generally, the autosampler 241 may perform a loop wash subroutine 214 followed by a trap wash subroutine 215-1, wherein the first trap column 142 of the system 100a may be washed. Subsequently said trap column 142 may be equilibrated by means of a respective trap equilibration subroutine 216-1. This may be followed by a combination of init subroutine 211 and sample pickup subroutine 212. Once picked up, the sample may be loaded onto the equilibrated trap column 142 using a trap loading subroutine 217-1, which may be followed by a precompression subroutine 213.

At the same time, the equilibration pump 243 may condition the respective first separation column 152 through application of the column wash 222-1 and the column equilibration 224-1 subroutines.

Subsequently, the trap column 142 with the precompressed sample may be switched into the flow path, i.e., into the flow path between the gradient supplying pump 112 and the conditioned separation column 152 which may be referred to as inject subroutine. However, due to the very short duration and since this subroutine only relates to switching of fluidic paths by switching respective distribution valves, this subroutine may not be depicted in the workflow visualization. Subsequently, the gradient pump 245 may provide a respective gradient such that the sample stored in the trap column 142 may be pushed to the separation column 152 and be separated therein—this may be denoted as gradient subroutine 228-1. The detector 172 (module 249) may then perform a respective acquisition subroutine 232-1 to measure analytes eluted from the separation column 152.

The autosampler 241 may in some embodiments further perform a wait subroutine 218, which may serve to ensure correct timing of downstream subroutines.

Similarly, the pumps may perform align subroutines 229 which may serve to align certain subroutines between the pumps and/or potentially account for a gradient delay volume (GDV). In that regard, also the detector may perform a wait subroutine 218 prior to starting the acquisition subroutine to account for a GDV. For sake of simplicity the wait routine may not always be displayed in the workflow visualization.

While the separation on the first separation column 152 is running, the autosampler 241 and the equilibration pump 243 may already prepare the second trap column 144 and the second separation column 154 for a subsequent separation. That is, while the second pump 114 performs the gradient subroutine 228-1, the autosampler 241 may perform loop wash 214, trap wash 215-2, trap equilibration 216-2, init 211, sample pickup 212, trap loading 217-2 and precompression 213 subroutines similar to before however this time in relation to the second trap column 144. Similarly, the first pump 112 may perform the column wash 222-2 and column equilibration 242-2 subroutines on the second separation column 154.

Once the subsequent sample is then injected and separated through application of a gradient by means of the second pump 114 (gradient subroutine 228-2) and respective measurement in the detector (acquisition subroutine 232-2), the first trap column 142 and the first separation column 152 may be prepared and loaded with a next sample as described above.

It will be understood that a workflow may comprise more than one subroutine of the same type, e.g., a trap washing subroutine 215-1 for the first trap column and a trap washing subroutine 215-2 for the second trap column. Furthermore, it will be understood that within a workflow, subroutines of the same type may still comprise different workflow parameters, e.g., in a case where the trap columns are different.

Thus, through careful planning and organizing of respective subroutines the throughput of such a tandem trap and elute workflow can be significantly increased compared to a single trap and elute workflow only using a single trap column and a single separation column. The present invention may particularly aid with correct setting up of such intricate and complex workflows, e.g., through visualization and/or consideration and determination of boundary conditions. The visualization according to the present invention may particularly increase ergonomics of setting up a workflow as the user can readily perceive important information through the visualization and/or easily customize the workflow by interacting with the visualization, e.g., through simply drag and drop manipulation of subroutines.

In the following, different subroutines are further discussed.

The loop wash subroutine 214 may generally refer to washing of the sample storage 125, particularly the sample loop 125. That is, this subroutine may be employed for removal of sample residues from the sample loop to avoid/minimize sample carry over. Its duration can be calculated based on parameters of the loop wash procedure and may essentially depend on a number of loop-wash iterations #_{lwash}, a volume per loop-wash iteration V_{lwash} as well as a loop-wash speed or respectively a loop-wash rate f_{lwash}, i.e., a flow rate during the washing procedure. Thus, the respective duration may be given as t_{lwash}=#_{lwash}*V_{lwash}/f_{lwash}. For example, the sample storage 125 may be washed utilizing the sampling device 122 or, alternatively one of the at least one pump 112, 114.

The trap wash subroutine 215 may refer to washing a trap column 142, 144 after injecting a previously trapped sample into a respective separation column. In other words, this subroutine may be employed for washing of a preconcentration column (i.e., trap column) to remove residuals from preceding sample preconcentration procedures in order to avoid carry over. A duration of this subroutine can be calculated and may depend on a volume for trap washing V_{trapwash}, a wash speed or respectively trap-wash rate f_{trapwash} as well as the wash mechanism. These values may be application-dependent and further also depend on the trap column being used. Thus, a user may for example be presented with default values from a look-up table based on the type of trap column and optionally the desired application, wherein the desired application may for example comprise property of sample, and/or criticality of potential carry over. In the case of flow-controlled wash, the duration may be given as t_{trapwash}=V_{trapwash}/f_{trapwash}. In the case of pressure-controlled wash, where the full flow pressure footprint of the chromatography device can be employed, the duration may be dependent on the trap-related backpressure Rₜᵣₐₚ of the system, which may particularly originate from the trap column, but may further depend on geometries of fluid conduits, viscosity of the solvent and/or sample as well as trap column temperature. It will be understood that the trap-related backpressure Rₜᵣₐₚ of the system relates to the backpressure in the flow path comprising the trap column during the trap wash. Hence, the duration may essentially depend on a trap-wash pressure P_{trapwash} and the trap-related backpressure Rₜᵣₐₚ, which determine a resulting flow and thus the trap-wash rate. The latter may be dependent on the type of the trap column, geometries of connected conduits, as well as viscosity and compressibility of the solvent. The backpressure may typically be flow dependent and may typically be given in units of pressure per flow, e.g. bar/(μl/min). In other words, a flow resistor comprising a backpressure of 100 bar/(μl/min), would cause a pressure drop of 100 bar for a flow of 1 μl/min. Thus, the respective duration may be approximated as t_{trapwash}≈V_{trapwash}*Rₜᵣₐₚ/P_{trapwash}, where Rₜᵣₐₚ may be derived from a lookup table, derived from historical (measured) value or by means of measuring. Additionally, statistical methods and/or statistical learning such as machine learning techniques may be employed for determining Rₜᵣₐₚ. To account for variation in the actual duration, a trap-wash safety margin t_{add,trapwash} may be added, thus t_{trapwash}=V_{trapwash}*Rₜᵣₐₚ/P_{trapwash}+t_{add,trapwash}. Such a safety margin may for example be 10% of the time originating from the trap-washing volume V_{trapwash}. Similar to the loop wash subroutine 214, several iterations may be performed in which case the number of trap-wash iterations #_{trapwash} may also be considered.

The trap equilibration subroutine 216 may be similar to the trap wash subroutine 215 and may be employed for equilibration of the trap column prior to loading of the next sample. Like the trap wash subroutine 215 its duration can be calculated and may depend on a volume for trap equilibration V_{trapeq}, an equilibration speed or respectively a trap-equilibration rate f_{trapeq} as well as the equilibration mechanism. These values may be application-dependent and may further also depend on the trap column being used. Thus, a user may for example be presented with default values from a look-up table based on the type of trap column and optionally the desired application, wherein the desired application may for example comprise property of sample, and/or criticality of potential carry over. In the case of flow-controlled equilibration of the trap column, the duration may be given as t_{trapeq}=V_{trapeq}/f_{trapeq}. In the case of pressure-controlled equilibration, where the full flow pressure footprint of the chromatography device can be employed, the duration may be dependent on the trap-related backpressure Rₜᵣₐₚ of the system-particularly originating from the trap column. However, it will be understood that the trap-related backpressure may also depend on geometries of fluid conduits, viscosity of the solvent and/or sample as well as trap column temperature. Again, it is understood that the trap-related backpressure Rₜᵣₐₚ of the system refers to the backpressure of the portion of the system comprising the trap column during the trap equilibration subroutine and the trap wash subroutine. It will be understood that the trap-related backpressure may be solvent dependent and may thus be different for washing and equilibration of the trap column. Thus, Rₜᵣₐₚ may generally be solvent dependent. However, for simplicity it may be set to a value for the solvent causing the highest backpressure, e.g., water, which may suffice for estimating the duration and at least provide an upper limit for the duration. Hence, the duration may essentially depend on a volume for trap equilibration V_{trapeq}, a pressure for trap equilibration P_{trapeq} and the backpressure Rₜᵣₐₚ. The latter may be dependent on the type of the trap column, geometries of the connected conduits, as well as the viscosity and compressibility of the solvent. Thus, the duration may be approximated as t_{rapeq}≈V_{trapeq}*Rₜᵣₐₚ/P_{trapeq}, where Rₜᵣₐₚ may be derived from a lookup table, derived from historical (measured) value or by means of measuring. Additionally statistical methods and/or statistical learning such as machine learning techniques may be employed for determining Rₜᵣₐₚ. To account for variation in the actual equilibration duration, a trap-equilibration safety margin t_{add,trapeq} may be added, thus t_{rapeq}=V_{trapeq}*Rₜᵣₐₚ/P_{trapeq}+t_{add,trapeq}. Again, such a safety margin may for example be chosen to amount to 10% of the time originating from the trap-equilibration volume V_{trapeq}.

The init subroutine 211 may generally refer to an initialization of the autosampler. Thus, it may generally be employed to prepare the autosampler for a subsequent sample pickup. In other words, it may comprise all steps for preparing the autosampler for a subsequent sample pickup. It may for example comprise setting the sampling device 122 to a desired position for sample pickup. Generally, the duration of the init subroutine 211 can be calculated and may depend on the momentary position of the sampling device 122 and particularly the piston and drive thereof, a configured moving speed of the drive, as well as an injection volume Vᵢₙⱼ of sample which will be drawn in a subsequent sample pick-up. That is, the idle volume and/or the moving speed of the drive may for example be set by the user or determined based on the amount of sample to be picked up.

The sample pickup subroutine 212 may generally refer to a subroutine for picking up a sample or respectively a volume/portion of sample with the autosampler, particularly by means of sampling device 122 and sample pick-up means 126. In other words, the sample pickup subroutine 212 may be employed for drawing of sample from the sample reservoir 128 (e.g., sample vial) into an injection flow path, e.g., sample loop 125. The respective duration can be calculated and may depend on the injection volume Vᵢₙⱼ, a draw speed or respectively draw rate f_{draw}, a draw delay t_{delay} which may also include the duration for movements of the sample pick-up means 126 (e.g., needle), as well as the duration of at least one additional (optional) washing step t_{pwash}. The at least one additional washing step may for example comprise washing the inside and/or outside of the needle pre and/or post sample pickup inside with one or more different solvents depending on application requirements. Thus, t_{pickup}=Vᵢₙⱼ/f_{draw}+t_{delay}+t_{pwash}. The draw rate may depend on the sampling device 122 and parameters thereof, particularly the moving speed of the drive and an inner volume of the sampling device 122.

Thus, the duration of the init subroutine 211 and the sample pickup subroutine 212 may scale proportionally with the injection volume. Hence, means to automatically adjust the draw rate and thus the moving speed of the drive of the sampling means 122 to the injection volume in dependency of the fluidic conduits of the injection flow path 125 (e.g., sample loop volume, diameter) may be employed. This may help to avoid excessively long sample aspiration phases.

The trap loading subroutine 217 may comprise providing the sample to a respective trap column 142, 144. For example, a sample stored in the sample storage 125 may be injected into a trap column 142, 144—injecting the sample into a column may be referred to as loading said column. In other words, this subroutine may be employed for delivery of the sample to a preconcentration column. Loading may generally be performed by means of a pump (e.g., gradient pump or equilibration pump), or by means of the sampling device. Again, the duration of this subroutine can be calculated. The duration may depend on a volume for trap loading V_{trapload}, a trap-loading speed or respectively trap-loading rate f_{trapload} as well as a loading mechanism. Again, these values may be application dependent and may further also depend on the trap column being used. Thus, a user may for example be presented with default values from a look-up table based on the type of trap column and optionally the desired application, wherein the desired application may for example comprise property of sample, and/or criticality of potential carry over. In the case of flow-controlled loading, the duration may be given by t_{trapload}=V_{trapload}/f_{trapload}. In the case of pressure-controlled loading, where the full flow pressure footprint of the chromatography device can be employed, the duration may be dependent on the backpressure Rₜᵣₐₚ of the system-particularly originating from the respective trap column. Hence, the duration may essentially depend on the trap-loading pressure P_{trapload} and the backpressure Rₜᵣₐₚ. The latter may be dependent on the type of trap column, the geometries of fluid conduits, the viscosity of the solvent and/or sample as well as trap column temperature. Thus, the duration may be approximated as t_{trapload}≈V_{trapload}*Rₜᵣₐₚ/P_{trapload}. Wherein Rₜᵣₐₚ may be derived from a lookup table derived from historical (measured) values or by means of measuring. Additional machine learning techniques may be employed for determining Rₜᵣₐₚ. To account for variation in the actual equilibration duration, a trap-loading safety margin t_{add,trapload} may be added, thus t_{trapload}=V_{trapload}*Rₜᵣₐₚ/P_{trapload}+t_{add,trapload}. The trap-loading safety margin may for example amount to 10% of the time originating from the trap-loading volume V_{trapload}.

The precompression subroutine 213 may generally relate to a pressurization of the sample prior to injection into the separation column. That is, it may for example relate to pressurization of the sample storage 125 and/or a trap column 142, 144 and more generally of an injection flow path, which may denote the fluidic path that is fluidly connected to the separation column for injection of the sample into the separation column. That is, the pressure of a sample stored in the injection flow path, e.g., in the sample storage portion 125, which may typically be at ambient pressure, or trap column 142, 144 may be brought up to or at least close to analytical pressure, i.e., the pressure at which the sample may be subjected to during separation in the separation column. In other words, this subroutine may be employed to pressurize the injection flow path at least close to the pressure of an analytical flow path comprising the separation column 152, 154—in other words, close to the pressure at the separation column 152, 154. Again, the duration t_{precomp} of the precompression subroutine 213 can be calculated. It may depend on the pressure difference between the initial pressure of the injection flow path and the desired pressure, i.e., a pressure delta (initial pressure Pᵢₙₜ to precompression pressure P_{compress}, wherein Pᵢₙᵢₜ may for example be ambient pressure P_{ambient}), a speed employed for compression, a volume of the injection flow path, i.e. the volume to be pressurized, as well as a viscosity and/or compressibility of the solvent and/or sample. However, this step occurs comparably fast (1-20s) and can be assigned a fixed value for simplification.

The inject subroutine may comprise switching of the sample storage, e.g., sample loop 125, or trap column 142 into the analytical flow path, which may denote a flow path between a pump, preferably the gradient pump, and the separation column. In other words, it may denote switching a portion comprising the picked-up sample into a flow path to the separation column. Since this subroutine has a very short duration (<1s) it can be approximated as a fixed duration.

The column wash subroutine 222 may generally refer to washing of the separation column. This subroutine may thus be employed for washing of the separation column after the preceding gradient for removal of any residual sample compounds. Similarly to the trap wash subroutine, duration of the column wash subroutine 222 can be calculated and may depend on a volume for the column wash V_{colwash}, a wash speed or respectively wash rate f_{colwash} as well as a wash mechanism.

In the case of flow-controlled column washing with a column-wash flow rate f_{colwash} (also simply referred to as column-wash rate), the duration may be given by t_{colwash}=V_{colwash}/f_{colwash}. In the case of pressure-controlled column washing, where the full flow pressure footprint of the chromatography device can be employed, the duration may be dependent on the column-related backpressure R_{col} of the system—particularly originating from the separation column. It will be understood that the column-related backpressure R_{col} of the system refers to the backpressure of the portion of the system comprising the separation column during washing of the column. Hence, the duration may essentially depend on the volume for washing the separation column V colwash, the column-wash pressure P_{colwash} and the column-related backpressure R_{col}. The latter may be dependent on the type of the column(s), geometries of the fluidic conduits, viscosity, and compressibility of the solvent as well as column temperature. In particular, the column-related backpressure may be solvent dependent and may thus be different for washing and equilibration of the separation column. Thus, the duration may be approximated as t_{colwash}≈V_{colwash}*R_{col}/P_{colwash}, where R_{col} may be derived from a lookup table derived from historical (measured) value or by means of measuring. Additional machine learning techniques may be employed for determining R_{col}. To account for variation in the actual equilibration duration, a column-wash safety margin t_{add,colwash} may be added, thus t_{colwash}=V_{colwash}*R_{col}/P_{colwash}+t_{add,colwash}. Again, such a safety margin may for example be chosen to amount to 10% of the time originating from the column-wash volume V_{colwash}.

The column equilibration subroutine (or short column EQ) 224 generally relates to equilibration of the separation column after sample separation, e.g., after running a gradient. In other words, this subroutine may be employed for equilibration of the column after the gradient and column wash phases. Typically, this subroutine may be preceded by a column wash subroutine. That is, after running a gradient, the column may be washed and subsequently equilibrated to prepare for a next sample run. Similarly to the column wash subroutine 222, the duration of the column equilibration subroutine 224 can be calculated. It may depend on a volume for equilibration of the separation column V_{coleq}, the equilibration speed or respectively column-equilibration rate f_{coleq} as well as the equilibration mechanism. In the case of flow-controlled equilibration with a column-equilibration flow rate f_{coleq} (or simply column-equilibration rate), the duration may be given by t_{coleq}=V_{coleq}/f_{coleq}. In the case of pressure-controlled equilibration, where the full flow pressure footprint of the chromatography device can be employed, the duration may be dependent on the column-related backpressure R_{col} of the system-particularly originating from the separation column. Hence, the duration may essentially depend on the column-equilibration pressure P_{coleq} and the column-related backpressure R_{col}. The latter may be dependent on the type of the column, the viscosity and compressibility of the solvent as well as column temperature. In particular, the column-related backpressure may be solvent-dependent and may thus be different for washing and equilibration of the separation column. Similar to before, an upper bound may be considered for simplicity, wherein R_{col} is chosen to correspond to the highest backpressure occurring for the solvents used. Thus, the duration may be approximated as t_{coleq}≈V_{coleq}*R_{col}/P_{coleq}. Where R_{col} may be derived from a lookup table derived from historical (measured) value or by means of measuring. Additional machine learning techniques may be employed for determining R_{col}. To account for variation in the actual equilibration duration, a column-equilibration safety margin t_{add,coleq} may be added, thus t_{coleq}=V_{coleq}*R_{col}/P_{coleq}+t_{add,coleq}. Again, such a safety margin may for example be chosen to amount to 10% of the time originating from the column-equilibration volume V_{coleq}.

Generally, a combination of column wash, column equilibration and optionally align may be referred to as column conditioning and may generally be performed by the equilibration pump.

The column loading subroutine 226 may comprise providing the sample to a respective separation column 152, 154. For example, a sample stored in the sample storage 125 may be injected into a separation column 152, 154, or alternatively a sample stored in a trap column 143, 144 may be injected into a separation column 152, 154—injecting the sample into a column may be referred to as loading said column. In other words, this subroutine may be employed for delivery of the sample to an analytical column. Loading may generally be performed by means of a pump (e.g., gradient pump or equilibration pump), or by means of the sampling device. Again, the duration of this subroutine can be calculated. The duration may depend on a volume for loading V_{colload}, a loading speed or respectively column-loading rate f_{colload} as well as a loading mechanism. In the case of flow-controlled loading, the duration may be given by t_{colload}=V_{colload}/f_{colload}. In the case of pressure-controlled loading, where the full flow pressure footprint of the chromatography device can be employed, the duration may be dependent on the column-related backpressure R_{col} of the system-particularly originating from separation column. Hence, the duration may essentially depend on the column-loading pressure P_{colload} and the column-related backpressure R_{col}. The latter may be dependent on the type of separation column, the geometries of fluid conduits, the viscosity and compressibility of the solvent and/or sample as well as separation and/or column temperature. In particular, the column-related backpressure may be solvent dependent and may thus be different for washing, equilibration and loading of the separation column. Thus, the duration may be approximated as t_{colload}≈V_{colload}*R_{col}/P_{colload}. Where R_{col} may be derived from a lookup table derived from historical (measured) value or by means of measuring. Additional machine learning techniques may be employed for determining R_{col}. To account for variation in the actual equilibration duration, a column-loading safety margin t_{add,colload} may be added, thus t_{colload}=V_{colload}*R_{col}/P_{colload}+t_{add,colload}. The column-loading safety margin may for example amount to 10% of the time originating from the column-loading volume V_{colload}.

The gradient subroutine 228 may generally relate to the actual separation of the sample. That is, it may comprise providing a solvent gradient to the separation column for separation, in other words it may encompass the actual separation. Generally, this subroutine may be performed by the gradient pump (i.e., the pump acting as gradient pump). Since this subroutine may encompass the actual separation stage, it may also be referred to as chromatographic separation subroutine 228. The duration of the gradient subroutine 216 may depend on the settings of the specified method for sample separation and analysis. Thus, its duration may generally be deterministic and time-based.

The gradient subroutine 216 may be followed by a (short) align subroutine 229, which may be applied to align the activities prior to start of a next gradient, particularly activities of gradient pump and equilibration pump. Its duration may need to be sufficiently long to assure completion of the column loading 226 or trap loading 217 subroutine, e.g., loading of a sample by means of the equilibration pump directly on the separation column, or on the trap column by means of the metering device or equilibration pump, wherein the duration of the loading subroutine may generally be dependent on system backpressure. Similarly, it may serve to assure that a gradient start condition for the next gradient run/separation as delivered by the gradient pump has reached the respective column valve. This may serve to avoid wash-off of early eluting compounds by residual high organic composition from the late phase of a previous gradient.

The acquisition subroutine 232 may refer to the detector collecting data on the effluent, i.e., the eluent exiting the separation column. That is, during this subroutine the detector may be collecting and/or recording data of the chromatographic separation. Thus, this subroutine may also be referred to as detector subroutine 232. Generally, this subroutine may be performed by the (at least one) detector. Its duration is deterministic and time-based. The duration may be (at least approximately) the same as the duration of the gradient subroutine.

In some embodiments, this subroutine may be shifted by a gradient delay time t_{GDV} to a later start (and end) with respect to the gradient subroutine 228. That is, a respective wait subroutine 218 of a duration corresponding to the gradient delay time t_{GDV} may be employed. This may serve to account for the gradient delay volume (GDV), i.e., the volume of fluid conduits between the point of gradient formation (typically the pump outlet) and the column. Thus, t_{GDV} may be the duration that is required for fluid composing the gradient start condition to actually reach the detector. Moreover, at least under ideal conditions, t_{GDV} may be the time when the first compounds eluting from the separation column may be detected. Typically, the duration of the acquisition task may be identical to the duration of the gradient task. Thus, analogously, the end of acquisition task delayed by gradient delay time t_{GDV} with respect to the gradient task.

For setting up a workflow an initial set of subroutines may be provided. This initial set of subroutines may for example be based on a default workflow that may be received, e.g., through a user input. For example, in a first step a user may be presented with a list of default workflows and choose a desired default workflow. Such a list may for example include the following default chromatography workflows: Direct injection, tap and elute (preconcentration), tandem-direct injection, tandem-trap and elute (preconcentration), and online 2D. However, it is noted that this list is only exemplary and not comprehensive.

The list may be subject to filtering. For example, only default workflows that are supported by the actual chromatographic setup (hardware and fluidic configuration) may be displayed. Thus, if only a single pump is present, workflows that require two pumps such as Tandem or Online 2D may not be displayed. The user may choose a default workflow and the chosen workflow, particularly at least a portion of its subroutines and their relative arrangement, may be displayed graphically (cf. FIG. 2A).

Initial duration and relative arrangement may take into account minimum requirements to allow for required parameters. In this regard, the initial duration and relative arrangement of subroutines may generally be based on default values, e.g., depending on utilized system components and/or the selected default workflow. In that regard, parameters either received from the user or the chromatography system (e.g., through ID tags), and/or parameters determined based on other parameters may be taken into consideration. Very generally, initial parameters may for example be chosen to allow for a minimum cycle time at maximum operating conditions.

In some embodiments, the user may provide additional information on the chromatographic application for which the workflow is set up, which may comprise information on the sample to be analysed. Such information on the sample may comprise an affinity of the sample to water, i.e., whether the sample is hydrophilic or hydrophobic, a viscosity of the sample, a polarity of the sample, a pH of the sample etc. In other words, information about the nature of the sample may be provided. Similarly, the type of chromatography (e.g., size exclusion, normal-phase, reverse-phase) may be provided.

In particular, means to further specify the chromatographic application may be displayed and the user may provide the additional information through these means, e.g., by entering respective information via a user interface or selecting information form displayed options.

Such additional information may be used to further tailor the workflows specifically to the application. For instance, in the case of hydrophobic sample species in aqueous solution, air gaps may be applied during sample pickup to minimize dispersion, thereby reducing adsorption to surfaces of the fluidic conduits and ultimately increasing the sensitivity for these species in downstream detection. Similarly, in case of hydrophilic sample species, the volume(s) employed during loading process(es) may be reduced to a minimum to prevent removal of early-eluting compounds. Further, in case of viscous samples, slow draw rate and extended draw delay may increase recovery of the sample resulting in better sensitivity during downstream detection.

Furthermore, the workflow may be customized. That is, the user may customize the chosen workflow to his specific requirements, which may also include changing and particularly optimizing the workflow based on user input. Important parameters in the workflow design in chromatography may be cycle time, i.e., the total duration of a sample run, as well as detector uptime, i.e., duration of data acquisition relative to the total duration. The method may thus further comprise determining these parameters and updating them when customizing the workflow. Furthermore, to provide feedback to the user and/or visualize the effect of changes to the workflow, one or preferably both these parameters may be displayed during workflow customization to allow for simple and intuitive optimization of the throughput of a given workflow.

Very generally, initially suggested values may be default values that correspond to a minimum cycle time at maximum operating conditions (e.g., pressure limit). However, a user may for example wish to increase the gradient duration which can for example be achieved by reducing the flow rate. For example, the flow rate could be chosen to be relatively constant across the workflow. A user may for example be presented with an interface, where respective values may be entered and/or changed. Such an interface may for example also display allowable ranges for the values based on other chosen/fixed system parameters and boundary conditions. In particular, the user may be provided with an interface displaying at least one workflow parameter and at least one associated boundary conditions. This may allow the user to alter a workflow parameter within the given boundary conditions. It will be understood that depending on a change of a workflow parameter, boundary conditions of other workflow parameters may be changed and thus recalculated.

In some embodiments, the method may further comprise determining and/or indicating where detector uptime is lost. This may allow the user to optimize the workflow with regard to detector uptime. Further, the method may comprise suggesting a change of method parameters to optimize the workflow, e.g., with regard to detector uptime and/or cycle time.

Customizing a workflow may comprise adjusting timing of subroutines. This can for example be done by the user by moving (dragging) subroutines within the displayed visualization of the workflow. This may generally also allow to rearrange subroutines, i.e., to change the sequence of at least some of the subroutines. However, possibilities for customization may be limited through certain constraints which may also be referred to as boundary conditions. For example, a certain logical order may be required for some subroutines and thus a rearrangement of subroutines may only be possible when said constraints are valued. Similarly, some subroutines may be required to complete simultaneously. Generally, these constraints, e.g., boundary conditions, may thus be reflected in the workflow editing and preferably also be visualized graphically, i.e., indicated to the user. For example, with reference to FIG. 2A, it is visualized that the precompression subroutine 213 may be constrained to end prior to the column loading subroutine 214, similarly also the column equilibration subroutine 224 may be constrained be finished prior to loading the sample in the column.

Furthermore, the timing of subroutines may be optimized with respect to the gradient delay volume (GDV). For example, additional constraints may be based on the GDV and/or the method may comprise automatically optimizing timing and/or duration of subroutines based on the GDV and/or resulting constraints. In other words, additional means for optimization of workflows may be realized by taking the gradient delay volume (GDV) into account. For this purpose, information of the actual fluidic setup of the system may be required to determine the GDV. The GDV may essentially relate to the delay between a change to the gradient and its occurrence at the detector and thus particularly be related to the volume of the fluid conduits between gradient pump and detector and the flow rate, respectively. Thus, the GDV may for example be taken into account by starting the data acquisition, i.e., the acquisition subroutine 218, with a corresponding gradient delay time t_{GDV}. In other words, the start of the acquisition subroutine 232 may be shifted by the gradient delay time t_{GDV} with respect to the start of the gradient subroutine 228. This may be visualized by adding a respective wait subroutine with a duration of t_{GDV}. For example, FIG. 2A depicts a direct injection workflow, wherein the acquisition subroutine 232 is shifted by t_{GDV} to account for the GDV of the system. Similarly, the tandem trap and elute workflow depicted in FIG. 2B is also optimized with respect to the GDV by including a wait subroutine 218 with a duration corresponding to t_{GDV}. Typically, the duration of the acquisition subroutine 232 may be identical to the duration of the gradient subroutine 228. Thus, analogously, the end of the acquisition subroutine may be delayed by delay t_{GDV} with respect to the end of the gradient subroutine. Particularly, in the case of method transfer and method development where the GDV may frequently be a key parameter that is modified, the respective visualization may be beneficial. Similarly, the switching of the injection valve may be delayed to account for the delay volume between the pump and the autosampler.

Furthermore, the method may comprise identifying an unnecessarily large gradient delay volume in the fluidic setup, which may be indicated to the user. Furthermore, the method may comprise suggesting a different fluidic configuration, e.g., by using different fluidic connections, in order to optimize the fluidic setup with respect to GDV. For example, the impact of a different fluidic configuration on the GDV and/or the impact of the GDV on the workflow execution may be displayed.

Additionally, customizing a workflow may also comprise adjusting the duration of subroutines. This can for example be changed by resizing of the subroutines through dragging the left or right edge of the respective item or by the user specifying a desired duration through another input, e.g., through typing in a desired duration. That is, parameters of a given subroutine may be adjusted by the user directly manipulating the extension of an item representing a respective subroutine or may for example be adjusted by clicking on the respective item. In the latter case, a pop-up window may be shown, displaying the associated parameters (cf. FIG. 3). For instance, if the user would click on the gradient bar item, means to parametrize the gradient may be displayed.

Again, a user may for example also change at least some of the parameters (e.g., more general parameters relevant to more than 1 subroutine) via an interface, where respective values may be entered and/or changed and allowable ranges for the respective values may be displayed.

As detailed before, the duration of the particular subroutines may vary and frequently depend on a multitude of parameters. Hence, if the duration of a subroutine is changed, some of the parameters may change as well. For instance, in the case of the sample pickup subroutine 212, assuming the draw rate f_{draw} and the draw delay t_{delay} are constant and the duration is set to t_{pickup}, only a certain range of injection volumes can be employed, since Vᵢₙⱼ≤(t_{pickup}−t_{delay})*f_{draw}. It will be understood that a lower injection Volume would be realized by not completely utilizing the available duration of the subroutine. Thus, if higher injection volumes should be employed this would require a corresponding extension of the associated subroutine or an increase of the draw rate, respectively. This dependency may advantageously also be displayed to the user as for example depicted in FIG. 3, wherein in the upper panel the duration t_{pickup} is set to 3.25 min and t_{delay} to 15 s resulting in a maximum injection volume Vᵢₙⱼ≤15 μL. In contrast, in the lower panel the duration t_{pickup} is set to 1.5 min and t_{delay} to 6 s resulting in a maximum injection volume Vᵢₙⱼ≤7 μL. Generally, the duration (and consequently the displayed size in the temporal domain, i.e., the first direction) of any task may represent its minimum duration required to allow for the realizing the maximum allowable parameters within the selected workflow. It will be understood that there will always be interdependency between durations of different subroutines and chosen/set workflow parameters. That is, with reference to the lower panel of FIG. 3, the duration of the depicted subroutine represents the duration needed for an injection Volume of 7 μL. It will be understood that the actual duration may be shorter if a lower injection volume is chosen, alternatively draw rate and/or draw delay may be adjusted to keep the duration fixed. Consequently, the duration represents the minimum duration required to enable the desired parameter space. This effectively results in a range for one or more parameters that can be accommodated, e.g., a range of injection volumes.

After customizing the workflow, the final workflow may be generated through combining all subroutines and the workflow may be saved. Subsequently the workflow may be executed. That is a respective chromatography system may be run in accordance with the respective workflow.

Thus, the present invention may provide a workflow editing approach that may greatly facilitate setting up of chromatography workflows through an intuitive display of all relevant control stages for a chromatography system.

Furthermore, the present invention may additionally or alternatively facilitate with setting up, editing and optionally optimizing more complex workflows, particularly workflows that require synchronization of several (at least partially) in parallel occurring subroutines, e.g., tandem 2D or heart-cut workflows. In particular, the method may comprise receiving parameters from a user, calculating boundary conditions and scheduling subroutines based on the given parameters and boundary conditions, which may include an optimization of the scheduling of subroutines. For example, the user may select a default workflow corresponding to a tandem workflow, based on which the user may be prompted to enter certain parameters. Alternatively, the user may provide certain parameters without being prompted and/or selecting a default workflow.

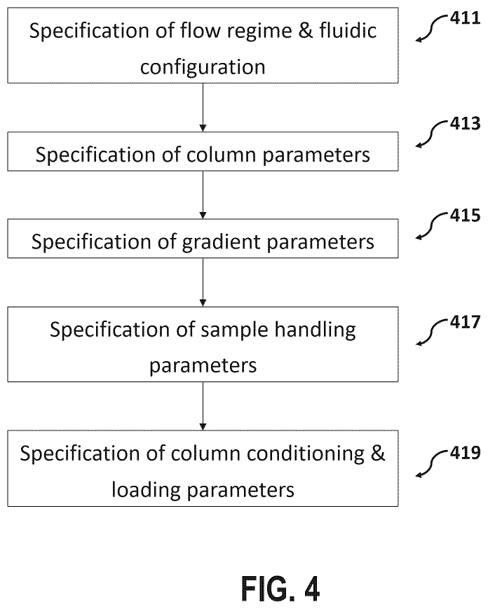

That is, the user may generally be asked to provide certain parameters. For example and with reference to FIG. 4, the user may provide/specify parameters in a chronological order.

In a first step 411 the user may specify flow regime and fluidic configuration for the desired workflow. That is, the user may define in which flow regime and with which fluidic configuration the chromatographic analysis may be performed, wherein the fluidic configuration may comprise geometric properties of conduits such as volume, inner diameter etc. This may be advantageous to assure that the set of parameters for the downstream instrument method may be tailored specifically to the flow regime and the (predefined) fluidic configuration that may be specific for each flow regime. For instance, the user may choose between the following: nano or capillary flow (NAN/CAP), thus flow rates in the range between 0 and 5000 nL/min, or micro flow (MIC), thus flow rates in the range between 5 L/min and 100 μL/min. Based on the chosen flow regime the maximum applicable injection volume V_{inj,max} may be set to a given value (e.g., 10 μL for NAN/CAP and 100 μL for MIC).

In a next step 413, characteristics of the fluidic system and particularly of the separation column(s) and, if present also trap column(s) may be specified, i.e., provided. In other words, column parameters and optionally further parameters of the fluidic systems (e.g., relating to fluidic conduits) may be specified. Such information may either be provided through the user or by the column manufacturer (e.g., through an ID tag), or a combination of both. Column parameters may comprise a void volume of the columns as well as maximally allowed pressure, flow, temperature and/or pressure increase/decrease of columns, and optionally fluid conduits, and backpressure, i.e., fluidic resistance of the columns. The latter may preferably be determined automatically by the chromatography system and stored in the system (e.g., in a data system or firmware, or column—e.g., ID tag). It will be understood that a void volume of a column may denote the volume that can be occupied by mobile phase within the respective column. Generally, the void volume may also simply be referred to as column volume.

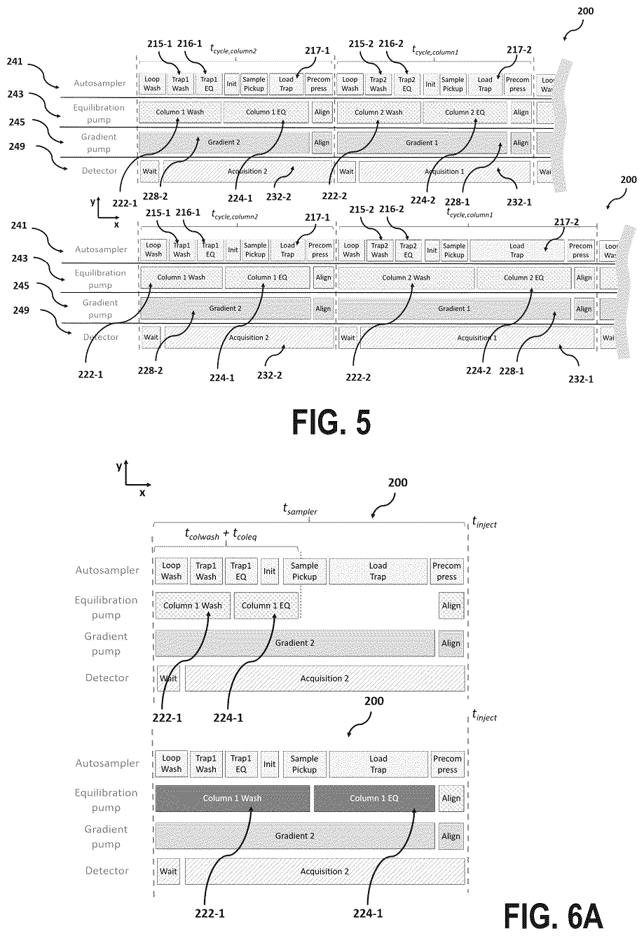

It will be understood that in principle the herein presented method could be applied to a tandem configuration comprising two separation columns of different type and/or trap columns of different type, e.g., in a trap and elute tandem configuration. In such a case some of the column parameters such as the fluidic resistance may vary between the respective separation and/or trap columns. This may affect the duration of certain subroutines such as the gradient subroutine 228, the loading subroutines 217, 226 or the column conditioning subroutines 222, 224, 229. Thus, it may result in durations of respective sample separations no longer being identical, instead, they may vary in an alternating fashion, i.e., between subsequent sample runs. For instance, the gradient subroutine 228 for one column may be longer than the corresponding gradient subroutine 228 of the other column. Correspondingly, the cycle times for the overall analysis runs of the two columns would be different. An example is depicted in FIG. 5, wherein the workflow 200 depicted in the upper panel basically corresponds to the workflow depicted in FIG. 2B without the wait subroutine 218 in the column associated to the autosampler module 241. This visualization relates to a trap and elute tandem injection workflow where both pairs of columns (i.e., trap and separation column) may be essentially identical (i.e., of the same type), thus resulting in identical cycle time t_{cycle,column1}=t_{cycle,column2}. The lower panel of FIG. 5 however relates to a trap and elute tandem injection workflow where the columns are of different type resulting in different cycle times t_{cycle,column1}>t_{cycle,column2}. In particular, when using different types of trap columns the duration of the trap loading subroutine 217 may vary. Similarly, also the duration of the trap wash 215 and/or trap equilibration 216 subroutines may vary. These variations may for example originate from different flow resistances and resulting backpressures and/or different volumes of the trap columns. Similarly, when using different separation columns, the duration of the gradient subroutine 228 and consequently the acquisition subroutine 232 may vary. Further, also the duration of column wash 222 and/or column equilibration 224 subroutines may vary. Again, these variations may for example originate from different flow resistances and resulting backpressures and/or different volumes of the separation columns.

However, in a typical direct injection or trap and elute application columns of the same type may be employed and essentially identical cycle times may be obtained. Nonetheless, even columns of the same type may typically show minor differences in their parameters, particularly their backpressure.

In a next step 415 gradient parameters may be specified. In particular the user may specify an intended gradient duration for the chromatographic separation, i.e., an intended duration of the gradient subroutine which may also be referred to as gradient time t_{grad}. The value t_{grad} must be equal or larger than a minimum gradient time t_{grad,min}:t_{grad}≥t_{grad,min}, wherein t_{grad,min} may depend on a minimum duration of sample loading and optionally trap column conditioning subroutines as well as sample handling, or column wash and equilibration subroutines, whichever is greater. Thus, t_{grad,min} may constitute a boundary condition that may be determined based on other parameters as further explained below.

The chosen value may define an allowed range for downstream parameters such as applicable injection volumes, loading or equilibration volumes etc. Default values for typical analytical runs may be provided based on the afore made specifications.

In a next step 417 sample handling parameters may be defined. In particular, the user may specify a range of injection volumes that the workflow shall be applied for. The injection volume must not exceed the maximum injection volume V_{inj,max} which may be determined based on other parameters (see below) or respectively set based on the flow regime and fluidic configuration specified by the user. Furthermore, the user may specify a lower limit for the injection volume Vᵢₙⱼ, min. Thus, resulting in a range for injection volume Vᵢₙⱼ:V_{inj,min}≤Vᵢₙⱼ≤V_{inj,max}.

Moreover, the user may specify a draw speed or respectively draw rate for sample pickup. The draw rate must be equal or larger than a minimum applicable draw rate f_{draw,min}, which again may be determined based on other parameters (see below), such that f_{draw}≥f_{draw,min}.

In a final step 419 column conditioning and loading parameters may be specified. Particularly, the user may specify volumes for sample loading as well as for column wash and equilibration for the separation column(s) and optionally also the trap column(s). For each of those parameters the set value must exceed a respective lower limit, which may essentially correspond to predefined values that may ensure absolute minimum conditions for the chromatographic separation. Moreover, the set values may not exceed a given upper limit value. Those may be boundary conditions given by timing and synchronization requirements of the overall workflow (i.e., a given subroutine must not exceed a certain duration). Again, the respective minimum and/or maximum values (i.e., boundary conditions) may be indicated to the user, thus providing the user with a viable range of values for respective parameters to choose from. The following value ranges may apply to those parameters:
(Trap-/column-)loading volume:

$${V}_{load} = {V}_{inj} + {V}_{loadex}$$

with a loading excess volume V_{loadex}

$${V}_{loadex , min} < {V}_{loadex} < {V}_{loadex , max}$$

V_{loadex} may denote an additional volume which may be employed during loading to assure that the sample is entirely loaded onto the column. This value may depend on the fluidic configuration (volume of fluidic connections) as well as the void volume of the trap/separation column. V_{loadex,min} may be a default value that proved to allow for robust loading under most applicative situations. Alternatively, also more tailored default values may be employed depending on the type of application or column. V_{loadex,max} may be determined based on other workflow parameters as for example outlined further below.

It will be understood that Vload may correspond to V_{colload} or V_{trapload}, respectively, depending on the workflow, e.g., if it is a trap and elute or a direct injection workflow. Furthermore, it will be understood that the term “column-loading volume” refers to the volume for loading of the separation column V_{colload}. The separation column may also be referred to as analytical column.

V_{loadex} may for example be defined as a multiple value of the respective trap column volume (Vₜᵣₐₚ) or separation column volume (V_{col}), i.e.,

$${V}_{trapload} = {X}_{trapload} * {V}_{trap} + {V}_{i n j} ,$$

$$or respectively {V}_{colload} = {X}_{colload} * {V}_{c o l} + {V}_{inj} .$$

Alternatively, different relations of the loading volume with respect to the injection volume may be applied.
Trap column wash volume:

$${V}_{trapwash , min} < {V}_{trapwash} < {V}_{trapwash , max}$$

V_{trapwash,min} may be a default value that assures that minimum applicable requirements for trap column washing are satisfied. It may for example depend on the type of trap column and/or sample properties. V_{trapwash,max} may be determined based on other workflow parameters as for example outlined further below. V_{trapwash} may for instance be defined as a multiple value of the trap column volume Vₜᵣₐₚ, i.e., based on a trap-wash factor X_{trapwash}:

$${V}_{trapwash} = {X}_{trapwash} * {V}_{trapcol}$$

Alternatively, other definitions (e.g. based on the loading volume) may be applied.
Trap column equilibration volume:

$${V}_{trapeq , min} < {V}_{trapeq} < {V}_{trapeq , max}$$

V_{trapeq,min} may be a default value that assures that minimum applicable requirements for trap column equilibration are satisfied. It may for example depend on the type of trap column and/or sample properties. V_{trapeq,max} may be determined based on other workflow parameters as for example outlined further below. V_{trapeq} may for instance be defined as a multiple value of the trap column volume Vₜᵣₐₚ, i.e., based on a trap-equilibration factor X_{trapeq}:

$${V}_{trapeq} = {X}_{trapeq} * {V}_{trapcol}$$

Alternatively, other definitions (e.g. based on the loading volume or trap column wash volume) may be applied.
Separation column wash volume:

$${V}_{colwash , min} < {V}_{colwash} < {V}_{colwash , max}$$

V_{colwash},min may be a default value that assures that minimum applicable requirements for separation column washing are satisfied. It may for example depend on the type of separation column, solvent properties and/or sample properties. V_{colwash},max may be determined based on other workflow parameters as for example outlined further below. V_{colwash} may for instance be defined as a multiple value X_{colwash} of the separation column volume V_{col}, i.e., based on a column-wash factor X_{colwash}.

$${V}_{colwash} = {X}_{colwash} * {V}_{col}$$

Alternatively, other definitions (e.g. based on the injection volume or loading volume) may be applied.
Separation column equilibration volume:

$${V}_{coleq , min} < {V}_{coleq} < {V}_{coleq , max}$$

V_{coleq},min may be a default value that assures that minimum applicable requirements for separation column washing are satisfied. It may for example depend on the type of separation column, solvent properties and/or sample properties. V_{coleq} may for instance be defined as a multiple value X coleq of the separation column volume V_{col}:

$${V}_{coleq} = {X}_{coleq} * {V}_{col}$$

Alternatively, other definitions (e.g. based on the injection volume, loading volume or separation column wash volume) may be applied.

Throughout the parameter specification respective boundary conditions may be calculated based on already specified parameters for the workflow, e.g., provided through the user and/or respective ID tags. In particular, based on a desired (default) workflow and/or the provided parameters subroutines may be provided. Furthermore, the subroutines may be assigned a duration corresponding to the minimum duration required based on the selected default workflow and/or workflow parameters, particularly received workflow parameters (e.g., specified through the user and/or received from ID tags).

Generally, two different cases may be considered based on a relation between a minimum total duration of sample handling subroutines and a minimum total duration of column conditioning subroutines. Again, the respective minimum durations depend on the default values and/or user-altered values for the respective subroutines and are such that they represent the minimum duration required to allow for the specified parameter. For example, if a desired injection volume is specified, the minimum duration corresponds to the duration required for said injection volume and maximum operating conditions, e.g., maximum flow rate.

In a first case I, the minimum total duration of sample handling subroutines may exceed the minimum total duration of column conditioning subroutines:

$${t}_{sampler , min} > {t}_{colconditioning , min}$$

Wherein column conditioning may comprise column wash 222 and column equilibration 224 subroutines, and optionally also an align subroutine 229, while sample handling subroutines may comprise loop wash 214, trap wash 215, trap equilibration 216, init 211, sample pickup 212, precompression 213, and trap loading 217 subroutines. However, it will be understood that the exact composition of sample handling and column conditioning subroutines may depend on the chromatographic system and/or the overall desired (default) workflow. For example, sample handling may only comprise trap wash 215, trap equilibration 216 and trap loading 217 subroutines if a trap column is present and used. That is, these subroutines may be present when performing a trap and elute workflow, e.g., a tandem trap and elute workflow, whereas they may not be present when performing a direct injection workflow.

Thus, the minimum total duration of (separation) column conditioning may generally be given as

$${t}_{colconditioning , min} = {t}_{colwash , min} + {t}_{coleq , min} + {t}_{align , mln} ,$$

wherein t_{align,min} may potentially be zero. The minimum total duration of sample handling may be given as

$${t}_{sampler , min} = {t}_{loopwash , min} + {t}_{trapwash , min} + {t}_{trapeq , min} + {t}_{init , min} + {t}_{pickup , min} + {t}_{trapload , min} + {t}_{precompress , min} ,$$

Wherein t_{trapwash,min}, t_{trapeq,min}, t_{trapload,min} may be zero (e.g., in case of a direct injection workflow).

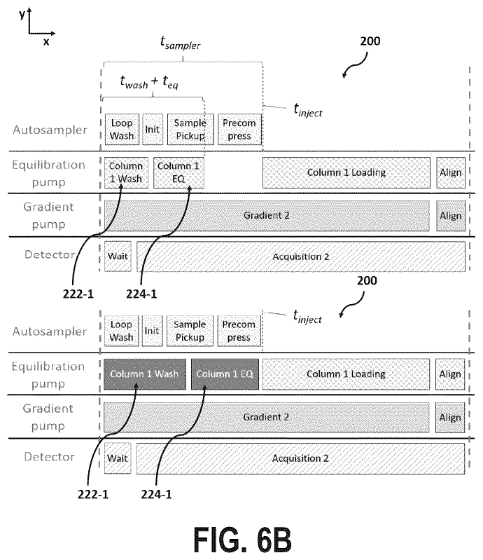

For example, the upper panel of FIG. 6A depicts a part of a tandem trap and elute workflow, which may be performed on a chromatographic system 100, 100a as discussed with reference to FIG. 1A. In the depicted workflow 200, the sample handling subroutines require more time than the column conditioning subroutines, i.e., t_{sampler,min}>t_{colconditioning,min}, such that the equilibration pump is idle for some time.

Similarly, the upper panel of FIG. 6B depicts part of a tandem direct injection workflow, which may for example be performed on a chromatographic system as discussed with reference to FIG. 1B. Again, the sample handling subroutines require more time than the column conditioning subroutines, i.e., t_{sampler,min} colconditioning,min, such that the equilibration pump is idle for some time.

That is, in both workflows depicted in the upper panels of FIGS. 6A and 6B the minimum applicable injection timepoint t_{inject} (and thus also minimum gradient duration t_{grad,min}) may be determined by the sample handling subroutines. Accordingly, the duration of column wash 222 and column equilibration 224 subroutines may be adjusted to synchronize schedules of autosampler, equilibration pump and gradient pump with respect to the injection timepoint t_{inject}. As depicted in the lower panels of FIGS. 6A and 6B, the duration of column wash 222 and column equilibration 224 subroutine may therefore be adjusted such that t_{colconditioning} approximates t_{sampler,min}, which may advantageously allow to synchronize respective subroutines with respect to the injection time t_{inject}.

In a second case II, the minimum total duration of column conditioning subroutines may exceed the minimum total duration of sample handling subroutines:

$${t}_{colconditioning , min} \geq {t}_{sampler , min}$$

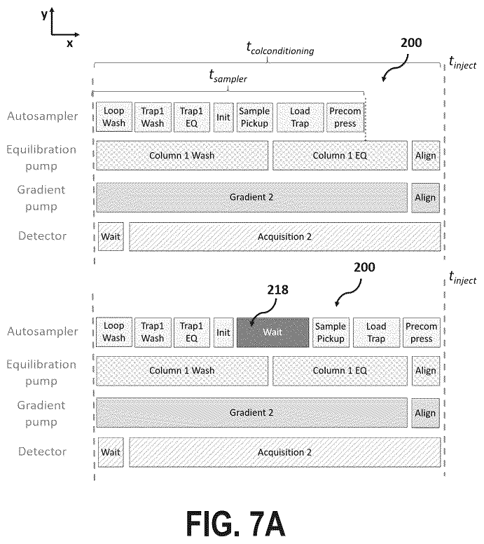

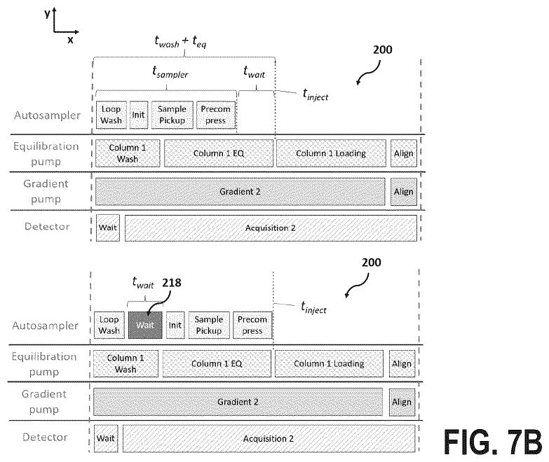

With reference to the upper panels of FIGS. 7A and 7B respective workflows are depicted, wherein the duration of column conditioning subroutines exceeds sample handling subroutines. In such a case an additional wait subroutine 218 may be added to the schedule of the autosampler as depicted in the lower panels of FIGS. 7A and 7B. This additional wait subroutine may ensure synchronization of respective subroutines of autosampler and equilibration pump prior to the inject timepoint (i.e., t_{inject}) and thus prior to sample loading. Alternatively, the duration of trap wash 215 and trap equilibration 216 subroutines may be adjusted. This is because subroutines of the autosampler related to sample pickup should typically not be altered in their duration. For instance, one might in principle extend the duration of the sample pickup subroutine 212 by lowering the draw rate. However, this might lead to undesired variance in the actual sample volume due to the variance in pickup parameters. It may thus be preferred to keep the autosampler parameters consistent throughout the instrument workflow.

Based on the above a maximum applicable value range for each relevant parameter can be calculated. This may essentially result in the fact that the duration of the subroutine related to a respective parameter is limited to a maximum value. This is to assure that it still fits into the overall time window as defined by the gradient duration t_{grad}.

Minimum applicable gradient time (t_{grad,min})

The minimum applicable gradient time t_{grad,min} may thus in the second case II correspond to the minimum duration of the column conditioning subroutines and optionally also column loading t_{colload} where applicable (e.g., in case of a direct injection setup), thus

$${t}_{grad , min} = {t}_{colwash , min} + {t}_{coleq , min} + {t}_{colload , min}$$

In the first case I, the minimum applicable gradient time t_{grad,min} may correspond to the minimum duration of the sample handling subroutines and again optionally column loading t_{colload} where applicable (e.g., in case of a direct injection workflow). That is, in case of a direct injection workflow without sample preconcentration in a trap column, t_{grad,min} may be given as

$$\begin{matrix}{t}_{grad , min} = {t}_{sampler , min} + {t}_{colload , min} \\ = {t}_{loopwash , min} + {t}_{init , min} + {t}_{pickup , min} + {t}_{precompress , min} + {t}_{colload , min}\end{matrix}$$

Alternatively, in case of a trap and elute workflow, t_{grad,min} may be equal to t_{sampler,min}−t_{align}. Again, t_{sampler,min} may comprise the minimum duration of trap washing, trap equilibration and trap loading subroutines, thus

$$\begin{matrix}{t}_{grad , min} = {t}_{sampler , min} - {t}_{align} \\ = {t}_{loopwash , min} + {t}_{trapwash , min} + {t}_{trapeq , min} + {t}_{init , min} + {t}_{pickup , min} + \\ {t}_{precompress , min} + {t}_{trapload , min} - {t}_{align}\end{matrix}$$

t_{align} may denote the time required for aligning the pressures of both columns prior to switching fluid connection of the gradient pump to the column not currently fluidly connected thereto. t_{align} may essentially depend on the properties of the columns, e.g., their void volume and/or their fluidic resistance.

Furthermore, a maximum applicable injection volume Vᵢₙⱼ, max may be determined.

Firstly, a distinction between cases I and II may be required. For a direct injection workflow in the second case II,

$${t}_{grad} = {t}_{colwash} + {t}_{coleq} + {t}_{collad}$$

and thus

$${t}_{colload ,} = {t}_{grad} - ( {t}_{colwash} + {t}_{coleq} )$$

Thus, with

$${V}_{colload} = {V}_{inj} + {V}_{colloadex}$$

the maximum applicable injection amounts to

$${V}_{inj , max} = ( {t}_{grad} - {t}_{colwash} - {t}_{coleq} ) * {f}_{max} - {V}_{colloadex}$$

wherein fₘₐₓ is the maximum applicable flow rate for the given fluidic setup and instrumentation and where V_{colloadex} is an additional volume which may be employed during loading to assure that the sample is entirely loaded onto the respective column. This value may depend on the fluidic configuration (volume of fluidic connections) as well as the void volume of the trap/separation column.

For the first case I, i.e., t_{sampler,min}>t_{colwash,min}+t_{coleq,min}+t_{align}, t_{grad}=t_{loopwash}+t_{trapwash}+t_{trapeq}+tᵢₙᵢₜ+t_{pickup}+t_{trapload}+t_{precompress}+t_{colload}+t_{align}

### Hence,

$${t}_{grad} - {t}_{loopwash} - {t}_{init} - {t}_{precompress} + {t}_{align} = {t}_{trapwash} + {t}_{trapeq} + {t}_{pickup} + {t}_{trapload} + {t}_{colload} ,$$

Wherein, when omitting the optional t_{pwash} for sake of simplicity, t_{pickup} may be given as (cf. above):

$${t}_{pickup} = \frac{{V}_{inj}}{{f}_{draw}} + {t}_{delay} .$$

Thus, for a direct injection workflow, wherein t_{trapwash}, t_{trapeq}, and t_{trapload} are zero, i.e., not present/applicable, and assuming flow-controlled loading, such that

$${t}_{colload} = \frac{{V}_{inj} + {V}_{colloadex}}{{f}_{colload}} ,$$

the maximum applicable injection volume is obtained as:

$${V}_{inj , max} = \frac{{t}_{grad} + {t}_{align} - {t}_{loopwash} - {t}_{init} - {t}_{precompress} - \frac{{V}_{loadex}}{{f}_{max}} - {t}_{delay}}{\frac{1}{{f}_{max}} + \frac{1}{{f}_{draw}}}$$

wherein f_{colload}=fₘₐₓ, i.e., the maximum applicable flow rate for the given fluidic setup and instrumentation may be assumed for column loading. Alternatively, in case of a trap and elute workflow t_{colload} may be zero, i.e., not present/applicable.

### With

$${t}_{trapload} = \frac{( {V}_{inj} + {X}_{load} * {V}_{trapcol} )}{{f}_{load}}$$

$$And$$

$${t}_{trapwash} = \frac{{V}_{trapwash}}{{f}_{trapwash}} = {X}_{trapwash} * \frac{{V}_{trapcol}}{{f}_{trapwash}}$$

$$And$$

$${t}_{trapeq} = \frac{{V}_{trapeq}}{{f}_{trapeq}} = {X}_{trapeq} * \frac{{V}_{trapcol}}{{f}_{trapeq}}$$

the following is obtained:

$${t}_{grad} - {t}_{loopwash} - {t}_{init} - {t}_{precompress} + {t}_{align} = {X}_{trapwash} * \frac{{V}_{trapcol}}{{f}_{trapwash}} + {X}_{trapeq} * \frac{{V}_{trapcol}}{{f}_{trapeq}} + \frac{{V}_{inj}}{{f}_{draw}} + \frac{( {V}_{inj} + {X}_{load} * {V}_{trapcol} )}{{f}_{load}}$$

Assuming identical (maximum) flow rates for trap wash, trap equilibration and loading, i.e.:

$${f}_{max} = {f}_{trapwash} = {f}_{trapeq} = {f}_{load}$$

This can be simplified resulting in

$${t}_{grad} - {t}_{loopwash} - {t}_{init} - {t}_{precompress} + {t}_{align} = {X}_{trapwash} * \frac{{V}_{trapcol}}{{f}_{max}} + {X}_{trapeq} * \frac{{V}_{trapcol}}{{f}_{max}} + \frac{{V}_{inj}}{{f}_{draw}} + {t}_{delay} + \frac{( {V}_{inj} + {X}_{load} * {V}_{trapcol} )}{{f}_{max}}$$

Finally, the maximum applicable injection volume V_{inj,max} is obtained:

$${V}_{inj , max} = \frac{( \begin{matrix}{t}_{grad} - {t}_{loopwash} - {t}_{init} - {t}_{precompress} + {t}_{align} - {t}_{delay} - {X}_{trapwash} * \\ \frac{{V}_{trapcol}}{{f}_{max}} - {X}_{trapeq} * \frac{{V}_{trapcol}}{{f}_{max}} - {X}_{load} * \frac{{V}_{trapcol}}{{f}_{max}}\end{matrix} )}{( \frac{1}{{f}_{max}} + \frac{1}{{f}_{draw}} )}$$

Additionally, a minimum applicable sample pickup speed (f_{draw,min}) may be determined.

Firstly, a distinction between cases I and II may be required. In the second case II,

$${t}_{col wash , min} + {t}_{coleq , min} + {t}_{align} \geq {t}_{sampler , min}$$

### Thus,

$${t}_{pickup} \leq ( {t}_{colwash} + {t}_{coleq} + {t}_{align} ) - {t}_{loopwash} - {t}_{init} - {t}_{precompress} - {t}_{trapwash} - {t}_{trapeq} - {t}_{trapload}$$

And with

$${t}_{pickup} = \frac{{V}_{inj}}{{f}_{draw}} + {t}_{delay}$$

finally, the minimum applicable sample pickup speed (draw rate) f_{draw,min} is obtained:

$${f}_{draw , min} = \frac{{V}_{inj , max}}{\begin{matrix}{t}_{colwash} + {t}_{coleq} + {t}_{align} - {t}_{loopwash} - {t}_{init} - {t}_{pickup} - {t}_{precompress} - \\ {t}_{delay} - {t}_{trapwash} - {t}_{trapeq} - {t}_{trapload}\end{matrix}}$$

Where V_{inj,max} is the maximum applicable injection volume that may be used for the given workflow (as discussed above). Again, depending on the workflow certain terms may be zero, i.e., they may be omitted. Particularly, in a direct injection workflow all terms relating to trap subroutines may be zero.

In the first case I,

$${t}_{sampler , min} > {t}_{col wash , min} + {t}_{coleq , min} + {t}_{align}$$

### Thus,

$${t}_{grad} = {t}_{loopwash} + {t}_{trapwash} + {t}_{trapeq} + {t}_{init} + {t}_{pickup} + {t}_{precompress} + {t}_{colload} + {t}_{trapload} - {t}_{align}$$

### Hence,

$${t}_{pickup} = {t}_{grad} - {t}_{loopwash} - {t}_{init} - {t}_{precompress} - {t}_{colload} - {t}_{trapwash} - {t}_{trapeq} - {t}_{trapload} + {t}_{align}$$

### With

$${t}_{pickup} = \frac{{V}_{inj}}{{f}_{draw}} + {t}_{delay}$$

finally, the minimum applicable sample pickup speed (draw rate) f_{draw,min} is obtained:

$${f}_{draw , min} = \frac{{V}_{inj , max}}{\begin{matrix}{t}_{grad} - {t}_{loopwash} - {t}_{init} - {t}_{precompress} - {t}_{colload} - \\ {t}_{trapwash} - {t}_{trapeq} - {t}_{trapload} + {t}_{align} - {t}_{delay}\end{matrix}}$$

Where V_{inj,max} is the maximum applicable injection volume that may be used for the given workflow (as discussed above).

Again, some of the terms may be omitted/set to zero based on the overall workflow. For example, in a trap and elute workflow, t_{colload} may be set to zero, whereas in a direct injection workflow duration of subroutines relating to the trap column and t_{align} may be set to zero.

Additionally, a maximum applicable loading excess volume may be determined.

Firstly, in a direct injection workflow not utilizing a trap column for sample preconcentration, a distinction between cases I and II may be required. In the second case II,

$${t}_{colload} = {t}_{grad} - ( {t}_{colwash} + {t}_{coleq} )$$

And with

$${t}_{colload} = \frac{{V}_{inj} + {V}_{colloadex}}{{f}_{max}}$$

the maximum column-loading excess volume V_{colloadex},max may be obtained:

$${V}_{colloadex , max} = ( {t}_{grad} - ( {t}_{colwash} + {t}_{coleq} ) ) * {f}_{max} - {V}_{inj , max}$$

Where fₘₐₓ is the maximum applicable flow rate for the given fluidic setup and instrumentation. V_{inj,max} is the maximum applicable injection volume that may be used for the given workflow (as discussed above).

In the first case I,

$${t}_{grad} = {t}_{loopwash} + {t}_{init} + {t}_{pickup} + {t}_{precompress} + {t}_{colload} - {t}_{align}$$

### Hence,

$${t}_{colload} = {t}_{grad} - {t}_{loopwash} - {t}_{init} - {t}_{pickup} - {t}_{precompress} + {t}_{align}$$

### With

$${t}_{pickup} = \frac{{V}_{inj}}{{f}_{draw}} + {t}_{delay} and {t}_{colload} = \frac{{V}_{inj} + {V}_{loadex}}{{f}_{max}}$$

finally, the maximum loading excess volume V_{colloadex}, max is obtained:

$${V}_{colloadex , max} = ( {t}_{grad} + {t}_{align} - {t}_{loopwash} - {t}_{init} - {t}_{precompress} - {t}_{delay} ) - {V}_{inj , max} ( \frac{1}{{f}_{max}} + \frac{1}{{f}_{draw}} ) ) * {f}_{max}$$

Where fₘₐₓ is the maximum applicable flow rate for the given fluidic setup and instrumentation and f_{draw} is the sample draw rate of the autosampler.

With regard to a trap and elute workflow and assuming case I,

$${t}_{grad} = {t}_{loopwash} + {t}_{trapwash} + {t}_{trapeq} + {t}_{init} + {t}_{pickup} + {t}_{precompress} + {t}_{trapload} - {t}_{align}$$

### Hence,

$${t}_{trapload} = {t}_{grad} + {t}_{align} - {t}_{loopwash} - {t}_{trapwash} - {t}_{trapeq} - {t}_{init} - {t}_{pickup} - {t}_{precompress} - {t}_{pickup}$$

### With

$${t}_{pickup} = \frac{{V}_{inj}}{{f}_{draw}} + {t}_{delay} and {t}_{trapload} = \frac{{V}_{inj} + {V}_{loadex}}{{f}_{load , max}}$$

Finally, the maximum trap-loading excess volume V_{traploadex},max is obtained:

$${V}_{traploadex , max} = ( {t}_{grad} + {t}_{align} - {t}_{loopwash} - {t}_{trapwash} - {t}_{trapeq} - {t}_{init} - {t}_{precompress} - {t}_{delay} ) * {f}_{load , max} - {V}_{inj , max} ( 1 + \frac{{f}_{load , max}}{{f}_{draw}} )$$

Where f_{load,max} is the maximum applicable flow rate for the loading subroutine for the given fluidic setup and instrumentation.

For the second case II

$${t}_{trapload} = {t}_{coleq} + {t}_{colwash} + {t}_{align} - ( {t}_{loopwash} + {t}_{trapeq} + {t}_{init} + {t}_{pickup} + {t}_{trapwash} + {t}_{precompress} )$$

### With

$${t}_{pickup} = \frac{{V}_{inj}}{{f}_{draw}} + {t}_{delay} and {t}_{trapload} = \frac{{V}_{inj} + {V}_{loadex}}{{f}_{load , max}}$$

Finally, the maximum trap-loading excess volume V_{traploadex,max} is obtained:

$${V}_{traploadex , max} = ( {t}_{coleq} + {t}_{colwash} + {t}_{align} - {t}_{loopwash} - {t}_{trapwash} - {t}_{trapeq} - {t}_{init} - {t}_{precompress} - {t}_{delay} ) * {f}_{load , max} - {V}_{inj , max} ( 1 + \frac{{f}_{load , max}}{{f}_{draw}} )$$

While V_{traploadex,max} or respectively V_{colloadex,max} may be interdependent with V_{inj,max} there may be certain application where a certain V_{loadex} may be required thus constraining the upper bound of Vᵢₙⱼ and vice versa.

Furthermore, the limits for the column wash volume (V_{colwash}) may be determined. A maximum applicable column wash volume V_{colwash},max may be given as:

$${V}_{colwash , max} = ( {t}_{grad} - {t}_{colload} - {t}_{coleq} ) * {f}_{max}$$

Wherein it will be understood that t_{colload} may be equal to zero in a trap and elute workflow since it may typically not comprise any column loading subroutine.

A lower limit for the column wash volume V_{colwash},min may be defined such that sufficient removal of compounds after the gradient can be assured. Typically, V_{colwash}, min shall be larger than a multiple value of the void volume of the respective separation column V_{col}. This value may be at least 3:

$${V}_{colwash , min} \geq 3 * {V}_{col}$$

Additionally, boundary conditions for a column equilibration volume (V_{coleq}) may be determined. A maximum applicable column equilibration volume V_{coleq},max may be given as

$${V}_{coleq , max} = ( {t}_{grad} - {t}_{colwash} - {t}_{colload} ) * {f}_{coleq , max}$$

Where f_{coleq,max} is the maximum applicable flow rate for the separation column equilibration subroutine for the given fluidic setup and instrumentation. Again, it will be understood that in a trap and elute workflow t_{colload} may be zero, as such a workflow may typically not comprise column loading.

A lower limit for the column equilibration volume V_{coleq,min} may be defined such that sufficient equilibration of the separation column after the column wash may be ensured in preparation for the subsequent loading of the next sample. Typically, V_{coleq,min} shall be larger than a multiple value of the void volume of the respective separation column V_{col} This value may be at least 5:

$${V}_{coleq , min} \geq 5 * {V}_{col}$$

In case of a trap and elute workflow a maximum applicable trap wash volume (V_{trapwash,max}) may be determined.

In case I, one would obtain

$${t}_{grad} = {t}_{loopwash} + {t}_{trapwash} + {t}_{trapeq} + {t}_{init} + {t}_{pickup} + {t}_{trapload} + {t}_{precompress} - {t}_{align}$$

### Hence,

$${t}_{trapwash} = {t}_{grad} + {t}_{align} - {t}_{loopwash} - {t}_{trapeq} - {t}_{init} - {t}_{pickup} - {t}_{trapload} - {t}_{precompress}$$

And with

$${V}_{trapwash , max} = {t}_{trapwash , max} * {f}_{trapwash , max}$$

finally, the maximum applicable volume for the trap washing subroutine V_{trapwash,max} is obtained:

$${V}_{trapwash , max} = ( {t}_{grad} + {t}_{align} - {t}_{loopwash} - {t}_{trapeq} - {t}_{init} - {t}_{pickup} - {t}_{trapload} - {t}_{precompress} ) * {f}_{trapwash , max}$$

Where f_{trapwash,max} is the maximum applicable flow rate for the trap washing subroutine for the given fluidic setup and instrumentation.

In case II:

$${t}_{trapwash} = {t}_{coleq} + {t}_{colwash} + {t}_{align} - ( {t}_{loopwash} + {t}_{trapeq} + {t}_{init} + {t}_{pickup} + {t}_{trapload} + {t}_{precompress} )$$

And with

$${V}_{trapwash , max} = {t}_{trapwash , max} * {f}_{trapwash , max}$$

finally, the maximum applicable volume for the trap washing subroutine V_{trapwash,max} is obtained:

$${V}_{trapwash , max} = ( {t}_{coleq} + {t}_{colwash} + {t}_{align} - {t}_{loopwash} - {t}_{trapeq} - {t}_{init} - {t}_{pickup} - {t}_{trapload} + {t}_{precompress} ) * {f}_{trapwash , max}$$

Furthermore, a maximum applicable trap equilibration volume (V_{trapeq,max}) may be determined.

In case I:

$${t}_{grad} = {t}_{loopwash} + {t}_{trapwash} + {t}_{trapeq} + {t}_{init} + {t}_{pickup} + {t}_{trapload} + {t}_{precompress} - {t}_{align}$$

### Hence,

$${t}_{trapeq} = {t}_{grad} + {t}_{align} - {t}_{loopwash} - {t}_{trapwash} - {t}_{init} - {t}_{pickup} - {t}_{trapload} - {t}_{precompress}$$

And with

$${V}_{trapeq , max} = {t}_{trapeq , max} * {f}_{trapeq , max}$$

Finally, the maximum applicable volume for the trap equilibration subroutine V_{trapeq,max} is obtained:

$${V}_{trapeq , max} = ( {t}_{grad} + {t}_{align} - {t}_{loopwash} - {t}_{trapwash} - {t}_{init} - {t}_{pickup} - {t}_{trapload} - {t}_{precompress} ) * {f}_{trapeq , max}$$

Where f_{trapeq,max} is the maximum applicable flow rate for the trap equilibration subroutine for the given fluidic setup and instrumentation.

In case II:

$${t}_{trapeq} = {t}_{coleq} + {t}_{colwash} + {t}_{align} - ( {t}_{loopwash} + {t}_{trapwash} + {t}_{init} + {t}_{pickup} + {t}_{trapload} + {t}_{precompress} )$$

And with

$${V}_{trapeq , max} = {t}_{trapeq , max} * {f}_{trapeq , max}$$

Finally, the maximum applicable volume for the trap equilibration subroutine V_{trapeq,max} is obtained:

$${V}_{trapeq , max} = ( {t}_{c o l e q} + {t}_{c o l w a s h} + {t}_{a l i g n} - {t}_{l o o p w a s h} - {t}_{trapwash} - {t}_{init} - {t}_{p i c k u p} - {t}_{trapload} - {t}_{p r e c o m p r e s s} ) * {f}_{trapwash , max}$$

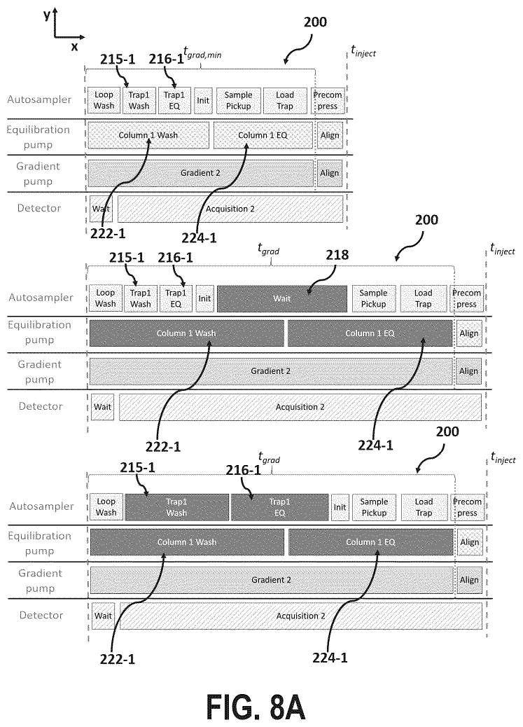

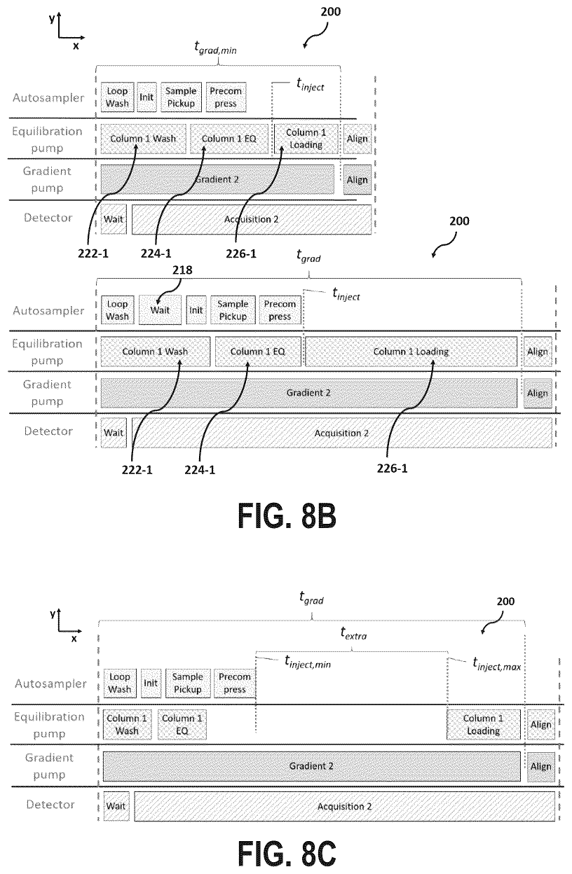

Generally, a subroutine may be scheduled based on the set gradient time. In a case where the set gradient time is equal to the minimum applicable gradient time (i.e., t_{grad}=t_{grad,min}), the duration of the subroutines may be constrained to their respective minimum durations. This also means that at least some of the subroutines of the chromatographic workflow may be performed at maximum operating conditions of the fluidic setup and instrumentation. Exemplary workflows wherein t_{grad}=t_{grad,min} are depicted in the upper panels of FIGS. 8A and 8B.

In a case wherein the set gradient duration exceeds the minimum applicable gradient time (i.e., t_{grad}>t_{grad,min}), an extra time tₑₓₜᵣₐ may leave some space (“head room”) for scheduling of subroutines. Thus,

$${t}_{extra} = {t}_{g r a d} - {t}_{grad , min} .$$

With reference to FIG. 8C, in the context of a direct injection set up tₑₓₜᵣₐ may also be considered as the difference between a latest applicable injection time point t_{inject,max} and the earliest applicable injection time point t_{inject}, min and thus

$${t}_{extra} = {t}_{inject , max} - {t}_{inject , min} ,$$

Where t_{inject,max} may be given as

$${t}_{inject , max} = {t}_{grad} - {t}_{colload , min}$$

And t_{inject,min} may be given as either

$${t}_{inject , min} = {t}_{sampler , min}$$

in case I, or as

$${t}_{inject , min} = {t}_{colwash , min} + {t}_{coleq , min}$$

in case II. That is, whichever duration is larger. Again, these equations may also hold for a trap and elute workflow under the condition that t_{colload},min is zero and potentially t_{align} is added if applicable, i.e.:

$${t}_{inject , max} = {t}_{g r a d} + {t}_{a l i g n}$$

And t_{inject}, min may be given as either

$${t}_{inject , min} = {t}_{sampler , min}$$

in case I, or as

$${t}_{inject , min} = {t}_{colwash , min} + {t}_{coleq , min} + {t}_{a l i g n}$$

in case II.

With respect to the subroutines designated to the autosampler: Generally, duration of subroutines related to the sample pickup may preferably not be altered to assure consistent performance of the sample handling process. Thus, the extra time tₑₓₜᵣₐ may either be accounted for by adding a respective wait subroutine 218 such that the duration of all autosampler subroutines remains unchanged (the middle panel of FIG. 8A and the lower panel of FIG. 8B), or, in case of a trap and elute workflow, the duration of trap wash 215 and trap equilibration 216 subroutines may be adjusted accordingly (the bottom panel of FIG. 8A). Moreover, a combination of both, wait and adjustment of trap column related subroutines, may be applied. It will be understood that other means of distributing the extra time tₑₓₜᵣₐ among available subroutines may be applied. For example, further constraints may be considered, such as that the flow rate may be kept consistent throughout column equilibration and column loading.

For example, the extra time tₑₓₜᵣₐ may be distributed by means of respective weighting factors w. Thus, the extra time may for example be redistributed between trap wash 215 and trap equilibration 216 subroutines:

$${t}_{extra , trapwash} = {w}_{trapwash} * {t}_{extra}$$

$${t}_{extra , t r a p e q} = {w}_{trapeq} * {t}_{extra}$$

wherein

$${w}_{trapwash} + {w}_{trapeq} = 1$$

With regard to the equilibration pump, the extra time tₑₓₜᵣₐ may be redistributed between column wash 222, column equilibration 224 and column loading 226 subroutines (whenever applicable). That is, column loading subroutine 226 may only be present in a direct injection workflow. Exemplary workflows are depicted in the middle and bottom panels of FIG. 8A for a trap and elute workflow and the lower panel of FIG. 8B of a direct injection workflow.

Thus, in a direct injection workflow the extra time may for example be redistributed as follows

$${t}_{extra , c o l w a s h} = {w}_{c o l w a s h} * {t}_{extra}$$

$${t}_{extra} = {w}_{coleq} * {t}_{extra}$$

$${t}_{extra , c o l l o a d} = {w}_{c o l l o a d} * {t}_{extra}$$

wherein

$${w}_{c o l l o a d} + {w}_{c o l e q} + {w}_{c o l w a s h} = 1 .$$

This extra time may be added to the minimum duration of each subroutine. For instance, in the case of the loading duration it results in:

$${t}_{colwash} = {t}_{colwash , min} + {t}_{extra , c o l w a s h}$$

The weighing factors may be configurable by the user or predefined (e.g., proportional to the respective minimum duration of the given subroutine).

In FIGS. 8A and 8B illustrate the principle of distribution of tₑₓₜᵣₐ amongst the various subroutines is exemplarily displayed. It should be denoted that the inject timepoint t_{inject} may shift to higher values as a result of this scheduling process.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, a preferred embodiment has been described with reference to the accompanying drawings, the skilled person will understand that this embodiment was provided for illustrative purpose only and should by no means be construed to limit the scope of the present invention, which is defined by the claims.

We claim:

1. A method for setting up a workflow for a chromatography system, wherein the workflow comprises a plurality of workflow parameters, the method comprising:
providing subroutines of the workflow;
providing at least one boundary condition for at least one workflow parameter;
assigning a duration and a start time to each of the subroutines; and
generating the workflow by combining the subroutines.

2. The method of claim 1, wherein the method comprises displaying at least a part of the workflow, wherein displaying at least a part of the workflow comprises displaying at least a selection of the subroutines;
wherein each displayed subroutine is represented as an item, respectively;
wherein a position in a first direction of each item is indicative of the start time of the respective subroutine relative to the other subroutines; and
wherein an expansion in the first direction of each item is indicative of the duration of the respective subroutine.

3. The method of claim 2, wherein the chromatography system comprises a plurality of system modules operated in parallel, wherein each subroutine is associated to at least one system module, and wherein a position of each item in a second direction perpendicular to the first direction is indicative of the association to a system module of the respective item.

4. The method of claim 1, wherein the method further comprises operating the chromatography system according to the generated workflow.

5. The method of claim 4, wherein the method further comprises receiving at least one input parameter.

6. The method of claim 4, wherein providing at least one boundary condition comprises automatically determining at least one boundary condition based on at least one workflow parameter, at least one boundary condition and/or at least one provided subroutine.

7. The method of claim 4, further comprising suggesting a change of workflow parameters to optimize the workflow.

8. The method of claim 4, wherein the method further comprises receiving a default workflow, wherein in the step of providing subroutines of the workflow the subroutines are provided based on the received default workflow.

9. The method of claim 4, wherein assigning a duration and a start time to each of the subroutines comprises automatically assigning a duration and a start time to each of the subroutines.

10. The method of claim 4, wherein the method further comprises customizing the workflow through adjustment of workflow parameters.

11. The method of claim 4, wherein the method further comprises optimizing timing and/or duration of subroutines based on a gradient delay volume and/or at least one boundary condition associated with the gradient delay volume.

12. The method of claim 4, wherein providing at least one boundary condition comprises determining a minimum gradient time t_{grad,min}.

13. The method of claim 4, wherein determining the minimum gradient time t_{grad,min} comprises determining whether a minimum total duration of column conditioning subroutines t_{colconditioning,min} is shorter or longer than a minimum total duration of sampling handling subroutines t_{sampler,min} and wherein t_{grad,min} is determined to correspond to the larger of the two and where applicable additionally a minimum column loading time t_{colload,min}.

14. The method of claim 9, wherein automatically assigning a duration and a start time to each of the subroutines comprises adjusting the duration of the shorter one of t_{colconditioning,min} and t_{sampler,min} to match the duration of the longer one.

15. The method of claim 12, wherein the provided subroutines are selected from a plurality of predefined subroutines, wherein the plurality of predefined subroutines comprises a gradient subroutine comprising providing a solvent gradient to a respective separation column and wherein an extra time tₑₓₜᵣₐ is given as a difference between the duration of the gradient subroutine and the minimum gradient time tₑₓₜᵣₐ=t_{grad}−t_{grad,min}.

16. The method of claim 4, wherein the method comprises allocating available extra time to present subroutines and/or adding a wait subroutine for each system module, respectively.

17. A chromatography system, comprising a controller, wherein the controller is configured to execute a workflow on the chromatography system and wherein the controller is configured to perform the method for setting up a workflow of claim 1.

18. A computer program product comprising instructions which, when executed by a processor, cause the processor to carry out the method of claim 1.
